(19) United States
(12) Patent Application Publication
(10) Pub. No.: US 2026/0284888 A1
(43) Pub. Date: Sep. 24, 2026

(54) WIRE LAYING AND POSITIONING SYSTEMS AND METHODS THEREOF

(71) Applicant: Polygon T.R Ltd., Tzur-Yigal (IL)

(72) Inventors: Omer EINAV, Kfar-Monash (IL); Doron SHABANOV, Tzur-Yigal (IL); Orya MANDELBAUM, Jerusalem (IL); Yotam EFRAT, Hod Hasharon (IL)

(73) Assignee: Polygon T.R Ltd., Tzur-Yigal (IL)

(21) Appl. No.: 19/474,730

(22) PCT Filed: Apr. 11, 2024
(86) PCT No.: PCT/IL2024/050361

§ 371 Date: Oct. 13, 2025

Related U.S. Application Data
(60) Provisional application No. 63/458,966, filed on Apr. 13, 2023.
(60) Provisional application No. 63/530,501, filed on Aug. 3, 2023.
(60) Provisional application No. 63/591,452, filed on Oct. 19, 2023.
(60) Provisional application No. 63/623,821, filed on Jan. 23, 2024.

(51) Int. Cl. B25J 9/16; B25J 9/00; B25J 11/00; B25J 15/00; H02G 1/06

(52) U.S. Cl. CPC B25J 9/1687; B25J 9/0084; B25J 11/00; B25J 15/0052; H02G 1/06

(57) ABSTRACT

The invention relates to an automated robotic wiring system configured for performing a wiring process including wiring one or more wires in an electrical panel, the system comprising one or more of a first robotic unit configured for inserting an end of a wire into an electrical component; one or more of a second robotic unit configured for positioning said wire along a path within said electrical panel; where the first robotic unit and the second robotic unit collaborate with each other during the wiring process.

### RELATED APPLICATION/S

This application claims the benefit of priority of U.S. Provisional Patent Application No. 63/458,966 filed on Apr. 13, 2023, U.S. Provisional Patent Application No. 63/530,501 filed on Aug. 3, 2023, U.S. Provisional Patent Application No. 63/591,452 filed on Oct. 19, 2023 and U.S. Provisional Patent Application No. 63/623,821 filed on Jan. 23, 2024, the contents of which are incorporated herein by reference in their entirety.

### FIELD AND BACKGROUND OF THE INVENTION

The present invention, in some embodiments thereof, relates to a system for laying and positioning wires and, more particularly, but not exclusively, to a robotic system for laying and positioning wires in an automated wiring robotic system.

Additional background art includes U.S. Pat. No. 10,099,371B2 disclosing robots capable of accommodating dynamic replacement of end effectors load and run software that allows the end effector to be operated without change to the main control program. The driver may be dynamically linked and run during program execution when the corresponding end effector is detected. Typically, the robot controller or the system controller will store a library of drivers, and load the appropriate driver when a new end effector is detected.

U.S. Patent Application Publication No. US20190054634A1 disclosing an effector unit for a robot, which can be locked and unlocked via a relative movement of the robot, so that several effectors can be used in the effector unit. In addition, the document discloses a corresponding method for automatically changing effectors.

U.S. Patent Application Publication No. US20220193925A1 disclosing a tool changing system for an industrial robot, the tool changing system including a tool; a base member for arrangement in a manipulator of the industrial robot and for holding the tool; and a tool storage for holding the tool when released from the base member; and a holding device configured to force the tool to the base member in any orientation of the base member when the tool is held by the base member; and a tool storage force device configured to force the tool to the tool storage in any orientation of the tool storage when the tool is held by the tool storage. A method of handling a tool by an industrial robot is also disclosed.

### SUMMARY OF THE INVENTION

Following is a non-exclusive list including some examples of embodiments of the invention. The invention also includes embodiments which include fewer than all the features in an example and embodiments using features from multiple examples, also if not expressly listed below.

Example 1. An automated robotic wiring system configured for performing a wiring process including wiring one or more wires in an electrical panel, the system comprising:
a. one or more of a first robotic unit configured for inserting an end of a wire into an electrical component;
b. one or more of a second robotic unit configured for positioning said wire along a path within said electrical panel;
wherein said first robotic unit and said second robotic unit collaborate with each other during said wiring process.

Example 2. The system according to example 1, wherein said automated robotic wiring system is configured for passing parts of wires from said one or more wires from said one or more of a first robotic unit to said one or more of a second robotic unit and vice versa during said wiring process.

Example 3. The system according to example 1, wherein said one or more of a first robotic unit is positioned on a front side of said electrical panel.

Example 4. The system according to example 1, wherein said one or more of a second robotic unit is positioned on a same side like said one or more of a first robotic unit.

Example 5. The system according to example 1, wherein said one or more of a second robotic unit is positioned on a back side of said electrical panel.

Example 6. The system according to example 1, further comprising at least two second robotic units, and wherein a first second robotic unit from said at least two second robotic units is positioned on a front side of said electrical panel while a second second robotic unit from said at least two second robotic units is positioned on a back side of said electrical panel.

Example 7. The system according to any one of examples 1-6, wherein said first robotic unit is a robotic arm.

Example 8. The system according to example 7, wherein said robotic arm comprises an end effector configured to engage said wire.

Example 9. The system according to any one of examples 1-8, wherein said second robotic unit is a wire laying and positioning robotic unit.

Example 10. The system according to example 9, wherein said wire laying and positioning robotic unit, comprises:
a. a robotic manipulator configured to provide movement to a positioning head in one or more directions;
b. a positioning head, comprising one or more wire manipulating mechanisms.

Example 11. The system according to example 10, wherein one of said one or more wire manipulating mechanisms comprises a positioning neck comprising one or more wire moving mechanisms.

Example 12. The system according to example 11, wherein said one or more wire moving mechanisms are one or more belts.

Example 13. The system according to example 11, wherein said one or more wire moving mechanisms are one or more rollers.

Example 14. The system according to any one of examples 10-13, wherein said positioning head comprises an inclination mechanism configured to tilt said positioning head.

Example 15. The system according to example 14, wherein said inclination mechanism tilts said positioning head an angle from 0 degrees to 90 degrees.

Example 16. The system according to any one of examples 10-15, wherein said positioning head comprises a rotation mechanism configured to rotate said positioning head.

Example 17. The system according to any one of examples 10-16, wherein said robotic manipulator is one or more of a robotic arm and a robotic gantry.

Example 18. The system according to any one of examples 10-17, wherein said one or more directions provided by said robotic manipulator are selected from the group consisting of left-right, forward-backward and up-down.

Example 19. The system according to any one of examples 10-18, further comprising one or more 7 sensors configured to monitor the movement of a wire within said positioning head.

Example 20. The system according to any one of examples 10-19, further comprising a wire securing actuator configured to control a speed which a wire is being released.

Example 21. The system according to any one of examples 01-20, further comprising an encoder configured for measuring how much of a wire has been released.

Example 22. The system according to any one of examples 10-21, further comprising a wire channel configured for containing a wire while said wire is being released.

Example 23. The system according to example 11, wherein said positioning neck comprises a closed configuration and an open configuration; and wherein in said open configuration a robotic unit is allowed to access and engage a wire located within said positioning neck.

Example 24. The system according to any one of examples 1-8, wherein said second robotic unit is a wire manipulation robotic unit positioned behind said electrical panel.

Example 25. The system according to example 24, wherein said wire manipulation robotic unit comprises two or more grippers, each configured to manipulate a distal end of a wire.

Example 26. The system according to example 25, wherein each of said two or more grippers rotate along a longitudinal axis of a gripper.

Example 27. The system according to example 25, wherein each of said two or more grippers move in a Cartesian fashion.

Example 28. The system according to example 25, wherein each of said two or more grippers move independently from other grippers.

Example 29. The system according to example 25, wherein each of said two or more grippers move up and down in relation to said electrical panel.

Example 30. The system according to example 25, wherein each of said two or more grippers move from a back side of said electrical panel to a front side of said electrical panel.

Example 31. The system according to example 25, wherein each of said two or more grippers interact with at least one of said one or more of a first robotic unit.

Example 32. The system according to example 25, wherein each of said two or more grippers interact with at least one of said one or more of a second robotic unit positioned on a front side of said electrical panel.

Example 33. The system according to any one of examples 1-32, further comprising a wire preparation unit configured for preparing one or more wires to be used in said wiring process.

Example 34. The system according to any one of examples 1-33, further comprising an openable loading table configured to receive said electrical panel.

Example 35. The system according to any one of examples 1-34, further comprising one or more sensors configured to monitor said wiring process.

Example 36. A method of performing a wiring process of an electrical panel by an automated robotic wiring system, comprising:
a. inserting a first end of a wire into a first electrical component by means of one or more of a first robotic unit;
b. positioning said wire along a path by means of one or more of a second robotic unit;
c. inserting a second end of a wire into a second electrical component by means of said one or more of a first robotic unit.

Example 37. The method according to example 36, further comprising positioning said wire within said one or more of a second robotic unit before said inserting a first end of a wire.

Example 38. The method according to example 37, further comprising picking up, by means of said one or more of a first robotic unit, said first end of said wire from a distal end of said one or more of a second robotic unit after said positioning said wire within said one or more of a second robotic unit.

Example 39. The method according to example 36, further comprising picking up, by means of said one or more of a first robotic unit, said second end of said wire from a distal end of said one or more of a second robotic unit after said positioning said wire along said path.

Example 40. The method according to example 38 or example 39, further comprising inclining a part of said one or more of a second robotic unit to facilitate said picking up.

Example 41. The method according to any one of examples 36-40, further comprising:
a. receiving wiring information data comprising a plurality of tasks for said one or more of a first robotic unit and said one or more of a second robotic unit to be performed during said wiring process;
b. performing said plurality of tasks according to said wiring information data;
   wherein said plurality of tasks are characterized by instructing said one or more of a first robotic unit and said one or more of a second robotic unit to collaborate with each other during said a wiring process.

Example 42. The method according to example 41, further comprising picking up, by said one or more of a first robotic unit, a dedicated tool for a task from said plurality of tasks according to said wiring information data.

Example 43. The method according to example 42, further comprising interchanging tools when a specific task from said plurality of tasks requires a different tool from said picked up tool.

Example 44. The method according to any one of examples 36-43, wherein said positioning said wire along a path comprises leaving a wire on a back side of an electrical panel.

Example 45. The method according to any one of examples 36-43, further comprising passing one or both distal ends of a wire from one side of said electrical panel to another side of said electrical panel.

Example 46. A wire laying and positioning robotic unit, comprising:
a. a robotic manipulator configured to provide movement to a positioning head in one or more directions;
b. a positioning head, comprising one or more wire manipulating mechanisms.

Example 47. The wire laying and positioning robotic unit according to example 46, wherein one of said one or more wire manipulating mechanisms comprises a positioning neck comprising one or more wire moving mechanisms.

Example 48. The wire laying and positioning robotic unit according to example 46 or 47, wherein said one or more wire moving mechanisms are one or more belts.

Example 49. The wire laying and positioning robotic unit according to any one of examples 46-48, wherein said one or more wire moving mechanisms are one or more rollers.

Example 50. The wire laying and positioning robotic unit according to any one of examples 46-49, wherein said positioning head comprises an inclination mechanism configured to tilt said positioning head.

Example 51. The wire laying and positioning robotic unit according to any one of examples 46-50, wherein said inclination mechanism tilts said positioning head an angle from 0 degrees to 90 degrees.

Example 52. The wire laying and positioning robotic unit according to any one of examples 46-51, wherein said positioning head comprises a rotation mechanism configured to rotate said positioning head.

Example 53. The wire laying and positioning robotic unit according to any one of examples 46-52, wherein said robotic manipulator is one or more of a robotic arm and a robotic gantry.

Example 54. The wire laying and positioning robotic unit according to any one of examples 46-53, wherein said one or more directions provided by said robotic manipulator are selected from the group consisting of left-right, forward-backward and up-down.

Example 55. The wire laying and positioning robotic unit according to any one of examples 43-54, further comprising one or more sensors configured to monitor the movement of a wire within said positioning head.

Example 56. The wire laying and positioning robotic unit according to any one of examples 43-55, further comprising a wire securing actuator configured to control a speed which a wire is being released.

Example 57. The wire laying and positioning robotic unit according to any one of examples 43-56, further comprising an encoder configured for measuring how much of a wire has been released.

Example 58. The wire laying and positioning robotic unit according to any one of examples 43-57, further comprising a wire channel configured for containing a wire while said wire is being released.

Example 59. The wire laying and positioning robotic unit according to any one of examples 46-58, wherein said positioning neck comprises a closed configuration and an open configuration; and wherein in said open configuration a robotic unit is allowed to access and engage a wire located within said positioning neck.

Example 60. An automated robotic wiring system configured for performing a wiring process including wiring one or more wires in an electrical panel, the system comprising:
a. one or more of a first robotic unit configured for inserting an end of a wire into an electrical component;
b. one or more of a second robotic unit configured for positioning said wire along a path within said electrical panel;
wherein said first robotic unit and said second robotic unit collaborate with each other during said wiring process.

Example 61. The system according to example 60, wherein said first robotic unit is a robotic arm.

Example 62. The system according to example 60 or 61, wherein said robotic arm comprises an end effector configured to engage said wire.

Example 63. The system according to any one of examples 60-62, wherein said second robotic unit is said wire laying and positioning robotic unit according to example 46.

Example 64. The system according to any one of examples 60-63, further comprising a wire preparation unit configured for preparing one or more wires to be used in said wiring process.

Example 65. The system according to any one of examples 60-64, further comprising an openable loading table configured to receive said electrical panel.

Example 66. The system according to any one of examples 60-65, further comprising one or more sensors configured to monitor said wiring process.

Example 67. A wire holder adaptor, comprising:
a. a base;
b. a first body extending vertically from said base and a second body extending vertically from said base; each of said first body and said second body comprising a distal end bending inwards toward each other and towards a first longitudinal axis passing through a center of said base;
said distal end of said first body and said distal end of said second body almost meet and are slightly separated from each other at a location where said first longitudinal axis passes;
said first body and said second body defining a wire holding enclosure area having an exit located at said location where said distal end of said first body and said distal end of said second body almost meet and are slightly separated;
c. at least two protrusions, each extending from a top portion of each of said first body and said second body; said at least two protrusions configured to be engaged by a robotic unit so as to cause said distal end of said first body and said distal end of said second body to further separate thereby allowing a wire to enter said wire holding enclosure area.

Example 68. The wire holder adaptor according to example 67, wherein once said robotic unit ceases engagement with said at least two protrusions, said distal end of said first body and said distal end of said second body return to a previous state prior to said engagement.

Example 69. The wire holder adaptor according to example 67 or 68, wherein said return to a previous state is passive.

Example 70. The wire holder adaptor according to any one of examples 67-69, further comprising one or more separator holder.

Example 71. The wire holder adaptor according to any one of examples 67-70, further comprising one or more separators.

Example 72. The wire holder adaptor according to any one of examples 67-71, further comprising one or more channels within said wire holding enclosure area defined by one or more bodies extending vertically from said base.

Example 73. The wire holder adaptor according to any one of examples 67-72, wherein said wire holder adaptor comprises a third body and a fourth body extending from said base; each of said third body and said fourth body comprising a distal end bending inwards toward each other and towards a second longitudinal axis passing through said base; wherein when said wire holder adaptor comprises said third body and said fourth body, then said first longitudinal axis does not pass through said center of said base.

Example 74. The wire holder adaptor according to any one of examples 67-73, wherein said base comprises an engaging mechanism configured to engage a surface of an electrical panel.

Example 75. The wire holder adaptor according to any one of examples 67-74, wherein said base comprises an engaging mechanism configured to engage an electrical duct of an electrical panel.

Example 76. A method of performing a wiring process by an automated robotic wiring system according to example 60, comprising:
a. inserting a first end of a wire into a first electrical component by means of said one or more of a first robotic unit;
b. positioning said wire along a path by means of said one or more of a second robotic unit;
c. inserting a second end of a wire into a second electrical component by means of said one or more of a first robotic unit.

Example 77. The method according to example 76, further comprising positioning said wire within said one or more of a second robotic unit before said inserting a first end of a wire.

Example 78. The method according to example 76 or 77, further comprising picking up, by means of said one or more of a first robotic unit, said first end of said wire from a distal end of said one or more of a second robotic unit after said positioning said wire within said one or more of a second robotic unit.

Example 79. The method according to any one of examples 76-78, further comprising picking up, by means of said one or more of a first robotic unit, said second end of said wire from a distal end of said one or more of a second robotic unit after said positioning said wire along said path.

Example 80. The method according to any one of examples 76-79, further comprising inclining a part of said one or more of a second robotic unit to facilitate said picking up.

Example 81. A method of performing a wiring process by an automated robotic wiring system according to example 60, comprising:
a. receiving wiring information data comprising a plurality of tasks for said one or more of a first robotic unit and said one or more of a second robotic unit;
b. performing said plurality of tasks according to said wiring information data;
wherein said plurality of tasks comprises one or more of:
   i. inserting an end of a wire into an electrical component by said one or more of a first robotic unit;
   ii. positioning said wire along a path within an electrical panel by said one or more of a second robotic unit;
wherein said plurality of tasks are characterized by instructing said one or more of a first robotic unit and said one or more of a second robotic unit to collaborate with each other during said a wiring process in the performance of said wiring process.

Example 82. The method according to example 81, further comprising picking up, by said one or more of a first robotic unit, a dedicated tool for a task from said plurality of tasks according to said wiring information data.

Example 83. An end effector for a robotic wiring system, comprising a wire holder comprising a first type of exchangeable tool.

Example 84. The end effector according to example 83, wherein said wire holder comprises a first adaptor configured for allowing exchanging of said first type of exchangeable tool.

Example 85. The end effector according to example 83 or example 84, wherein said first type of exchangeable tool are one or more of a wire grasping tool, a USB gripper, a RJ45 gripper, a HDMI gripper, a continuity test probe and a USB data transfer tool.

Example 86. The end effector according to any one of examples 83-85, wherein said first type of exchangeable tool comprises two elongated finger-like extensions.

Example 87. The end effector according to any one of examples 83-86, wherein said two elongated finger-like extensions are actuated using a “scissor-like” mechanism.

Example 88. The end effector according to any one of examples 83-87, wherein said “scissor-like” mechanism provides said two elongated finger-like extensions with an angular movement.

Example 89. The end effector according to any one of examples 83-88, wherein said two elongated finger-like extensions are characterized by one or more of the following actuation states comprising an open stated, a semi-closed state and a closed state.

Example 90. The end effector according to any one of examples 83-89, wherein said wire holder comprises a caging actuator configured for holding an actuation state of said first type of exchangeable tool while using said end effector.

Example 91. The end effector according to any one of examples 83-90, wherein said two elongated finger-like extensions are characterized by having a distance between said two elongated finger-like extensions of from about 2 mm to about 7 mm.

Example 92. The end effector according to any one of examples 83-91, wherein said two elongated finger-like extensions are characterized by having a distance between said two elongated finger-like extensions configured for holding a required object.

Example 93. The end effector according to any one of examples 83-92, wherein said two elongated finger-like extensions are configured to apply a force of from about 1N to about 20N.

Example 94. The end effector according to any one of examples 83-95, wherein said two elongated finger-like extensions are configured for grasping wires having a diameter of from about 0.5 mm to about 6.0 mm and higher diameter.

Example 95. The end effector according to any one of examples 83-94, wherein each of said two elongated finger-like extensions comprise a distal end configured to hold one or more of a wire, a connector, USB connector, a RJ45 connector, a HDMI connector, a cable, a tube, a fiber optic cable and a fiber optic tube.

Example 96. The end effector according to any one of examples 83-95, wherein said wire holder comprises one or more of first sensors configured to monitor actions performed by said wire holder.

Example 97. The end effector according to any one of examples 83-96, wherein one of said one or more of first sensors is at least one force sensor for measuring forces from one or more axis.

Example 98. The end effector according to any one of examples 83-97, wherein said end effector comprises dedicated calibration information used by said one or more sensors for each type of said first type of exchangeable tool.

Example 99. The end effector according to any one of examples 83-98, wherein at least one sensor from said one or more of first sensors are positioned on said end effector and additionally are configured for monitoring said first type of exchangeable tool.

Example 100. The end effector according to any one of examples 83-99, wherein one or more of said one or more of first sensors are positioned on said first type of exchangeable tool.

Example 101. The end effector according to any one of examples 83-100, wherein said wire holder comprises one or more of first motors for moving said wire holder in one or more directions.

Example 102. The end effector according any one of examples 83-101, wherein said wire holder comprises one or more of second sensors for monitoring the moving actions of said wire holder.

Example 103. The end effector according to any one of examples 83-102, wherein one of said one or more of second sensors is at least one anti-collision sensor for monitoring external forces applied on one or more parts of said end effector while being used.

Example 104. The end effector according to any one of examples 83-103, wherein said wire holder comprises an exchangeable tool locker configured for locking said first type of exchangeable tool in place.

Example 105. The end effector according to any one of examples 83-104, wherein said first type of exchangeable tool comprises at least one identification marking.

Example 106. The end effector according to any one of examples 83-105, wherein said first type of exchangeable tool comprises a distal end configured to hold a component at a certain angle in relation to an axis of said first type of exchangeable tool.

Example 107. The end effector according to any one of examples 83-106, wherein said angle of from about 0° to about 180°.

Example 108. The end effector according to any one of examples 83-107, wherein a distance from a distal end of said first type of exchangeable tool to said adaptor is from about 10 mm to about 300 mm.

Example 109. The end effector according to any one of examples 83-108, wherein said first type of exchangeable tool comprises a total width of from about 1 mm to about 10 mm.

Example 110. The end effector according to any one of examples 83-109, wherein said end effector exchanges said first type of exchangeable tool from a plurality of first type of exchangeable tools located in a dedicated stand for first type of exchangeable tools.

Example 111. The end effector according to any one of examples 83-110, further comprising a wire locker comprising a second type of exchangeable tool.

Example 112. The robotic wiring system according to any one of examples 83-111, wherein said second type of exchangeable tool is a motorized screwdriver configured to receive one or more interchangeable screwdriver bits.

Example 113. The end effector according to any one of examples 83-112, wherein said motorized screwdriver comprises a second adaptor configured for allowing exchanging of said one or more interchangeable screwdriver bits.

Example 114. The end effector according to any one of examples 83-113, wherein said second type of exchangeable tool is a motorized pusher configured for pushing locking mechanism in electrical connector terminals.

Example 115. The end effector according any one of examples 83-114, wherein said wire locker comprises one or more of third sensors configured to monitor locking actions of said wire locker.

Example 116. The end effector according any one of examples 83-115, wherein one of said one or more of third sensors is a torque sensor configured to monitor torque related to locking mechanisms of electrical terminal connectors.

Example 117. The end effector according to any one of examples 83-116, wherein said wire locker comprises one or more of second motors for moving said wire locker in one or more directions.

Example 118. The end effector according to any one of examples 83-117, wherein said first type of exchangeable tool is configured to perform tasks related to an automated wiring process.

Example 119. The end effector according any one of examples 83-118, wherein said second type of exchangeable tool is configured to perform tasks related to an automated wiring process.

Example 120. The end effector according to any one of examples 83-81195, wherein said tasks are one or more of grasping a wire, grasping a tube, grasping a cable, locking a wire, testing continuity and delivering data.

Example 121. The end effector according to any one of examples 83-120, wherein said first type of exchangeable tool is configured to fit in a tight spot.

Example 122. The end effector according to any one of examples 83-121, wherein said second type of exchangeable tool is configured to fit in a tight spot.

Example 123. The end effector according to any one of examples 83-122, wherein said first type of exchangeable tool is configured to be used in a validation process.

Example 124. The end effector according to any one of examples 83-123, wherein said second type of exchangeable tool is configured to be used in a validation process.

Example 125. The end effector according to any one of examples 83-124, wherein said first type of exchangeable tool is configured to be used in a quality assurance (QA) process.

Example 126. The end effector according to any one of examples 83-125, wherein said second type of exchangeable tool is configured to be used in a quality assurance (QA) process.

Example 127. The end effector according to any one of examples 83-125, wherein said end effector comprises a single multi-sensor configured for monitoring the processes of all parts of said end effector.

Example 128. The end effector according to any one of examples 83-127, wherein said calibration information is generated by one or more of tests, analysis and simulations.

Example 129. A robotic wiring system comprising:
a. at least one robotic arm comprising an end effector according to example 83; and
b. a tool stand comprising a plurality of tools.

Example 130. A method of performing a wiring process by an automated wiring machine, comprising:
a. receiving wiring information data comprising a plurality of tasks;
b. picking up, by said automated wiring machine, a dedicated tool for a task from said plurality of tasks according to said wiring information data;
c. performing said task from said plurality of tasks according to said wiring information data;
wherein said method comprises interchanging tools when a specific task from said plurality of tasks requires a different tool from said picked up tool.

Example 131. An automated robotic wiring system configured for performing a wiring process including wiring one or more wires in an electrical panel, the system comprising:
a. one or more of a first robotic unit configured for inserting an end of a wire into an opening in said electrical panel;
b. one or more of a second robotic unit configured for picking up said end of said wire after said end of said wire passes through said opening in said electrical panel.

Example 132. The automated robotic wiring system according to example 131, wherein said one or more of a first robotic unit and said one or more of a second robotic unit are configured to collaborate with each other during a passage of said end of said wire through said opening.

Example 133. The automated robotic wiring system according to any one of examples 131-132, wherein either said one or more of a first robotic unit or said one or more of a second robotic unit are configured for inserting said end of said wire into an electrical component.

Example 134. The automated robotic wiring system according to any one of examples 131-133, further comprising one or more of a third robotic unit configured for positioning said wire along a path within said electrical panel.

Example 135. The automated robotic wiring system according to any one of examples 131-134, wherein said one or more of a first robotic unit and/or said one or more of a second robotic unit are robotic arms comprising an end effector configured for manipulating said wire.

Example 136. The system according to any one of examples 131-135, wherein said one or more of a third robotic unit is said wire laying and positioning robotic unit according to example 46.

Example 137. The automated robotic wiring system according to any one of examples 131-136, further comprising a wire preparation unit configured for preparing one or more wires to be used in said wiring process.

Example 138. The automated robotic wiring system according to any one of examples 131-137, further comprising an openable loading table configured to receive said electrical panel.

Example 139. The automated robotic wiring system according to any one of examples 131-138, wherein either said one or more of a first robotic unit or said one or more of a second robotic unit are located below said openable loading table.

Example 140. The automated robotic wiring system according to any one of examples 131-139, wherein at least one of said one or more of a first robotic unit and said one or more of a second robotic unit are located on a front side of said electrical panel while the other is positioned on a back side of said electrical panel.

Example 141. The automated robotic wiring system according to any one of examples 131-140, wherein said one or more of a first robotic unit and said one or more of a second robotic unit are one or more of a manipulator, a Cartesian gantry system and a multi-axis platform.

Example 142. The automated robotic wiring system according to any one of examples 131-141, further comprising one or more sensors configured to monitor said wire when passing from said one or more of a first robotic unit to said one or more of a second robotic unit.

Example 143. The automated robotic wiring system according to any one of examples 131-142, further comprising one or more cameras configured to monitor said wire when passing from said one or more of a first robotic unit to said one or more of a second robotic unit.

Example 144. A method of performing a wiring process by an automated robotic wiring system according to example 131, comprising:
a. inserting a first end of a wire into an opening by means of said one or more of a first robotic unit;
b. picking up said first end of a wire after passing through said opening by means of said one or more of a second robotic unit.

Example 145. A method of performing a wiring process by an automated robotic wiring system according to claim 131, comprising:
a. accessing a first side of said electric panel by means of said one or more of a first robotic unit;
b. accessing a second side of said electrical panel by means of said one or more of a second robotic unit;
c. passing at least part of said wire from said one or more of a first robotic unit to said one or more of a second robotic unit or vice versa.

Example 146. A system comprising:
a. a manipulation arm;
b. an end-effector configured to hold a wire; and
c. at least one sensor;
wherein the system is configured to:
d. identifying an object;
e. searching for an opening in the object; and
f. inserting the wire into the object opening by using a motion trajectory based on the sensors feedback.

Example 147. A method to insert a wire through an object comprising:
a. identifying said object;
b. searching for an opening in the object; and
c. inserting the wire into the object opening by using a motion trajectory based on sensors feedback.

Example 148. The system and method according to example 146 and example 147, where the object is a wiring duct.

Example 149. The system and method according to example 146 and example 147, where the object is a clip.

Example 150. A system comprising a manipulation arm and a wire releasing mechanism where the wire is released through a gap from one side of a panel to the other side.

Example 151. The system according to example 150, where the wire has a minimum speed that ensures that the wire moves from one side to the other.

Example 152. The system according to example 150 or 151, where the release mechanism is incorporated with an end-effector.

Example 153. A method of delivering a wire through a gap from one side to the other where the wire is released from a mechanism with proper speed that ensure that the wire moves from one side to the other.

Example 154. A system for automatically wiring small electrical panels, comprising an assembly module and a wiring module.

Example 155. The system according to example 154, where the release mechanism is incorporated with an end-effector, and the release mechanism includes one or more mechanical units (e.g. a gripper) that present the wire from one side of an object to the other side the object, where said object may be for example a panel.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks, might be expected to use completely different methods, e.g., making use of expert knowledge and/or the pattern recognition capabilities of the human brain, which would be vastly more efficient than manually going through the steps of the methods described herein.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1a-c are schematic representations of an exemplary robotic electrical cabinet wiring system, from different perspective views, according to some embodiments of the invention;

FIGS. 1d-e are schematic representations of exemplary electrical cabinets and general parts thereof, according to some embodiments of the invention;

FIG. 1f is a schematic representation of a two-step electrical panel preparation process, according to some embodiments of the invention;

FIGS. 2a-b are schematic representations of an internal view and an upper view, respectively, of an exemplary robotic electrical cabinet wiring system, according to some embodiments of the invention;

FIGS. 3a-b are schematic representations of the actuation of an exemplary cabinet loading table, according to some embodiments of the invention;

FIG. 4a is a schematic diagram of an exemplary wire preparation unit, according to some embodiments of the invention;

FIG. 4b is a schematic representation of an exemplary wire stand, according to some embodiments of the invention;

FIGS. 4c-4h are schematic representations of an exemplary wire presentation module and its internal mechanisms, according to some embodiments of the invention;

FIGS. 4i-j are schematic representations of an exemplary wire-end connector mounting module, according to some embodiments of the invention;

FIGS. 4k-m are schematic representations of an exemplary wire manipulator, according to some embodiments of the invention;

FIG. 4n is a schematic representation of additional components of the wire preparation unit, according to some embodiments of the invention;

FIG. 40 is a flowchart of an exemplary method of wire preparation, according to some embodiments of the invention;

FIGS. 5a-c are schematic representations of an exemplary robotic arm, according to some embodiments of the invention;

FIG. 5d is a schematic representation of an exemplary wiring-end effector, according to some embodiments of the invention;

FIG. 5e is a schematic representation of the parts of the wire holding element/wire holder, according to some embodiments of the invention;

FIG. 5f is a schematic representation of the sensors located on the elongated extensions, according to some embodiments of the invention;

FIGS. 5g-h are schematic representations of exemplary gimbal blocks to which the extensions are connected, according to some embodiments of the invention;

FIG. 5i is a schematic representation of an exemplary wire locking element/wire locker, according to some embodiments of the invention;

FIG. 5j are schematic representations of a plurality of possible exemplary interactions of wiring-end effector modules with different types of terminal blocks (components) having different locking mechanisms, according to some embodiments of the invention;

FIGS. 6a-b are schematic representation of ferrules, according to some embodiments of the invention;

FIG. 7a is a schematic representation of an exemplary wiring-end effector module configured for interchangeable tools, according to some embodiments of the invention;

FIGS. 7b-c are schematic representations of an exemplary locking mechanism for interchangeable tools, according to some embodiments of the invention;

FIGS. 7d-j are schematic representations of exemplary end effector interchangeable tools and their characteristics, according to some embodiments of the invention;

FIG. 7k, is a schematic representation of the system 770, according to some embodiments of the invention;

FIG. 7l, is an exemplary method of wiring, according to some embodiments of the invention;

FIGS. 7m-o are exemplary force graphs during a process of finding a location of a duct, according to some embodiments of the invention;

FIG. 8a is a schematic representation of an exemplary dedicated stand comprising a plurality of different interchangeable tools and/or a plurality of different interchangeable screwdriver bits, according to some embodiments of the invention;

FIGS. 8b-8c are schematic representations of an exemplary stand for different interchangeable tools, according to some embodiments of the invention;

FIG. 8d is a schematic representation of an exemplary interchangeable wire gripping tools, according to some embodiments of the invention;

FIG. 8e are schematic representations of exemplary interchangeable tools configured to grab technical cables, according to some embodiments of the invention;

FIG. 8f are schematic representations of exemplary technical tools, according to some embodiments of the invention;

FIGS. 9a-b are schematic representations of an exemplary alternative wire gripper tool, according to some embodiments of the invention;

FIG. 10a is another exemplary wiring end-effector having interchangeable tools capabilities, according to some embodiments of the invention;

FIGS. 10b-g are schematic representations of exemplary wire holding element/wire holder, according to some embodiments of the invention;

FIG. 11 is a flowchart of an exemplary validation method, according to some embodiments of the invention;

FIG. 12 is a flowchart of an exemplary method of wiring by an exemplary wiring-end effector having interchangeable tools, according to some embodiments of the invention;

FIGS. 13a-b are a flowchart of an exemplary method of wiring by an exemplary wiring-end effector module when the wire comprises ferrule, according to some embodiments of the invention;

FIGS. 14a-e are schematic representations of an exemplary grip and slip process when performed by a human;

FIG. 15 is a flowchart of an exemplary method of wiring by the robotic arms, according to some embodiments of the invention;

FIGS. 16a-c are schematic representations of an exemplary wire laying and positioning robotic unit, according to some embodiments of the invention;

FIG. 16d is a schematic representation of an exemplary positioning head, according to some embodiments of the invention;

FIGS. 16e-g are schematic representations of an exemplary tilting action of the positioning head, according to some embodiments of the invention;

FIGS. 17a-b are a flow chart of an exemplary method of wiring using both robotic arms and wire laying and positioning robotic unit, according to some embodiments of the invention;

FIGS. 17c-o are schematic representations showing exemplary actions disclosed by the flowchart of FIGS. 17a-b;

FIGS. 18a-c are schematic representations of exemplary separators and uses thereof, according to some embodiments of the invention;

FIGS. 18d-u are schematic representations of exemplary wire holder adaptors and their technical features, according to some embodiments of the invention;

FIG. 19a is a schematic representation of an exemplary robotic electrical cabinet wiring system configured to pass wires through openings, according to some embodiments of the invention;

FIG. 19b is a schematic representation of an exemplary robotic electrical cabinet wiring system configured access an electrical cabinet and/or a frame thereof from both sides, according to some embodiments of the invention;

FIGS. 19c-d show schematic representations of exemplary systems configured to pass a wire from one side to another, according to some embodiments of the invention;

FIGS. 19e-f show schematic representations of an exemplary wire delivering mechanism in two actuation configurations, according to some embodiments of the invention;

FIG. 19g shows a schematic representation of an exemplary wire delivering mechanism ready to deliver a wire from one side to another, according to some embodiments of the invention;

FIG. 19h shows a schematic representation of a wire delivering mechanism in an extended configuration, according to some embodiments of the invention;

FIG. 19i shows two images showing a wire delivering mechanism delivering a wire between two rows, according to some embodiments of the invention;

FIG. 19j, showing a schematic representation of a wire delivery mechanism and parts thereof, according to some embodiments of the invention;

FIGS. 19k-m, showing schematic representations of an exemplary wire handling and placement unit, according to some embodiments of the invention;

FIG. 19n, showing a flowchart of an exemplary method for delivering a wire from one side to the other, according to some embodiments of the invention;

FIG. 20 is a schematic representation of an exemplary data flow and operation of an automated wiring system, according to some embodiments of the invention;

FIGS. 21a-b are schematic illustrations of a wiring process by two automated mechanical arms, according to some embodiments of the invention;

FIG. 22 is a graph describing the exemplary phases of the insertion of a wire into an electrical terminal connector of a component as identified by the sensors in the gripper, according to some embodiments of the invention;

FIGS. 23a-c are three different examples of sensed forces by the gripper in three different scenarios, according to some embodiments of the invention;

FIG. 24 is a graph showing a plurality of test experiments for the characterization of exemplary scenarios, according to some embodiments of the invention;

FIGS. 25a-d are schematic representations of an exemplary automatic assembly and wiring system for small panels and modules thereof, according to some embodiments of the invention; and

FIGS. 26a-b are schematic representations of an exemplary system to manipulate a wire under an electrical panel, according to some embodiments of the invention.

### DESCRIPTION OF SPECIFIC EMBODIMENTS OF THE INVENTION

The present invention, in some embodiments thereof, relates to a system for laying and positioning wires and, more particularly, but not exclusively, to a robotic system for laying and positioning wires in an automated wiring robotic system.

### Overview

An aspect of some embodiments of the invention relates to automatically positioning one or more wires using a dedicated wire laying and positioning robotic system (or unit or manipulator) as part of a robotic wiring system. In some embodiments, the dedicated wire laying and positioning robotic system comprises a plurality of mechanical elements configured to manipulate a wire and position it in and/or along dedicated locations within an electrical panel. In some embodiments, the wire is secured onto the electrical panel while is being positioned. In some embodiments the wire laying and positioning robotic system utilizes a Cartesian mechanism such as a gantry robot that provides two degrees of freedom (for example left-right and forward-backward movement) over a panel being wired. In some embodiments, additional degrees of freedom (DOF) are provided to the wire laying and positioning robotic system, for example up-down movement. In some embodiments, the laying and positioning robotic system moves at a certain speed while at the same time releases and lays down a wire. In some embodiments, the speed of the release of the wire is the same as the speed which the wire laying and positioning robotic system moves. In some embodiments, a potential advantage of releasing at the same speed as the movement is that the wire is positioned at an orderly manner without the concern of possible entanglements of the wire, or without creating pulling/pushing forces on the wire. In some embodiments, the speed of the release of the wire is higher than the speed which the wire laying and positioning robotic system moves. In some embodiments, a potential advantage of releasing the wire at a higher speed than the movement of the system is that it provides “spare” loose wire that can fit to uneven surfaces, which potentially assists in the positioning of the wire in situations where a plurality of wires are already placed and they physically disturb the process of positioning a new wire. In some embodiments, during a same process of positioning a same wire, the system is configured to amend one or more of the speed of movement and the speed of release of the wire, according to wire positioning requirements, either known in advance (for example during the planning process) and/or during the process itself in real-time, according to information received, for example, by one or more sensors. In some embodiments, the robotic wiring system comprises one or more additional robotic units configured for positioning one or more electrical components in the electrical cabinet. In some embodiments, the robotic wiring system comprises one or more additional robotic units configured for inserting one or more distal ends of wires into electrical components located in the electrical cabinet. In some embodiments, the positioning of a wire in an electrical cabinet comprises the insertion of a distal end of a wire into an electrical component by a first robotic unit, then laying and positioning the wire in the electrical cabinet by the wire laying and positioning robotic system, then either inserting the other distal end of the wire into an additional electrical component by either the first robotic unit or by an additional robotic unit, or leaving the other distal end of the wire free to be used later on by an electrician when installing the electrical cabinet in the planned location.

An aspect of some embodiments of the invention relates to an automated robotic wiring system comprising a plurality of robotic units, each having a different role in a wiring process. In some embodiments, wires being positioned within an electrical panel are transferred (“passed”) from one robotic unit to another during the wiring process. In some embodiments, the transfer of the wire is characterized by transferring either an end of a wire or a part of a wire that it is not an end of the wire. In some embodiments, the different robotic units are provided with dedicated mechanisms that assist in the transfer of the wire, for example, inclination mechanism, rotation mechanism, gripping mechanisms, holding mechanism and one or more sensors configured to monitor the wire before, during and/or after the transfer process. In some embodiments, the actions of the different robotic units are coordinated in advance during a planning process according to specific wiring processing needs (for example, the type of wire, the length of the wire, the path that a wire needs to do from one component to another within the electrical panel, etc.). In some embodiments, the actions of the different robotic units are amended during the wiring process according to real-time needs and/or problems that may rise during a wiring process, for example, according to real-time information received from one or more sensors that monitor the wiring process. In some embodiments, the passing of the wire is from a first side (for example from the back side) of the electrical cabinet to a second side (for example to a front side) of the electrical cabinet. In some embodiments, the passing of the wire is performed on a same side (for example on the front side) of the electrical panel. In some embodiments, a potential advantage of passing the wires from a first side of the electrical cabinet to a second side of the electrical cabinet is that it allows to leave one distal of the wire on a desired side of the electrical cabinet, while laying, positioning and connecting the other side of the wire on the other side. In some embodiments, a distal end of the wire is left on the back side of the electrical cabinet to allow connection of the electrical cabinet to the location where the electrical cabinet is going to be installed. In some embodiments, the same mechanism of passing wires from one side to another is used for other parts of electrical cabinets, for example on doors of electrical cabinets, where dedicated electrical components are mounted (for example, breakers, lights, digital displays, etc.). In some embodiments, another potential advantage of allowing frontal access and distal access to the electrical cabinet during the wiring process is that it allows the robotic units to access the wire, and optionally re-routing it, either from the front or the back and avoid electrical components used within the electrical cabinet, line circuit breakers, protective covers, ducts, etc. In some embodiments, the system is configured to manage any length of wire, from very short wires (for example a few centimeters long) to very long wires (for example longer than 30 centimeters, longer than a meter, etc.), where the meaning of “manage” includes one or more of: preparing the wire (including one or more of: choosing the right wire; cutting the wire to a required length; adding dedicated connectors to the ends of the wire; marking the wire; etc.), transferring the wire between the different robotic units, connecting ends of the wires to specific components, positioning the wire along pre-determined paths within an electrical panel and locking the wire in place after being positioned.

An aspect of some embodiments of the invention relates to a dedicated wire holding adaptor configured to be positioned within an electrical panel, and optionally within an electrical duct, and configured to hold one or more wires, and to assist in the organization of a plurality of wires being positioned within a same electrical panel. In some embodiments, the wire holder adaptor is manipulated by one or more robotic units. In some embodiments, the one or more robotic units are configured to pick up a specific wire holder adaptor and position it in the electrical panel. In some embodiments, during the wiring positioning process, the one or more robotic units are configured to interact with the wire holding adaptor in order to position the wire within the wire holding adaptor, therefore guarantying that the wire will not move from its planned position. Therefore, in some embodiments, the wire holding adaptor comprises dedicated structures that assist in the interaction between the wire holding adaptor and the one or more robotic units. In some embodiments, the wire holding adaptor comprises one or more areas which allow the division of groups of wires within the wire holding adaptor. In some embodiments, the different groups of wires can be organized horizontally and/or vertically within a same wire holding adaptor. In some embodiments, optionally, separators are used to assist in the separation between groups of wires (where each “group” may comprise one or more wires) within a same wire holding adaptor. In some embodiments, the wire holding adaptor comprises an engaging mechanism configured to allow the attachment of the wire holding adaptor to the electrical panel, and optionally to an electrical duct.

An aspect of some embodiments of the invention relates to manipulating wires through electrical components and/or electrical accessories and/or accessories used in electrical cabinets. In some embodiments, wires are used to wire an electrical panel, and, in some embodiments, one or more wires are laid inside ducts and/or dedicated clips. In some embodiments, automatic robotic system, optionally comprising dedicated end-effectors manipulate the wires during the wiring process of electrical cabinets. In some embodiments, sensors are used to identify one or more of a duct, a clip and any other object within the electrical cabinet. For example, optical one or more of optical sensors, force sensors, torque sensors and moment measuring sensors. In some embodiments, the one or more sensors are used to receive feedback on a wire and the surroundings of the wire, for example, a contact between a wire and an object (for example a duct or a clip).

An aspect of some embodiments of the invention relates to an automated wiring system comprising two distinct wiring manipulators. In some embodiments, a first wire manipulator comprises a gripper configured to manipulate a distal end of a wire and perform delicate actions, like connecting the distal end to a component. In some embodiments, a second wire manipulator comprises a dedicated mechanism configured to ease the positioning of the wire in the electrical cabinet when extending the wire in the electrical cabinet. In some embodiments, the two wiring manipulators work in cooperation during the wiring process. In some embodiments, a first wire manipulator is positioned on one side of the electrical panel while a second wire manipulator is positioned either on a same side or on the other side of the electrical panel. In some embodiments, when the second wire manipulator is located on the other side of the electrical panel, wires are passed through gaps in the electrical panel.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Exemplary Robotic Electrical Cabinet Wiring System

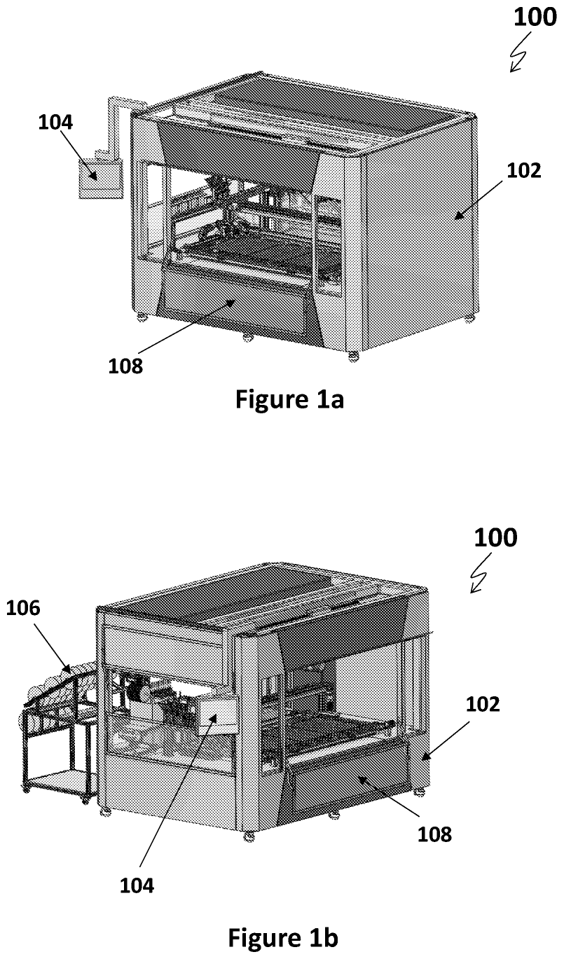

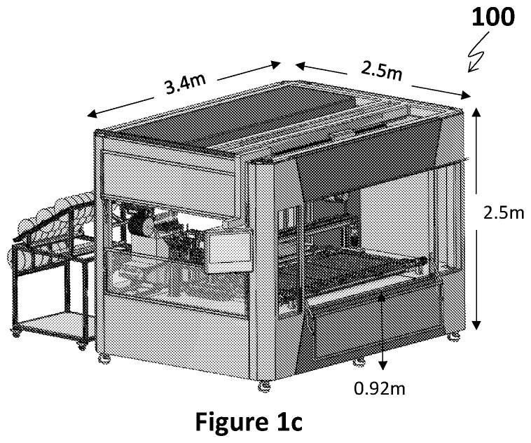

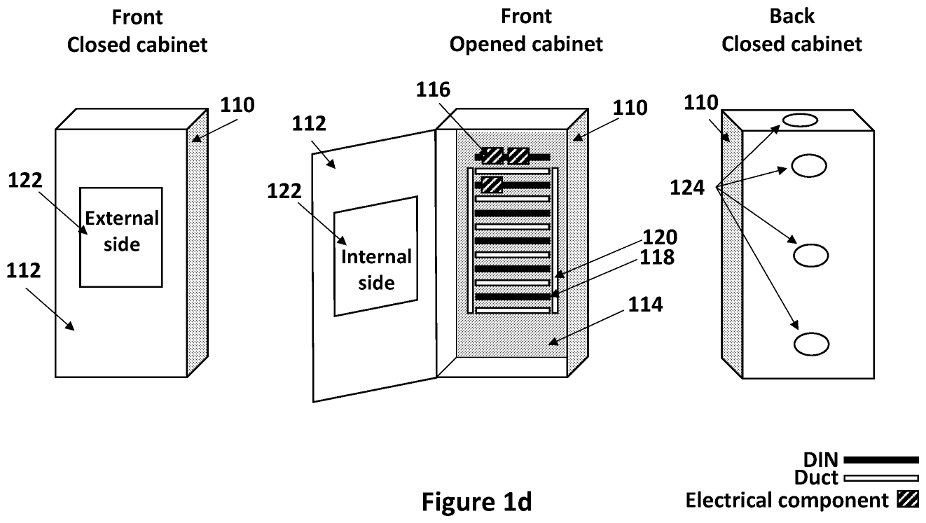

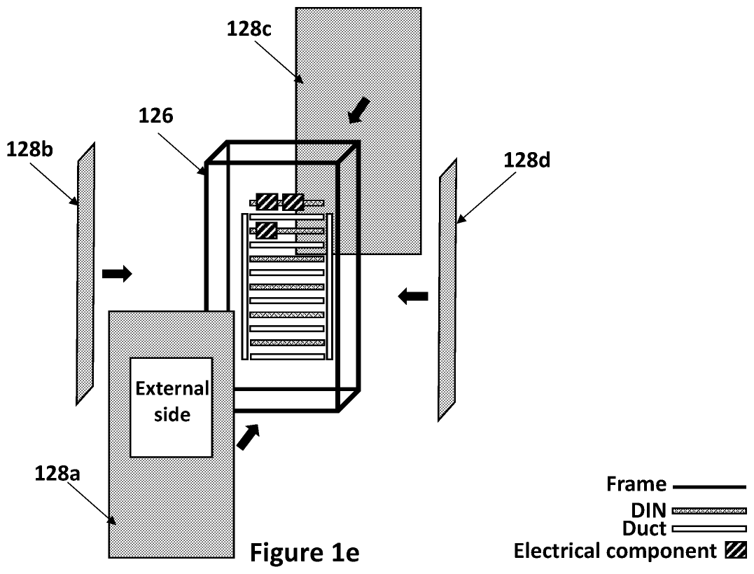

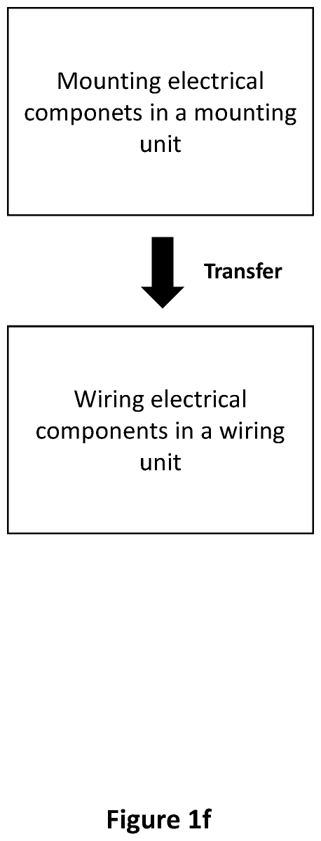

Referring now to FIGS. 1a-c, showing schematic representations of an exemplary robotic electrical cabinet wiring system, from different perspective views, according to some embodiments of the invention.

In some embodiments, an exemplary robotic electrical cabinet wiring system 100 comprises a plurality of mechanical, electrical and robotic components configured to work together in order to perform an automated robotic wiring process, for example, on an electrical cabinet. In the following paragraphs an electrical panel will be used as an example for explaining the invention. It should be understood that other devices can be wired using the system as disclosed herein.

In some embodiments, an automated robotic wiring process includes one or more (not a complete list) of the following actions:

1. Planning, optionally virtually planning, a configuration of a specific electrical panel, including planning the number and types of components required within the electrical panel, the specific position of each of the required components and the number, type and length of the wires required for the complete wiring of the electrical panel (according to the plan).

2. Preparing wires, including one or more of: choosing the type of wire, cutting the wire to a required length, adding required connectors to the ends of a wire, marking wires, optionally testing wires before using then in the specific electrical panel.

3. Transferring the wire between robotic units, during the wiring process (which may include also the preparation of the wires), the wires are transferred between one or more robotic units.

4. Connecting end of wires to electrical components: during the wiring process, end of wires are connected to electrical components, and the wires themselves are positioned between electrical components along dedicated paths within the electrical panel.

5. Positioning wires within the electrical panel: the wiring process includes connecting one end of a wire to a first electrical component, then positioning the wire along a dedicated path within the electrical panel, until reaching a second electrical component.

6. Testing: in some embodiments, optionally, one or more tests are performed during and/or after wiring actions to assess the correct wiring of the electrical panel. In some embodiments, testing may include one or more of testing the wires themselves (including for example testing that the end terminal is well crimped, for example by applying the right pulling force), testing the physical connection between wires and electrical components, testing that the force of pulling the wire from the component is above a certain threshold, testing the correct positioning and/or attachment of the wires in the predetermined paths. In some embodiments, the testing and/or monitoring is performed by one or more sensors.

The abovementioned actions are only general actions and are provided to allow a person having skills in the art to understand the context of the following explanations regarding the automated robotic wiring system and methods thereof.

In some embodiments, the robotic electrical cabinet wiring system 100 comprises an encasement 102 used to contain all the elements (for example one or more robotic units) of the system. In some embodiments, the encasement 102 is configured to provide a protected environment for the one or more robotic units to perform the robotic wiring process and to provide safety for the human users.

In some embodiments, the robotic electrical cabinet wiring system 100 comprises a graphical unit interface (GUI) 104 configured to allow a human user to interact with the system, for example, the GUI can be a touch-screen.

In some embodiments, the robotic electrical cabinet wiring system 100 comprises, either integrally attached or as an adjunct unit, a wire stand 106 comprising a plurality of wires that will be used during the wiring process, as schematically shown in FIGS. 1b-c.

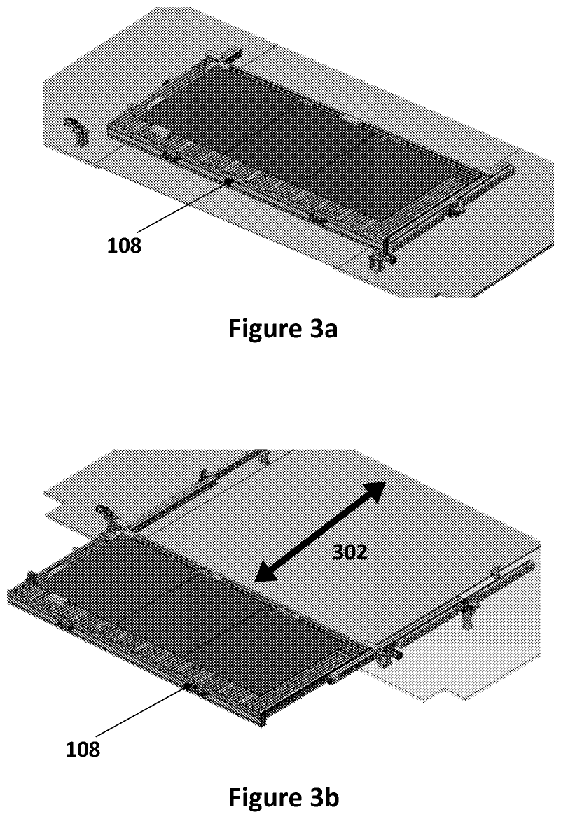

In some embodiments, the robotic electrical cabinet wiring system 100 comprises a cabinet loading table 108 configured to open and close (see FIGS. 3a-b) to allow the loading and unloading of the component being wired, for example, an electrical cabinet.

FIG. 1c shows exemplary sizes of an exemplary robotic electrical cabinet wiring system 100. In some embodiments, the exemplary robotic electrical cabinet wiring system 100 comprises a height of about 2.5 meters (m), for example, a height from about 2 m to about 4 m, optionally a height from about 2 m to about 5 m. In some embodiments, the exemplary robotic electrical cabinet wiring system 100 comprises a width of about 3.4 m, for example, a width from about 3 m to about 5 m, optionally a width from about 2 m to about 10 m. In some embodiments, the exemplary robotic electrical cabinet wiring system 100 comprises a depth of about 2.5 m, for example, a depth from about 2 m to about 4 m, optionally a depth from about 2 m to about 5 m. In some embodiments, the height of the cabinet loading table 108 is about 0.92 m from the surface on which the robotic electrical cabinet wiring system 100 is standing, for example a height from about 0.5 m to about 1.5 m, optionally a height from about 1 m to about 2 m. In some embodiments, the dimensions of an exemplary robotic electrical cabinet wiring system 100 are modified according to the component in need of wiring. For example, different sizes of electrical cabinets.

Referring now to FIG. 1d, showing a schematic representation of an exemplary electrical cabinet, according to some embodiments of the invention. In the following paragraphs an exemplary electrical cabinet will be disclosed. It should be understood that the following are general explanations to allow a person having skills in the art to understand the invention and that other configurations are included in the scope of the invention. In some embodiments, a wire cabinet comprises a main body or cabinet 110, usually having a door 112. In some embodiments, the main body 110 houses one or more electrical panels 114, on which one or more electrical components 116 are mounted (usually on one or more racks or rails—also called DIN rails 118). In some embodiments, additionally, the one or more electrical panels 114 comprise one or more ducts 120 (also shown for example in FIG. 18c) configured to receive one or more electrical wires (referred herein just as wire)—not shown—that connect between different electrical components within the electrical cabinet. In some embodiments, an electrical cabinet comprises other electrical components, for example switches, lights and digital displays (shown in the figure as number 122) that usually comprise an external part, which can be accessed and/or viewed by an user, and an internal part, which allows the connection of those electrical components located on the door, to electrical components within the cabinet. In some embodiments, the electrical cabinet comprises one or more openings 124 on the back of the cabinet that allow the passage of wires from the outside of the electrical cabinet to the inside of the electrical cabinet. In some embodiments, the electrical cabinet can have any number of openings, at any number of locations, having any size.

Referring now to FIG. 1e, showing a schematic representation of an exemplary electrical cabinet comprising a frame and removable/mountable covers, according to some embodiments of the invention. In some embodiments, an exemplary electrical cabinet is made of mountable walls/covers 128a-d that are attached to a frame 126. In some embodiments, the DIN rails are mounted on the frame 126 (schematically shown in FIG. 1d) with access from both sides. In some embodiments, the covers 128b-d and doors 128a are mounted after the wiring process. A potential advantage of using this kind of electrical cabinet is that it allows easy access from both sides during the wiring process which allows access to locations within the electrical cabinet that may be difficult and/or not possible with one side access.

Referring now to FIG. 1f, showing a schematic representation of a two-step electrical panel preparation process, according to some embodiments of the invention. In some embodiments, an electrical cabinet is mounted on a dedicated mounting unit. In some embodiments, the mounting unit is similar to the robotic units shown in FIGS. 1a-1c, with the difference that the mounting unit is configured to mount one or more electrical components within the electrical cabinet, for example, using one or more robotic units. In some embodiments, once the electrical components are mounted in the electrical cabinet, the electrical cabinet is transferred to a wiring unit, for example as shown in FIGS. 1a-1c, to be wired. In some embodiments, the mounting unit and the wiring unit are located one near each other and the transfer is performed by automated means. In some embodiments, the mounting unit and the wiring unit are one and the same.

In some embodiments, the mounting unit can mount components for 2 wiring units in order to balance the workload—for example the mounting of component may take 10 minutes while wiring 25 minutes—therefore one mounting unit can “serve” 2 wiring systems.

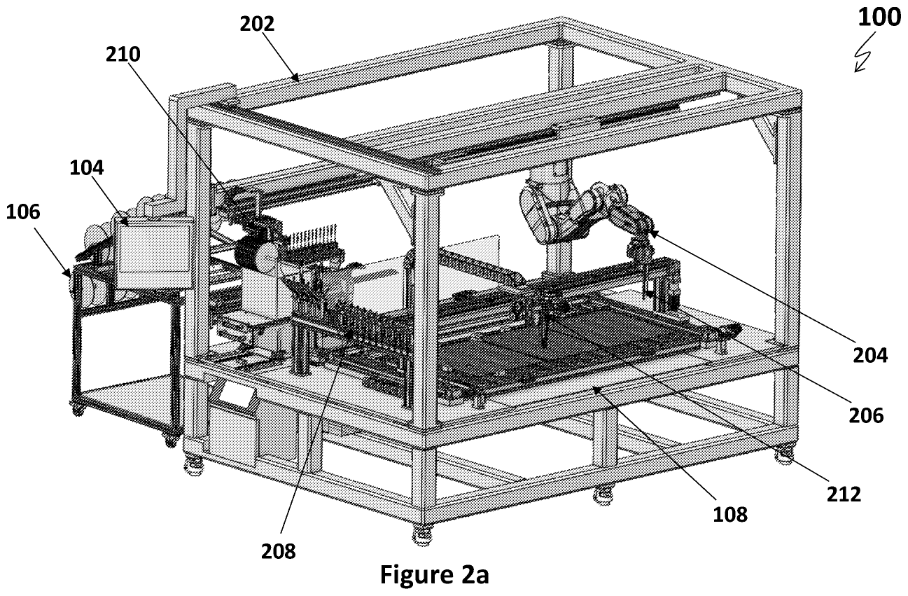

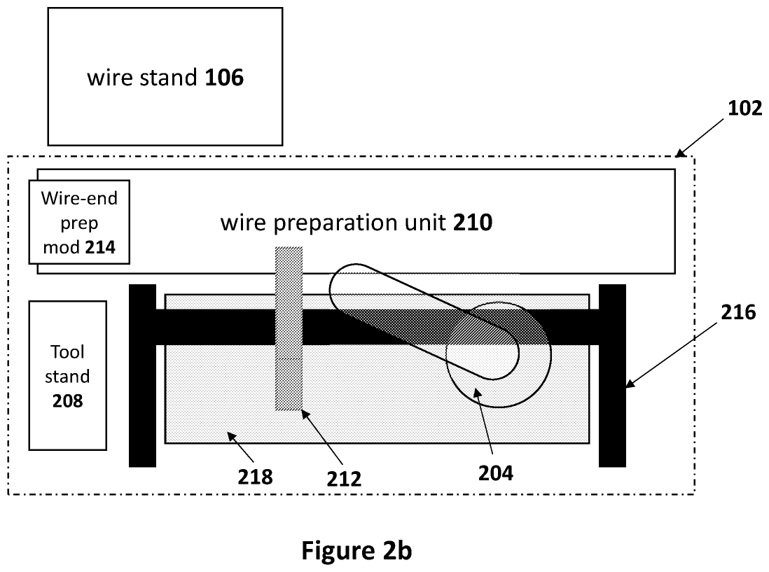

Referring now to FIG. 2a, showing a schematic representation of an internal view of an exemplary robotic electrical cabinet wiring system, according to some embodiments of the invention. Additionally, referring to FIG. 2b, showing a schematic representation of an upper view of a schematic diagram of an exemplary robotic electrical cabinet wiring system 100, according to some embodiments of the invention.

Same referral numbers are used for same parts in all figures.

In some embodiments, the encasement 102 is held by a dedicated chassis 202 configured to hold the cover panels of the encasement 102, and to function as a base for other units of the system. FIG. 2a also shows the graphical unit interface (GUI) 104, the wire stand 106 and the cabinet loading table 108, as shown for example in FIGS. 1a-b.

In some embodiments, an exemplary robotic electrical cabinet wiring system 100 comprises one or more robotic units, for example robotic arms 204, configured to manipulate wires during the robotic wiring process. Detail description of exemplary robotic arms 204 are provided in U.S. patent application No. 63/447,076, and also, partially, below. In some embodiments, exemplary robotic arms 204 optionally comprise an end-effector 206, optionally comprising an interchangeable tool at a distal end. In some embodiments, exemplary interchangeable tools can be tweezers, wires holders, screw drivers, data ports, cable holders and more. In some embodiments, an exemplary robotic electrical cabinet wiring system 100 comprises a dedicated stand with interchangeable tools 208, which can be accessed by the one or more robotic arms 204.

In the following paragraphs a robot arm 204 will be used as an example to allow a person having skills in the art to understand the invention. It should be understood that any other robotic unit configured for the manipulation of wires can be used, and also those, form part of the scope of the invention.

In some embodiments, an exemplary robotic electrical cabinet wiring system 100 comprises an automatic robotic wire preparation unit 210 configured to prepare the wires that are going to be used during the robotic wiring process (see below for further explanations on the wire preparation unit 210). In some embodiments, the wire preparation unit 210 comprises a wire-end preparation module 214 configured to add an end connector to the wire (see for example FIG. 2b and further explanations below).

In some embodiments, an exemplary robotic electrical cabinet wiring system 100 comprises a wire laying and positioning robotic unit 212 configured to position and lay down the wires during the robotic wiring process (see below for further explanations on the wire laying and positioning robotic unit 212). In some embodiments, the wire laying and positioning robotic unit 212 is configured to move in three-dimensions (right-left, forwards-backwards and up-down). In some embodiments, the movement is provided by a robotic unit, for example a robotic arm or a gantry. For the following explanations, a gantry 216 will be used as an example. It should be understood that every time a gantry is disclosed, it also refers to any other robotic unit that can provide the same functions, for example as mentioned above, a robotic arm. In some embodiments, the wire laying and positioning robotic unit 212 is mounted on a dedicated gantry 216 configured to allow free movement in two directions (left-right and forward-backward) and optionally in 3 directions (left-right, forward-backward and up-down movements) over the electrical cabinet 218 being wired.

As can be schematically seen in FIG. 2b, the one or more robotic arms 204 are configured to reach each of the other units, for example, to reach the wire preparation unit 210, the dedicated stand with interchangeable tools 208 and any location within the electrical panel 218 being wired. In some embodiments, the gantry 216 of the wire laying and positioning robotic unit 212 provides freedom to reach any location over the electrical panel 218 being wired. In some embodiments, alternatively or additionally, different robotic arrangements are used to automatically wire a panel, for example, 2, 3 or 4 robotic arms, 2 or more gantries (for example, one used for wire insertion while other for wire paving/routing).

Referring now to FIGS. 3a-b, showing a schematic representation of the actuation of an exemplary cabinet loading table 108, according to some embodiments of the invention. FIG. 3a shows an exemplary cabinet loading table 108 in a closed configuration. In some embodiments, the cabinet loading table 108 can be moved forwards and backwards, as schematically shown for example in FIG. 3b by arrow 302, in order to mount on the electrical panel 218 (not shown) and to allow for human users to work on the electrical panel 218, while the cabinet loading table 108 is open. In some embodiments, when the cabinet loading table 108 is closed, it allows for all the relevant units of the exemplary robotic electrical cabinet wiring system 100 to reach any part within the electrical panel 218. In some embodiments, optionally, an additional robotic system is integrated to the cabinet loading table 108 for loading/unloading panels (not shown).

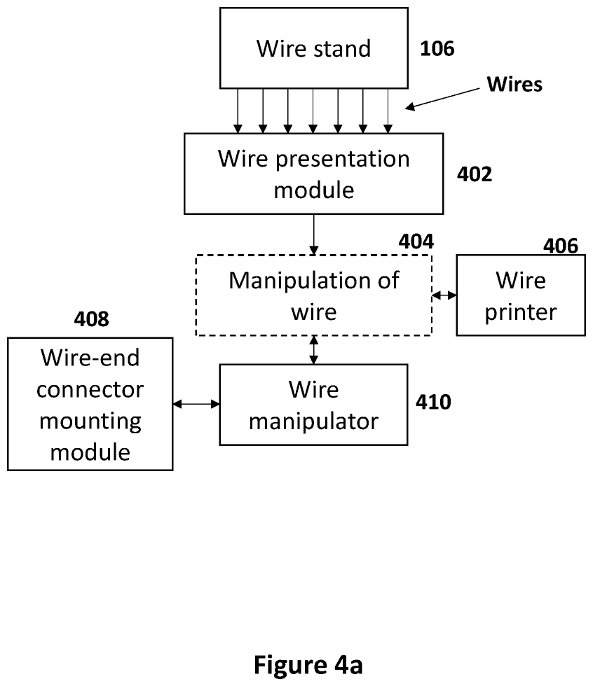

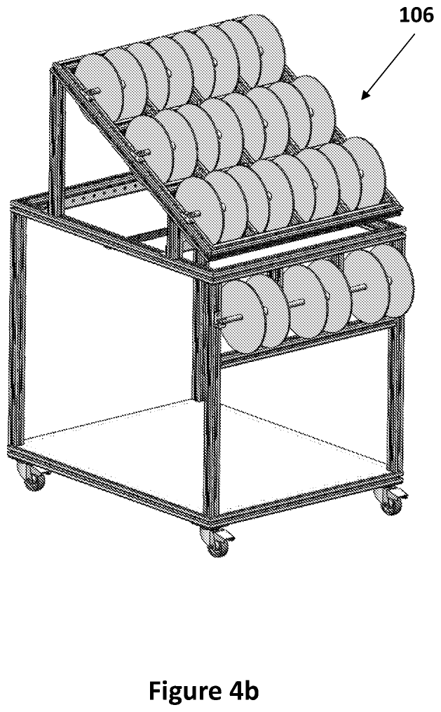

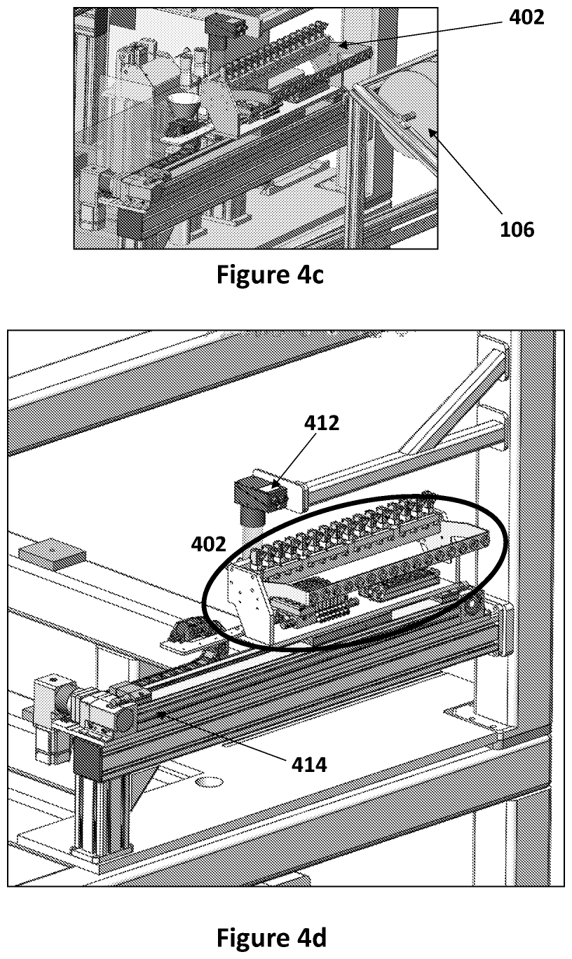

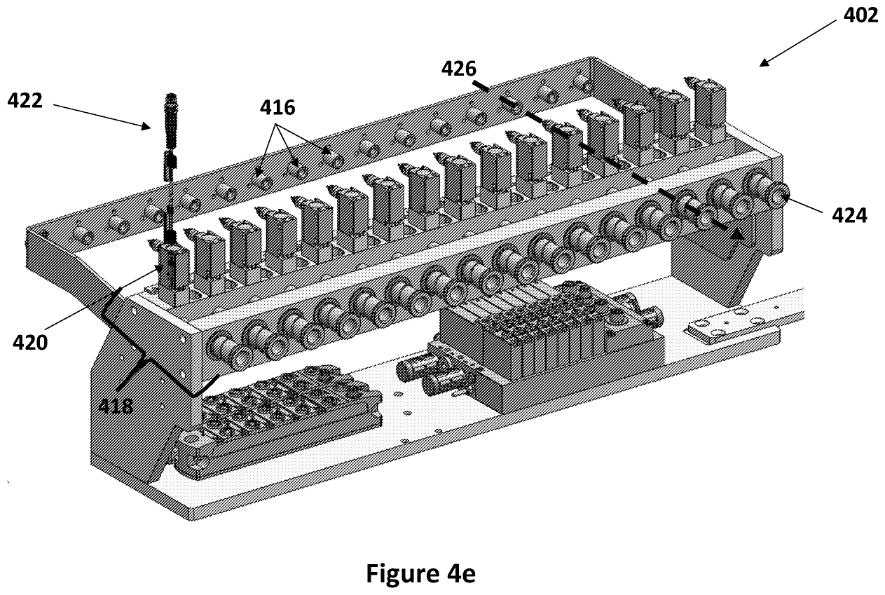

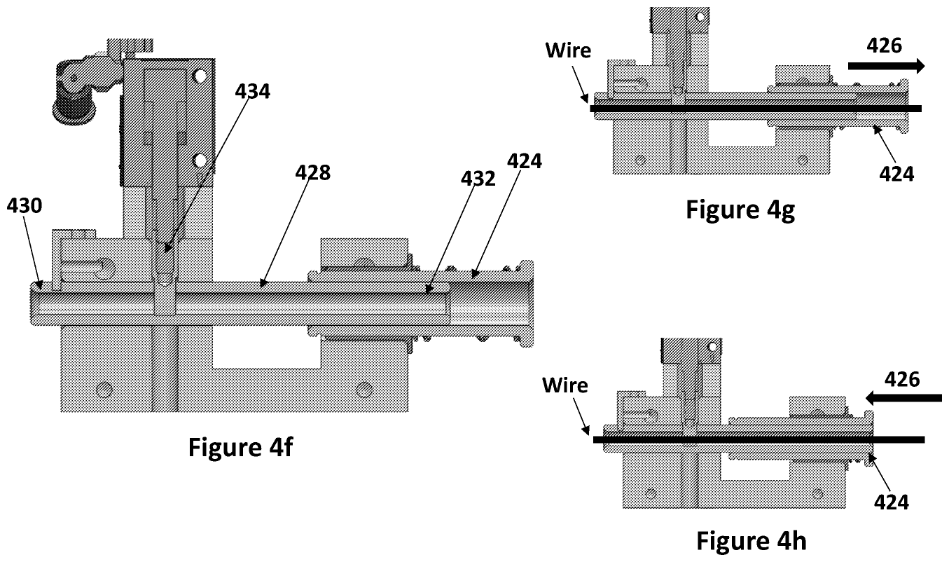

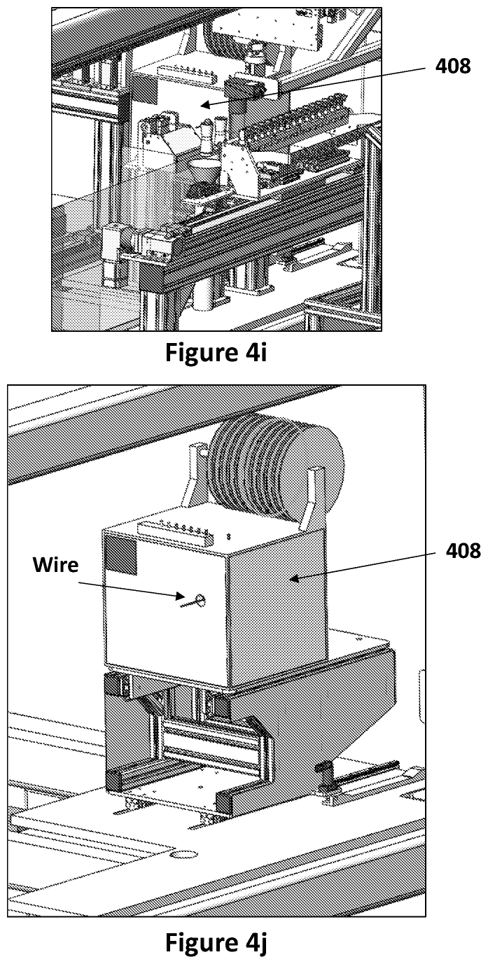

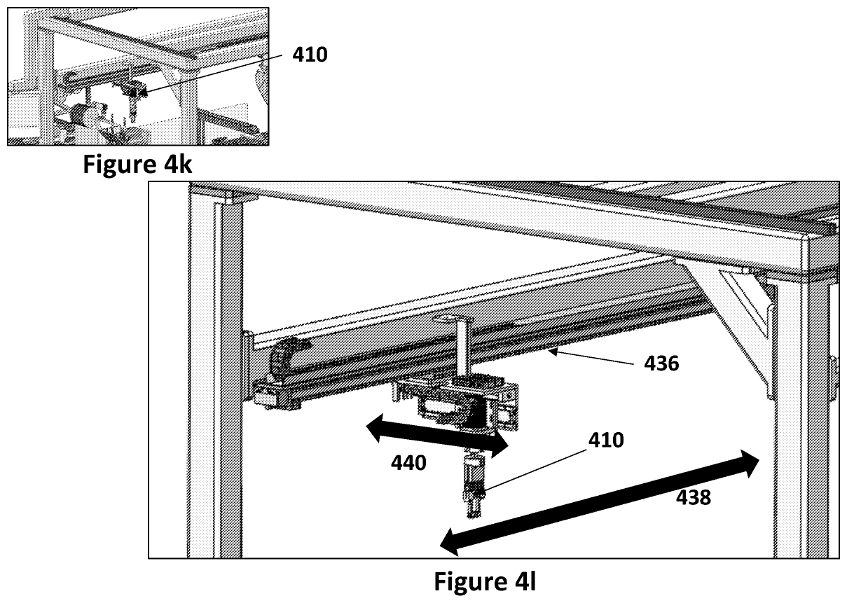

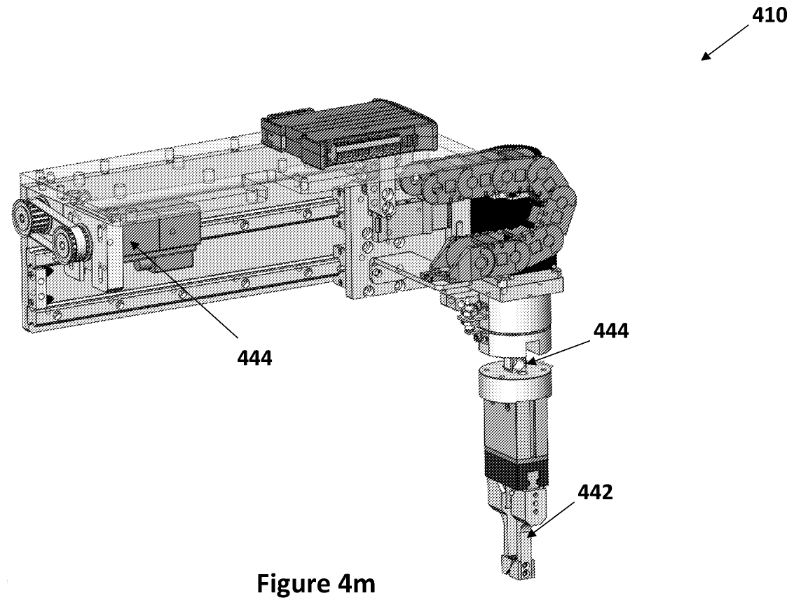

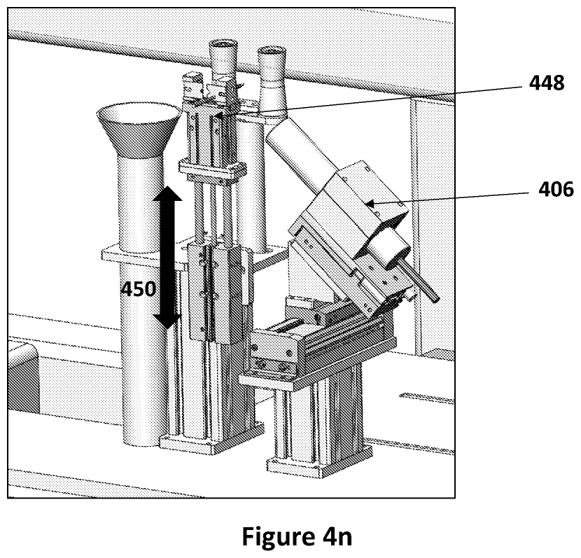

Referring now to FIGS. 4a-n showing schematic representations of exemplary wire preparation units 210, according to some embodiments of the invention.

Referring now to FIG. 4a, showing a schematic diagram of an exemplary wire preparation unit 210, according to some embodiments of the invention. In some embodiments, the wire stand 106 is positioned near the wire preparation unit 210. FIG. 4b shows a schematic representation of an exemplary wire stand 106, according to some embodiments of the invention. In some embodiments, an exemplary wire stand 106 can hold between 10 and 20 spools of wires, optionally from about 5 to about 30 spools of wires, optionally more than 30 spools of wires. In some embodiments, the spools of wire can have identical dimensions or can be of different dimensions. In some embodiments, an exemplary wire stand 106 comprises wheels that facilitate the movement of the wire stand 106. In some embodiments, a wire stand can be pre-set for certain jobs and be attached to the system upon execution of said job. In some embodiments, the actuation of the spools in the wire stand 106 is manual or passive, meaning that pulling a wire from the spool causes the rotation of the spool. In some embodiments, the actuation of the wire stand is mechanical or active, meaning that the wire stand 106 comprises dedicated motors that actively actuate the spools causing the movement of the wires out of the spools.

In some embodiments, an exemplary wire preparation unit 210, comprises a wire presentation module 402 configured to hold and present a plurality of wires that are received from the wire stand 106 (see also FIG. 4e). In some embodiments, a human user feeds the wires from the wire stand 106 into the wire presentation module 402. In some embodiments, a dedicated robotic arm or robotic unit (not shown) feeds the wires from the wire stand 106 into the wire presentation module 402. In some embodiments, the wires in the wire presentation module 402 are locked until a specific type of wire present in the wire presentation module 402 is needed, which is then released so it can be manipulated 404 by other robotic units, as will further explained below.

In some embodiments, an exemplary wire preparation unit 210, comprises a dedicated wire printer 406 configured to print on the wire being prepared. In some embodiments, a potential advantage of printing on the wire is that it later facilitates a human user to identify the relevant wire between pluralities of wires. In some embodiments, additionally or alternatively, a labeling machine is used to label the wires by mounting a label on the wire. In some embodiments, a labeling sleeve is inserted to the wire at this stage.

In some embodiments, an exemplary wire preparation unit 210, comprises a dedicated wire-end connector mounting module 408 configured to mount an end connector on an end of a wire. In some embodiments, the wire-end connector mounting module 408 is configured to receive an end of a wire and automatically stripped it and mount a connector/wire head, also known in the art, for example, as ferrule. Wire connectors/wire heads are known in the art, and they can be for example one or more of ring connectors, spade connectors and blade connectors.

In some embodiments, an exemplary wire preparation unit 210, comprises a dedicated wire manipulator 410 configured to perform the manipulation actions 404 to the wire during the preparation process and, optionally, present the prepared wire to the one or more robotic arms 204. In some embodiments, the wire manipulator 410 grabs a first end of a wire from the wire presentation module 402 and brings it to the wire-end connector mounting module 408. In some embodiments, after finishing with the first end of the wire, the necessary length of the wire is pulled from the spool through the wire presentation module 402, then cut so as to generate a second end of the wire (before or after labeling the wire), which is then grabbed by the wire manipulator 410 and brought to the wire-end connector mounting module 408 so the second end will also have an end connector. In some embodiments, at this point, the wire is ready to be used for the wiring process.

Referring now to FIGS. 4c, 4d, 4e and 4f, showing schematic representations of an exemplary wire presentation module 402 and its internal mechanisms, according to some embodiments of the invention. FIG. 4c, schematically shows an exemplary positioning of an exemplary wire stand 106 in front of an exemplary wire presentation module 402, while FIG. 4d shows the wire presentation module 402 in its exemplary location in the wire preparation unit 210. In some embodiments, the wire preparation unit 210, optionally comprises a dedicated camera (or one or more sensors) 412 as part of a wire identification system of the robotic electrical cabinet wiring system 100 configured to identify characteristics of the wire, for example, a color of the wire, the diameter of a wire, etc. In some embodiments, the wire presentation module 402 is mounted on ta dedicated rail 414, configured to allow horizontal movement of the wire presentation module 402 in order to bring a specific wire within the wire presentation module 402 in front the wire manipulator 410.

Referring now to FIG. 4e, showing a schematic representation of an exemplary wire presentation module 402, according to some embodiments of the invention. In some embodiments, the wire presentation module 402 comprises a plurality of wire inlets 416, from which wires from the wire stand 106 are inserted. In some embodiments, each of the wires are then inserted in to a protecting bushing 418. In some embodiments, the protecting bushing 418 comprises a locking wire mechanism 420. In some embodiments, for example, the wire locking mechanism 420 is a piston actuated wire locking mechanism, and optionally comprises a sensor 422 (schematically shown outside the wire locking mechanism in FIG. 4e). In some embodiments, the protecting bushing 418 comprises a plurality of wire outlets 424 from which the end of the wire exits and it is presented (herein the reason of the name “wire presentation module”) to the wire manipulator 410. Arrow 426 schematically shows the path that a wire does from the wire inlets 416, into the protecting bushing 418 and exiting via the wire outlets 424.

Referring now to FIG. 4f, showing a schematic representation of a locking mechanism with the protecting bushing 418, according to some embodiments of the invention. FIG. 4f shows a side view middle section of the locking mechanism within the protecting bushing 418. In some embodiments, each individual protecting bushing comprise one or more of: A tube 428, having a proximal end 430 and a distal end 432. In some embodiments, the proximal end receives the wire exiting from the wire inlets 416. In some embodiments, the distal end is covered by a wire outlet 424; and a locking mechanism 434 configured lock the wire in place. In FIG. 4f, the locking mechanism 434 comprises a pin configured to move vertically and press the wire that is inside the tube 428, thereby locking it in place. In some embodiments, the wire outlet 424 is configured to move horizontally in order to either hide the end of the wire, as shown for example in FIG. 4g, or expose the end of wire, thereby presenting the wire, as shown for example in FIG. 4h. In some embodiments, the distance that the wire outlet 424 moves provides an exposed end of a wire having a length of from bout 15 mm to about 25 mm, optionally having a length of from about 10 mm to about 30 mm, optionally having a length of from about 5 mm to about 50 mm, for example 20 mm, 35 mm, 40 mm. In some embodiments, this length is used to allow space for cutting the wire at the required position while keeping the rest of the wire inserted within the wire presentation module 402.

Referring now to FIG. 4i-j, showing schematic representation of exemplary wire-end connector mounting module 408, according to some embodiments of the invention. FIG. 4i shows an exemplary location of a wire-end connector mounting module 408 within the robotic electrical cabinet wiring system 100, while FIG. 4j shows an example of how the wire-end connector mounting module 408, looks like. As mentioned above, the wire-end connector mounting module 408 comprises dedicated hardware configured for stripping an end of a wire from its plastic cover and mount a dedicated connector, thereby preparing the wire to be connected into an electrical component.

Referring now to FIGS. 4k, 4l and 4m, showing schematic representations of an exemplary wire manipulator 410, according to some embodiments of the invention. FIG. 4k shows a relative location of an exemplary wire manipulator 410 within the robotic electrical cabinet wiring system 100, while FIG. 4l shows a clean view of the exemplary wire manipulator 410. In some embodiments, the exemplary wire manipulator 410 is mounted on a dedicated rail 436 that allows horizontal movement of the wire manipulator 410 (as schematically shown by arrow 438). In some embodiments, the wire manipulator 410 comprises a motor (see also FIG. 4m) that provides the wire manipulator 410 with a side movement that is perpendicular to the previous mentioned horizontal movement, as schematically shown by arrow 440. Referring now to FIG. 4m, showing a schematic detail representation of an exemplary wire manipulator 410, according to some embodiments of the invention. In some embodiments, the exemplary wire manipulator 410 comprises a gripper 442 configured to hold/grip an end of wire (which is the one presented to the wire manipulator 410 at the wire outlet 424 by the wire presentation module 402), and preform preparation action by moving the end of a wire form one location to another within the wire preparation unit 210 (see below exemplary method of wire preparation). In some embodiments, the gripper 442 comprises a tension sensor 444 configured to provide feedback to the system of the behavior of the wire being moved by the wire manipulator 410 (for example to identify if the wire is tangled on something). In some embodiments, as mentioned above, the gripper 442 comprises a motor 446 that provides the gripper 442 with the side movement.

In some embodiments, the wire manipulator 410 can be a robotic unit actuated differently, for example, an additional robotic arm configured to move at any direction without the need of the rail 436.

Referring now to FIG. 4n, showing schematic representation of additional components of the wire preparation unit 210, according to some embodiments of the invention. In some embodiments, as mentioned above, the wire preparation unit 210 comprises a wire printer 406, configured to mark the wire exiting form the wire presentation module 402. In some embodiments, the wire preparation unit 210 comprises a wire cutter 448, configured to cut the wire when a desired length of the wire is reached, thereby generating the other end of the wire. In some embodiments, optionally, the wire cutter 448 is configured to move vertically (up and down), as schematically shown by arrow 450. In some embodiments, the wire cutter 448 is located in the wire manipulator 410.

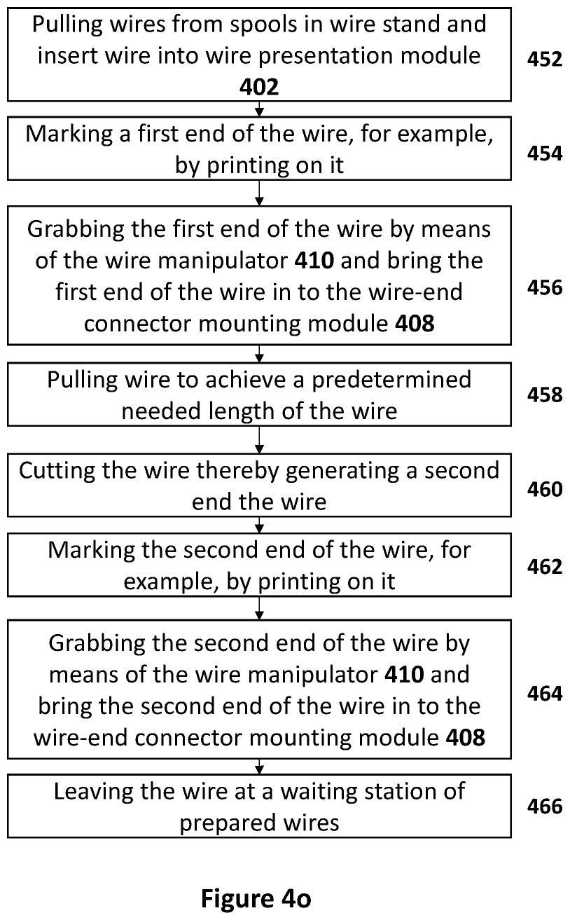

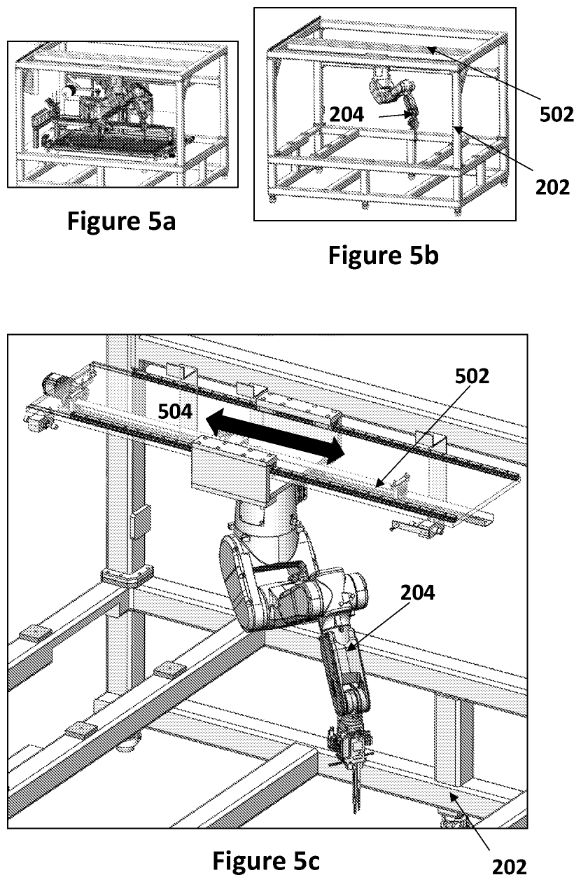

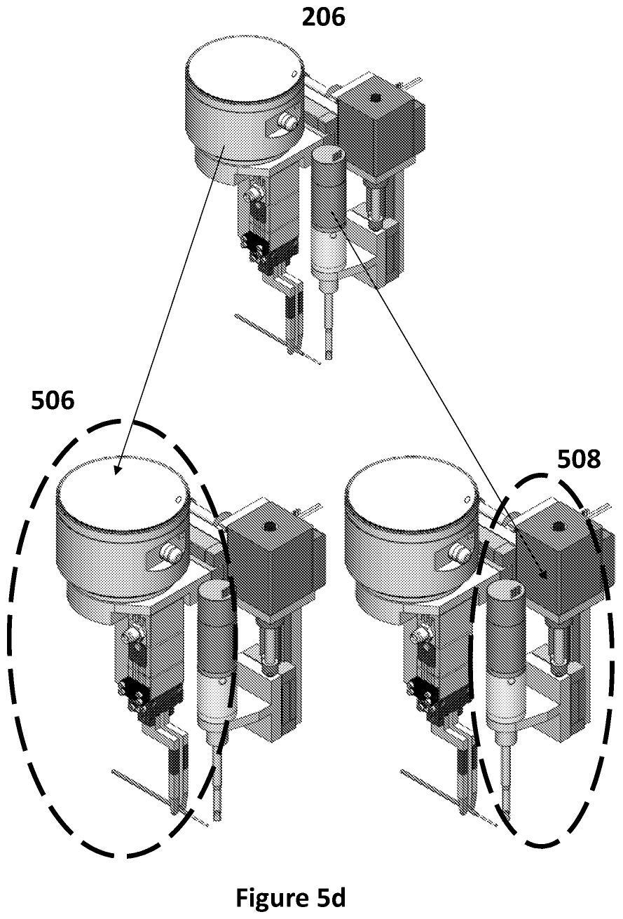

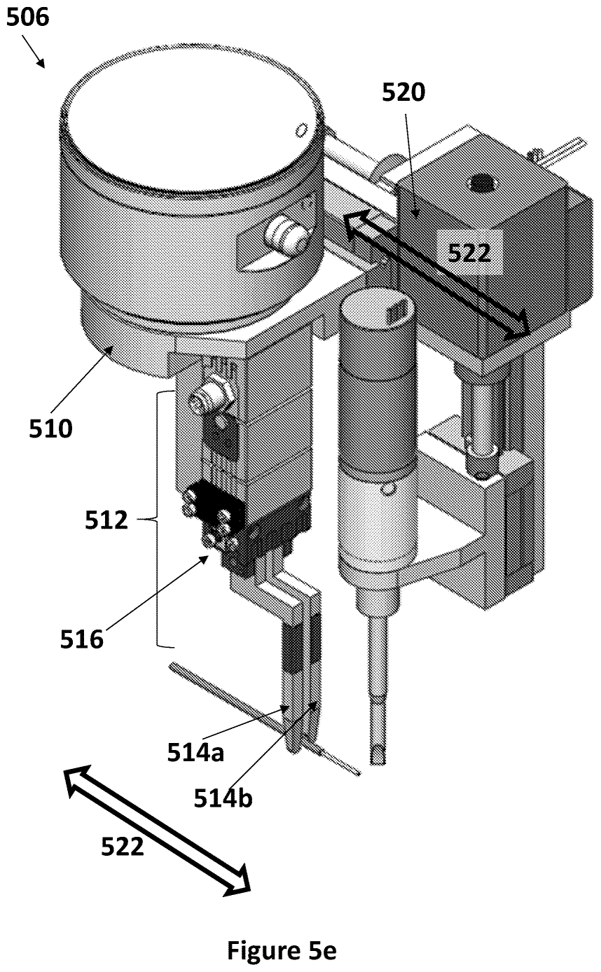

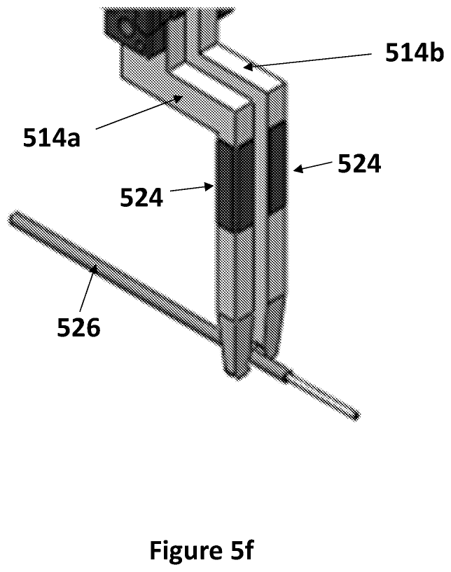

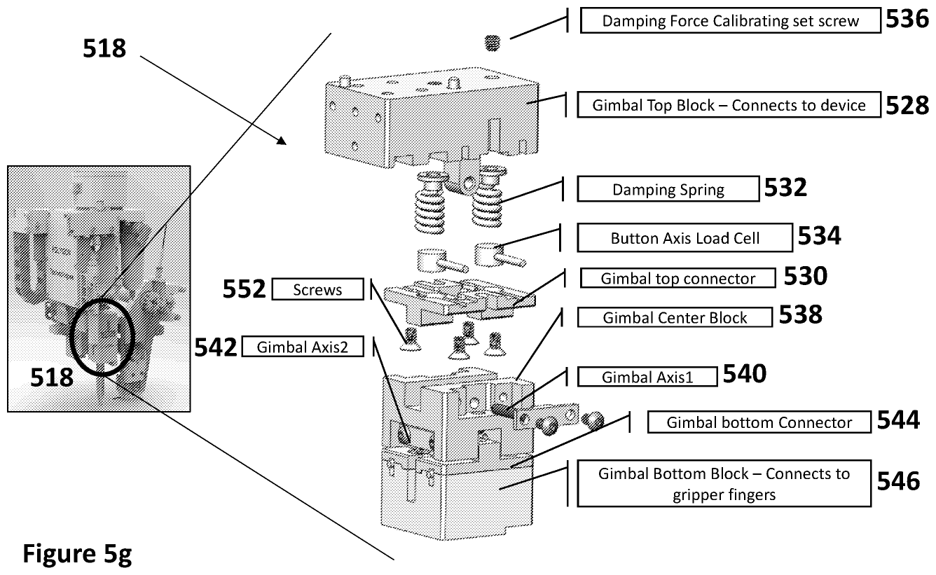

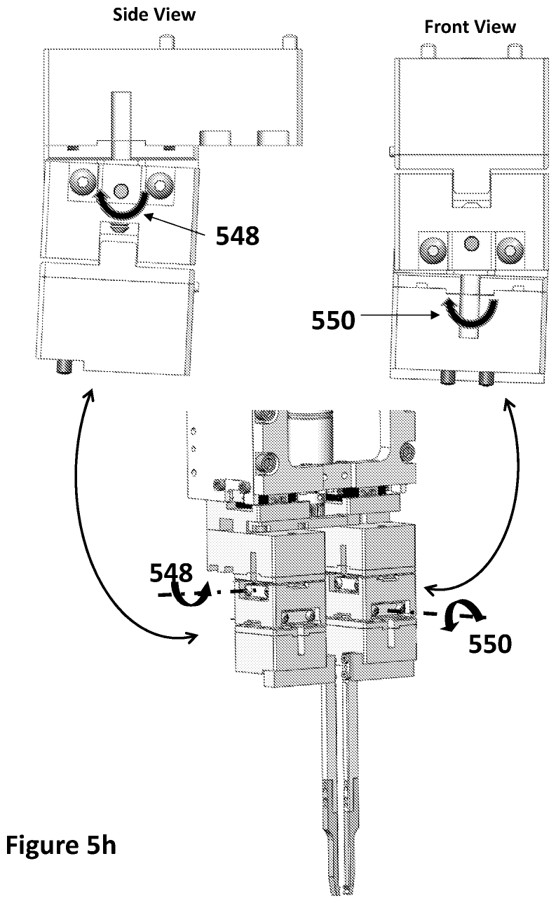

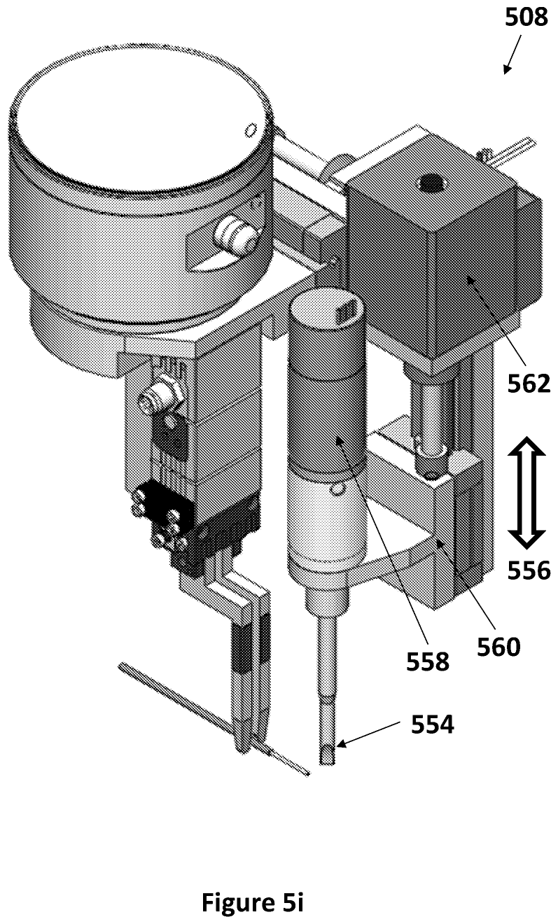

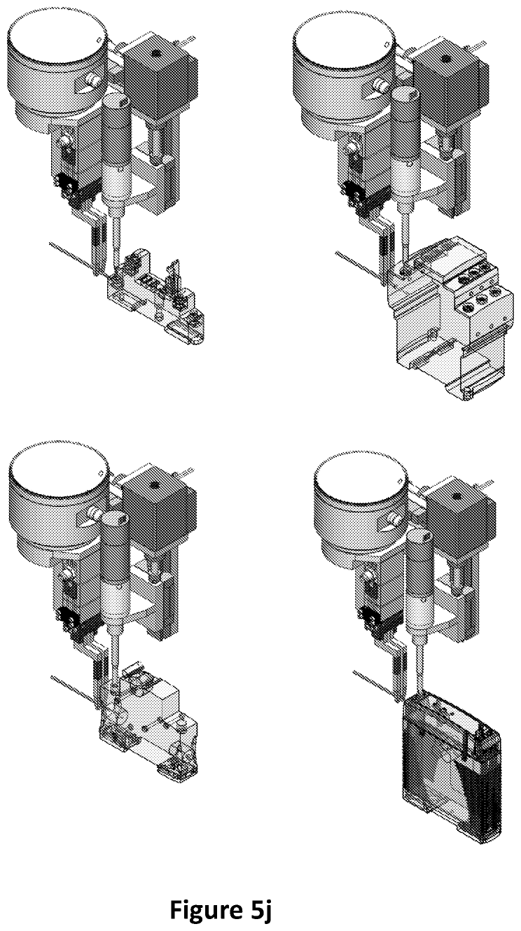

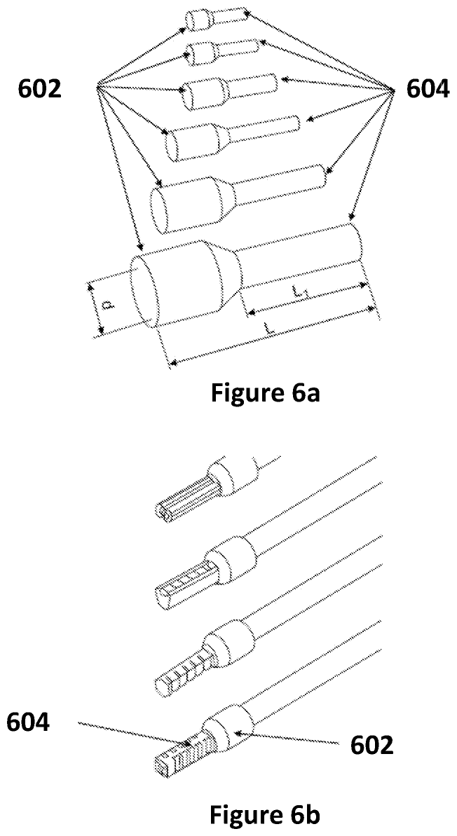

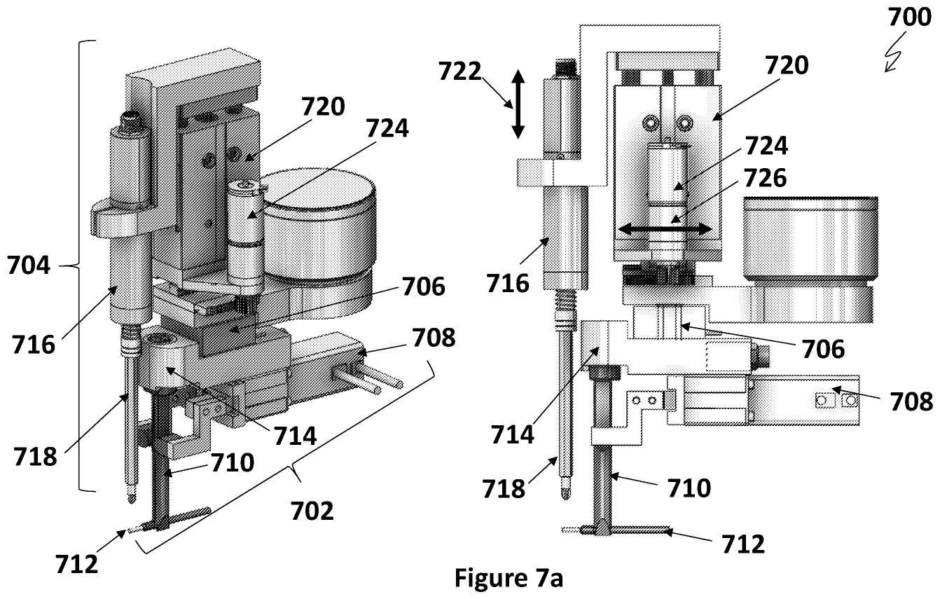

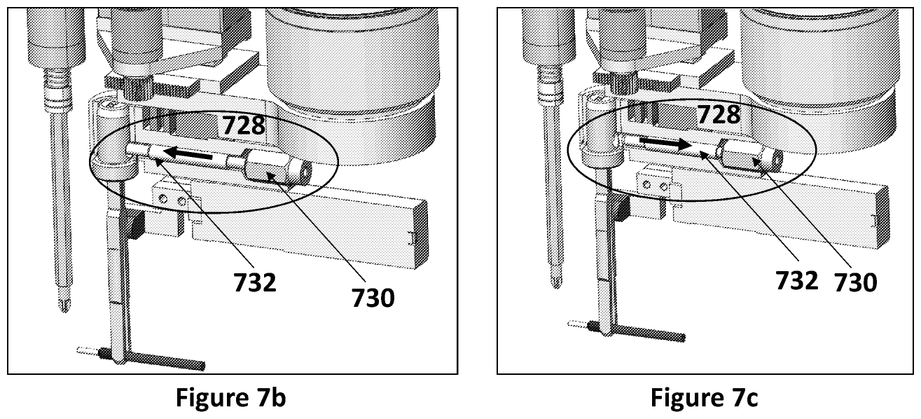

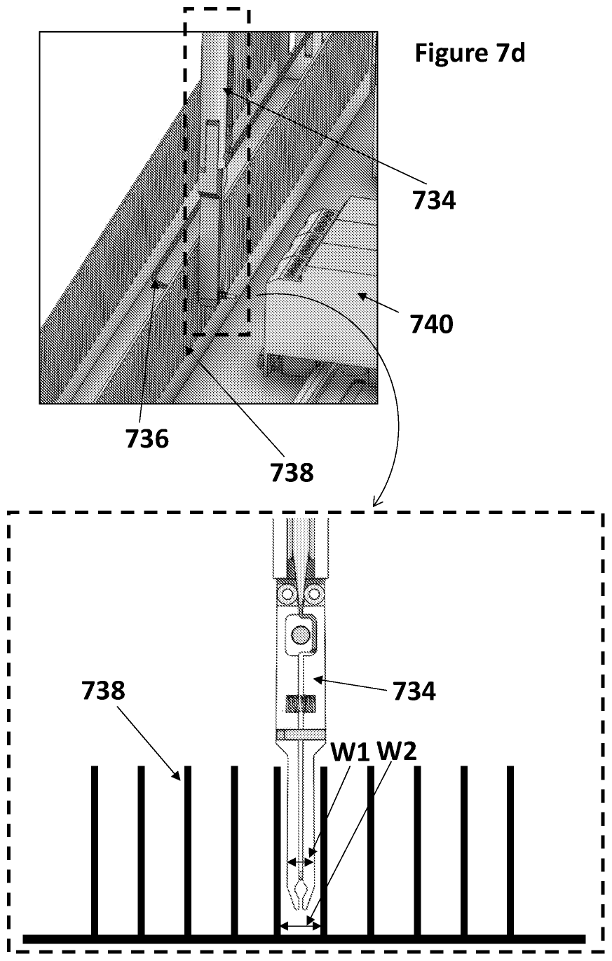

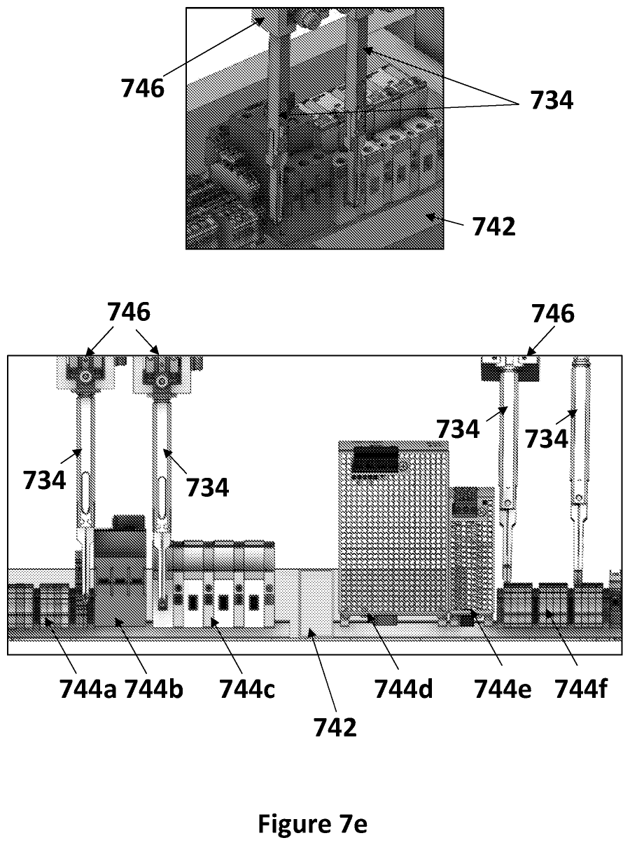

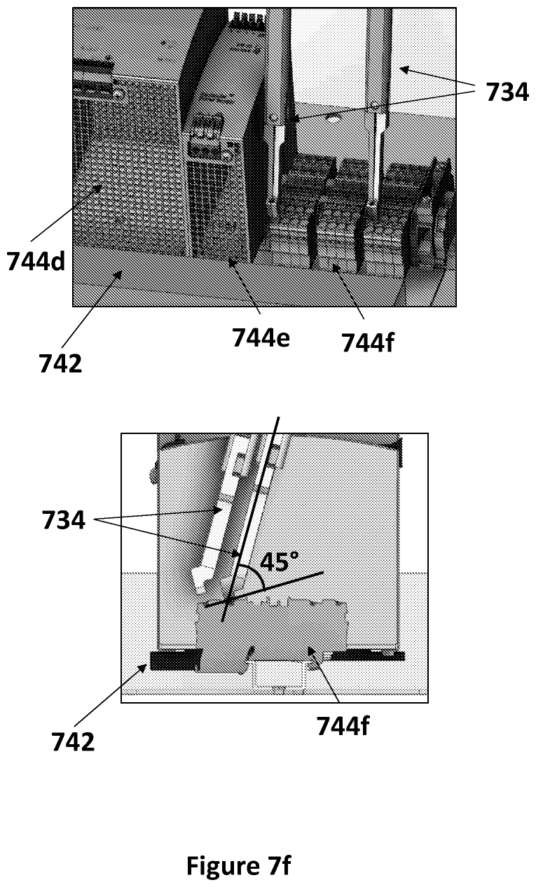

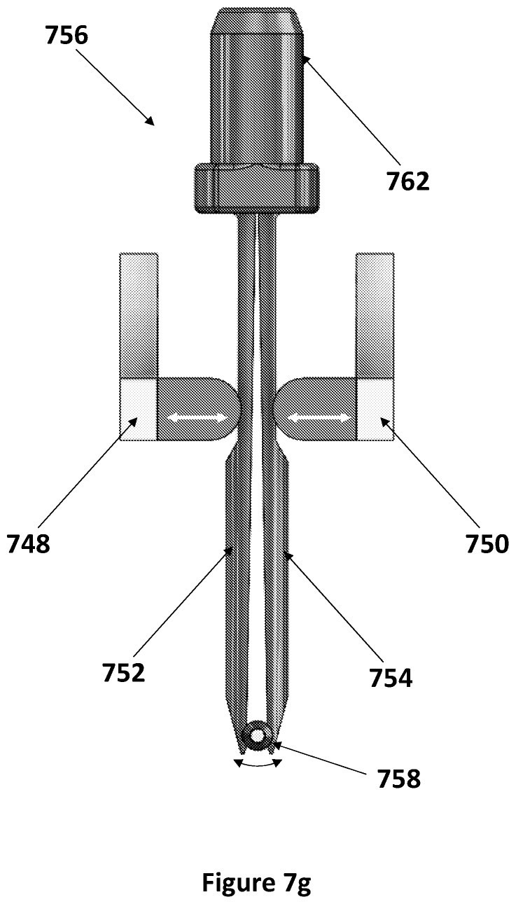

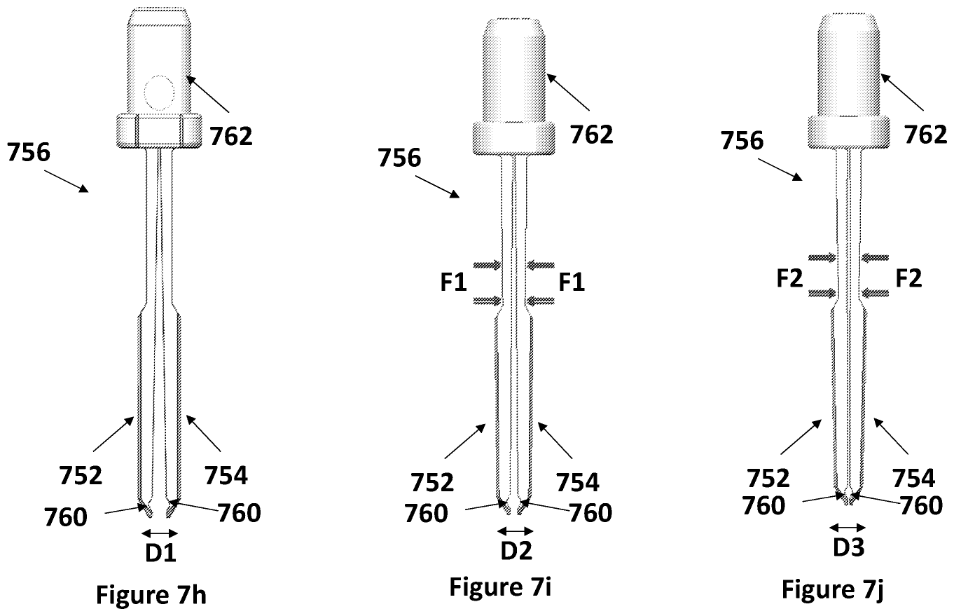

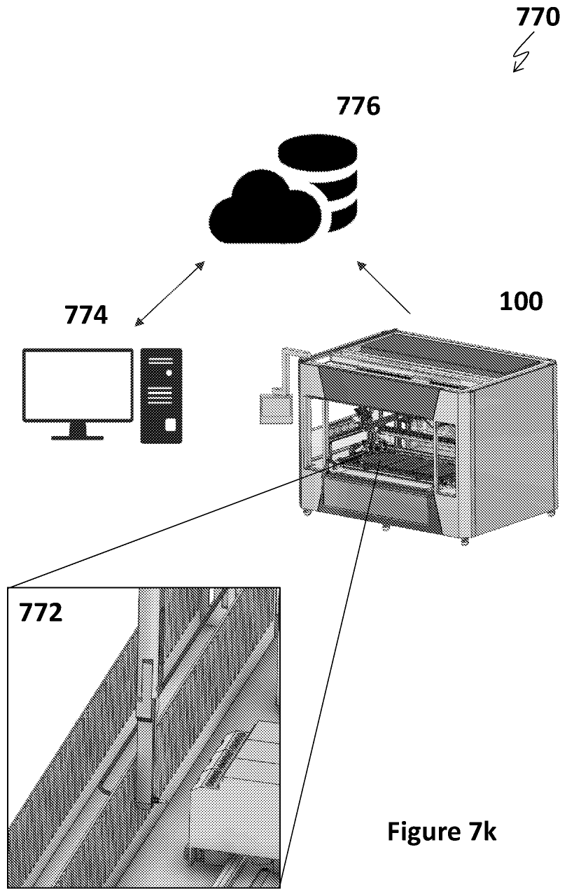

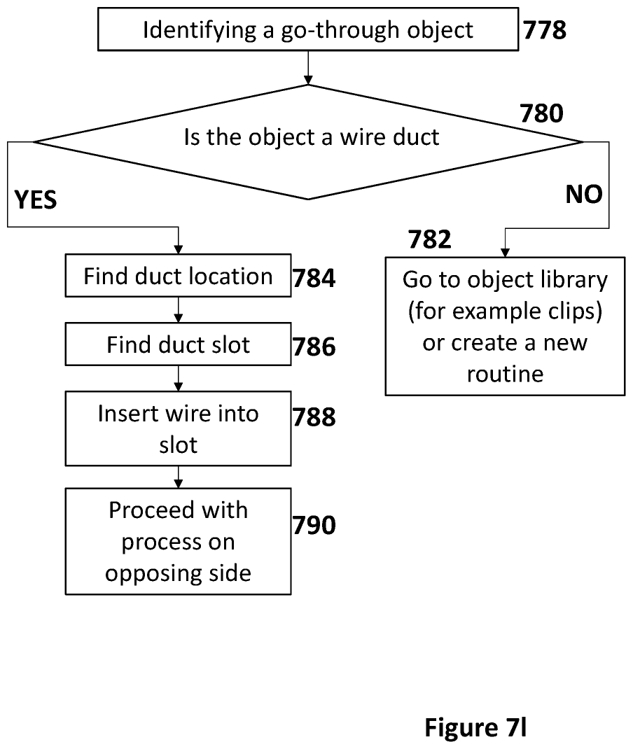

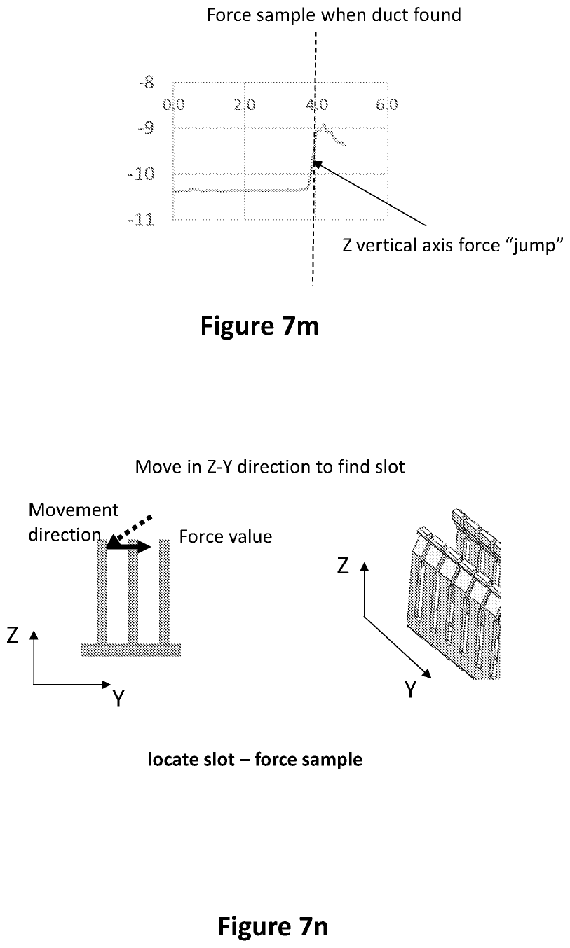

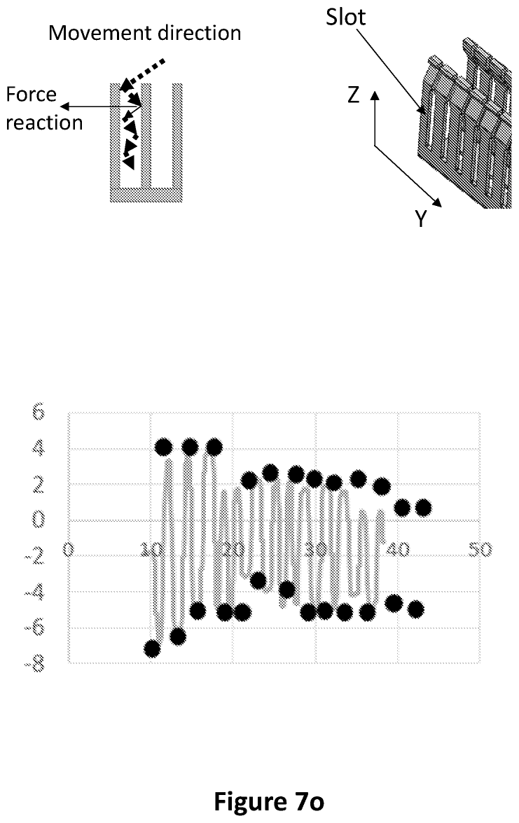

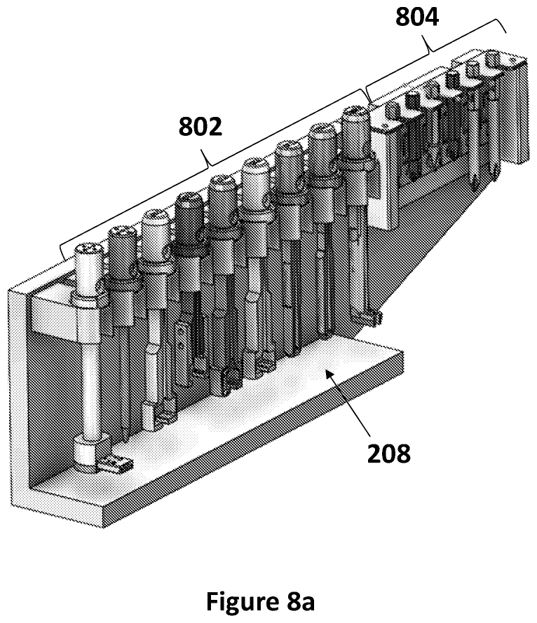

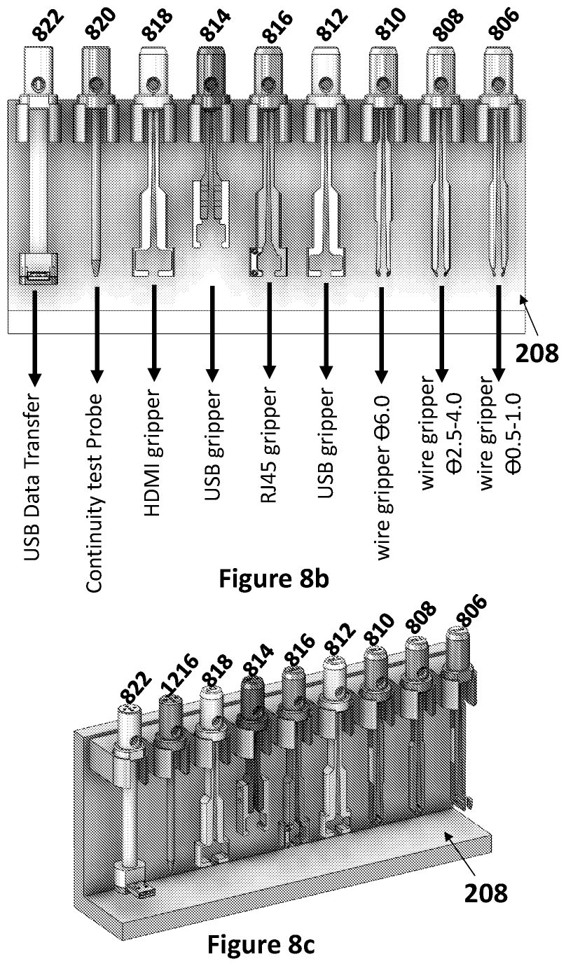

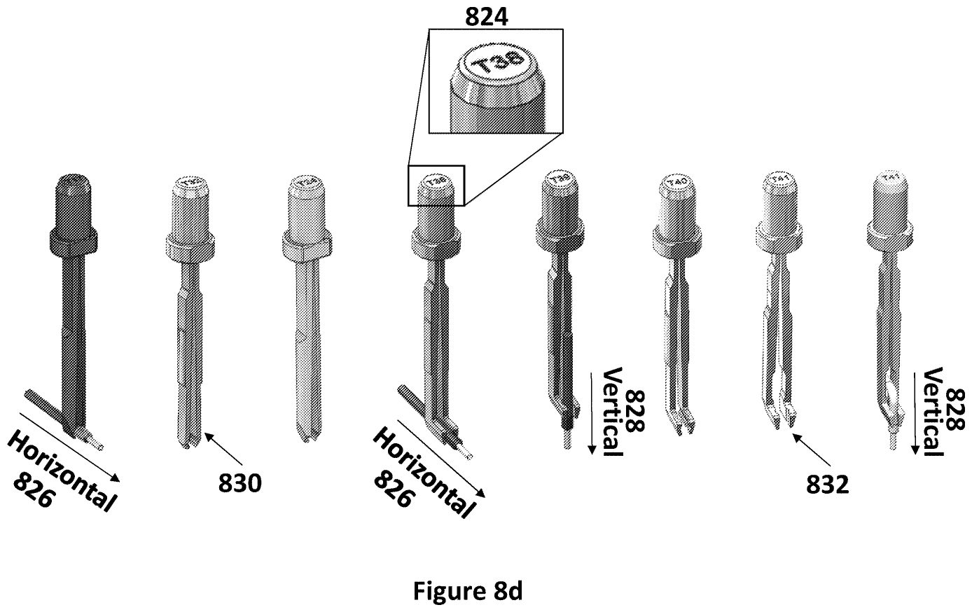

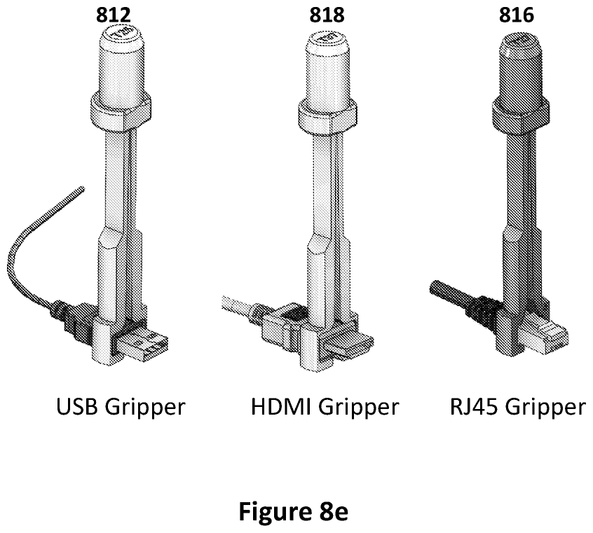

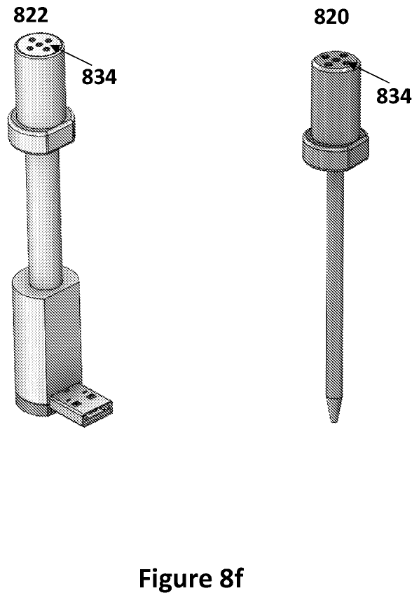

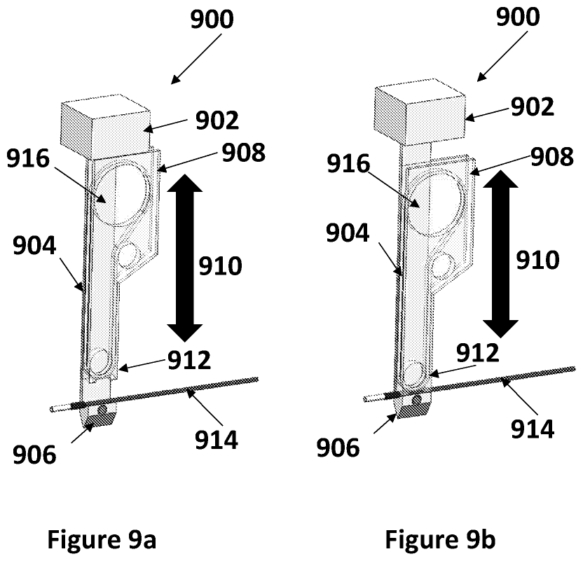

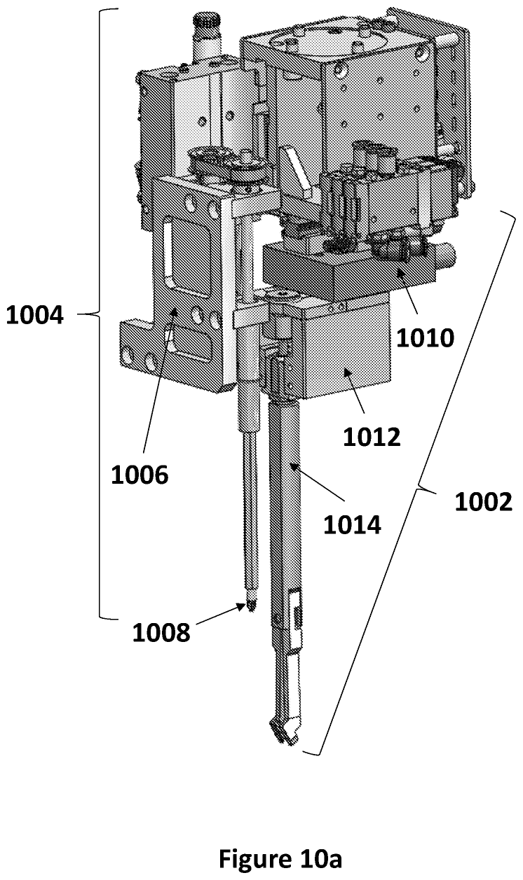

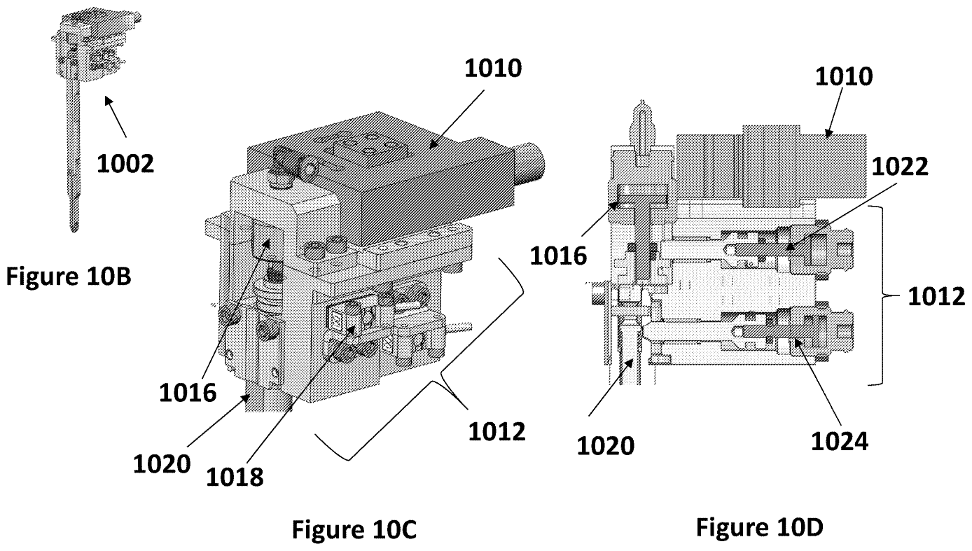

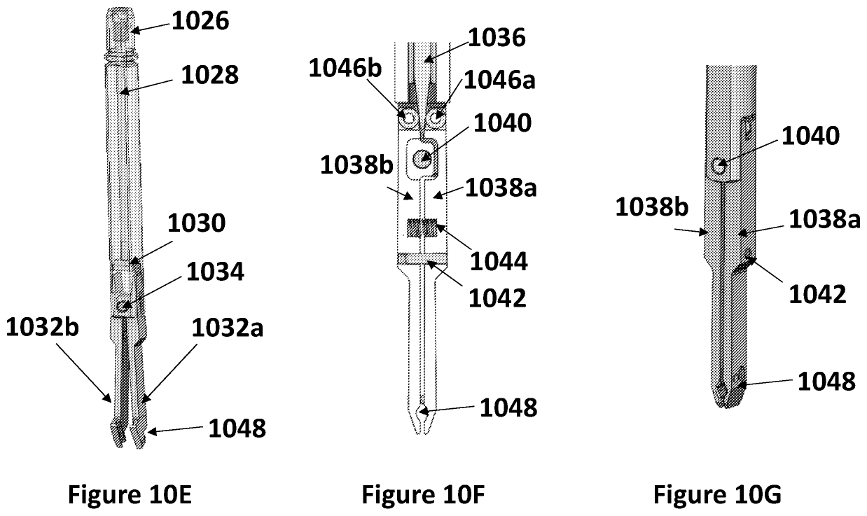

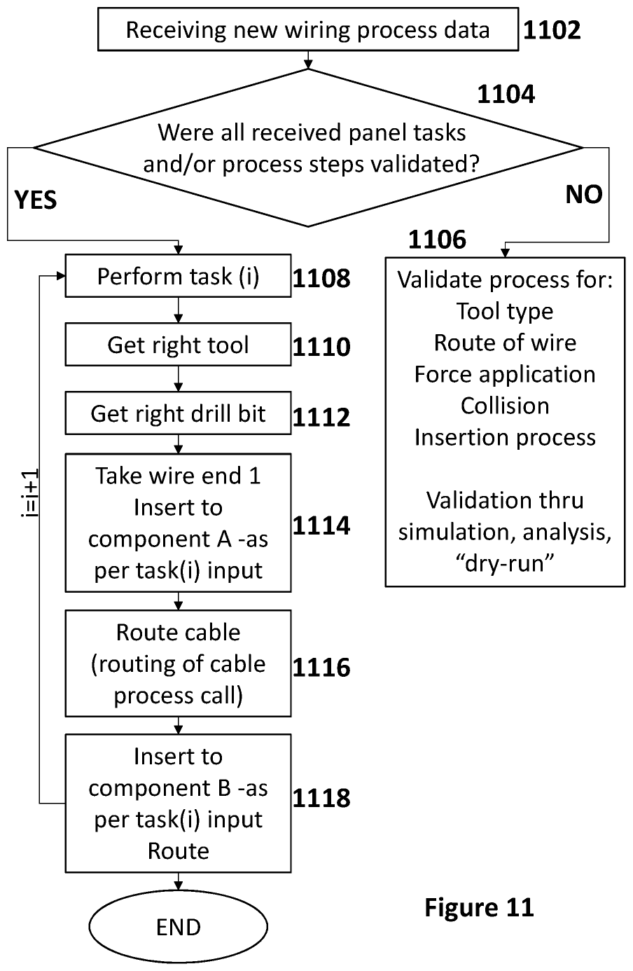

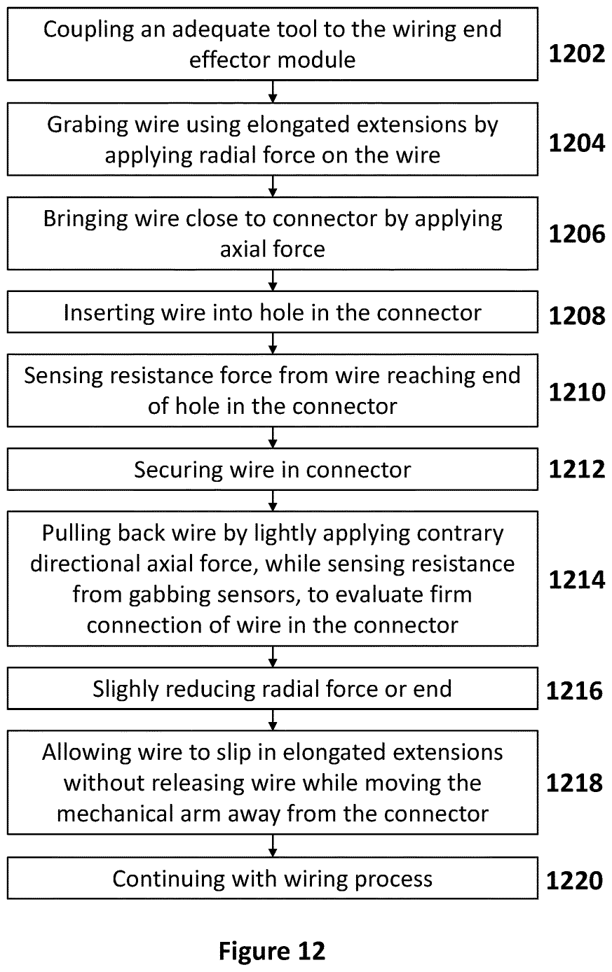

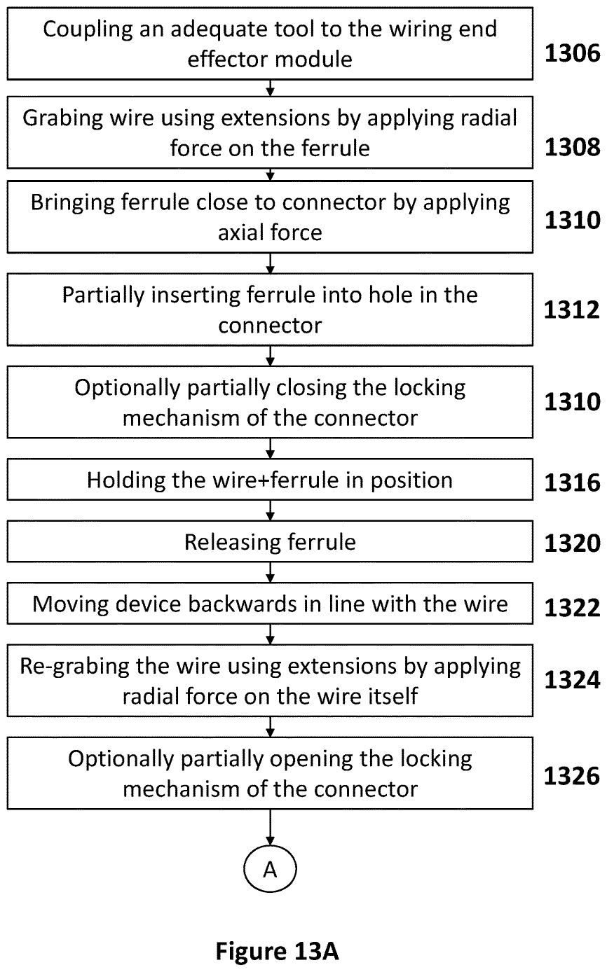

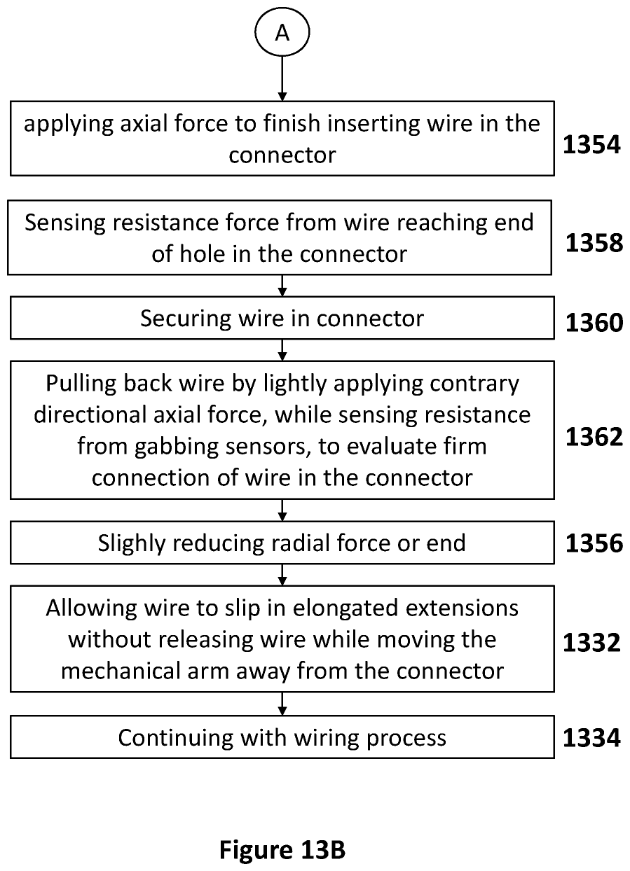

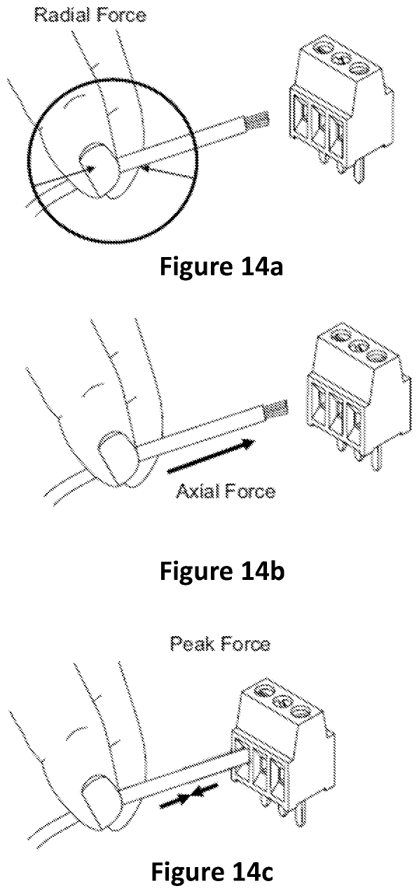

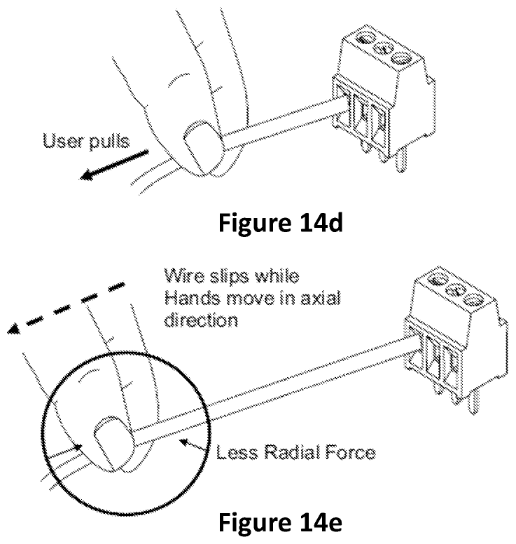

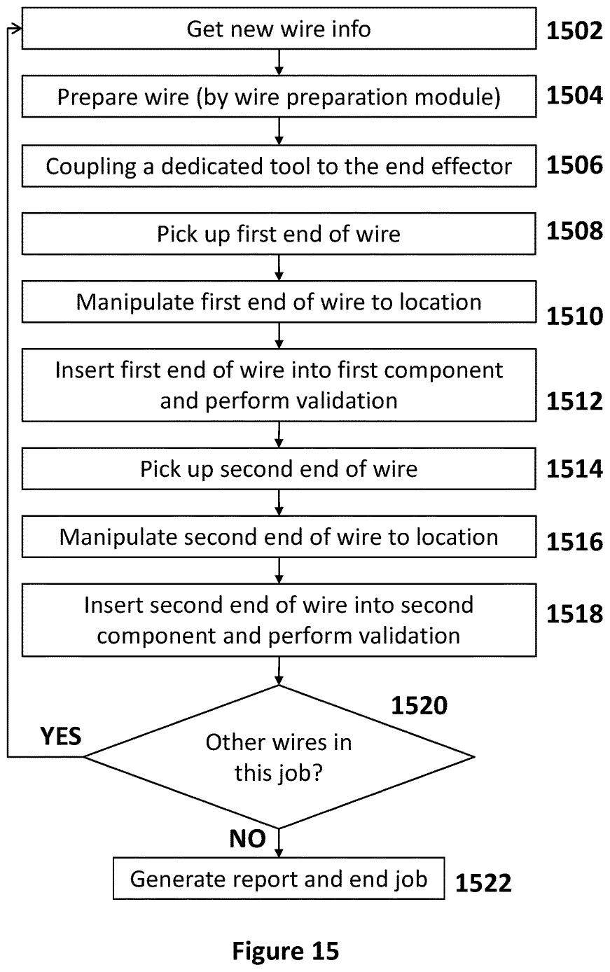

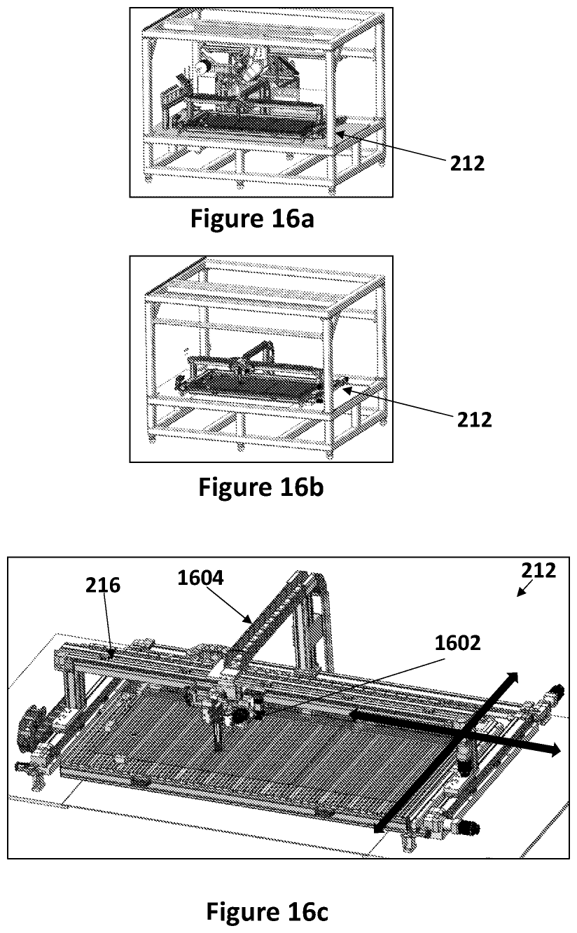

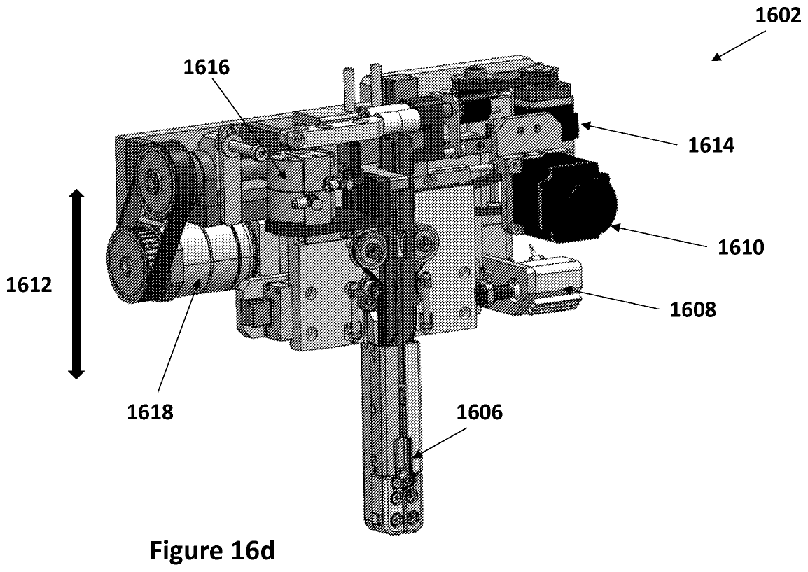

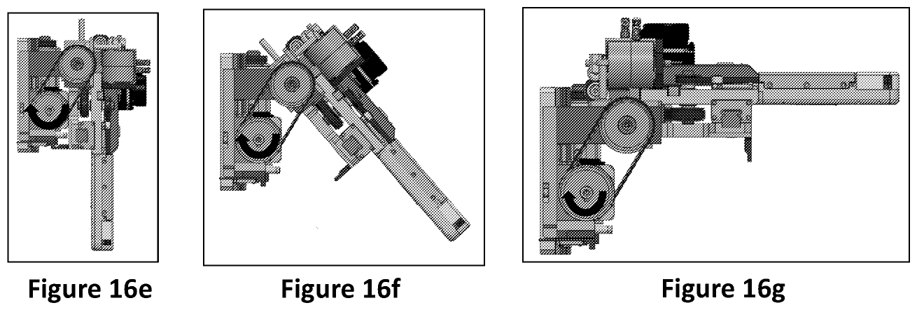

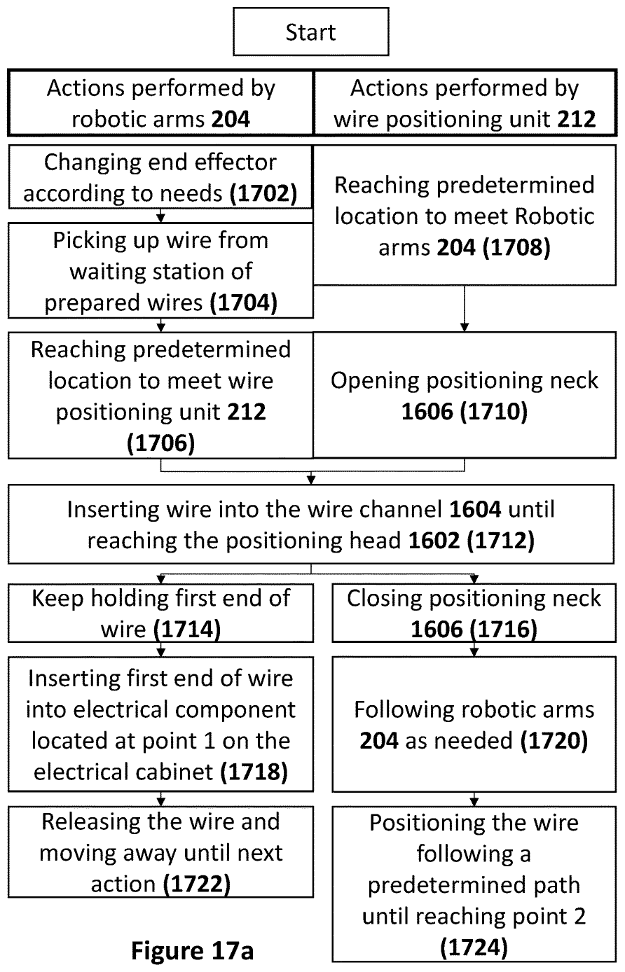

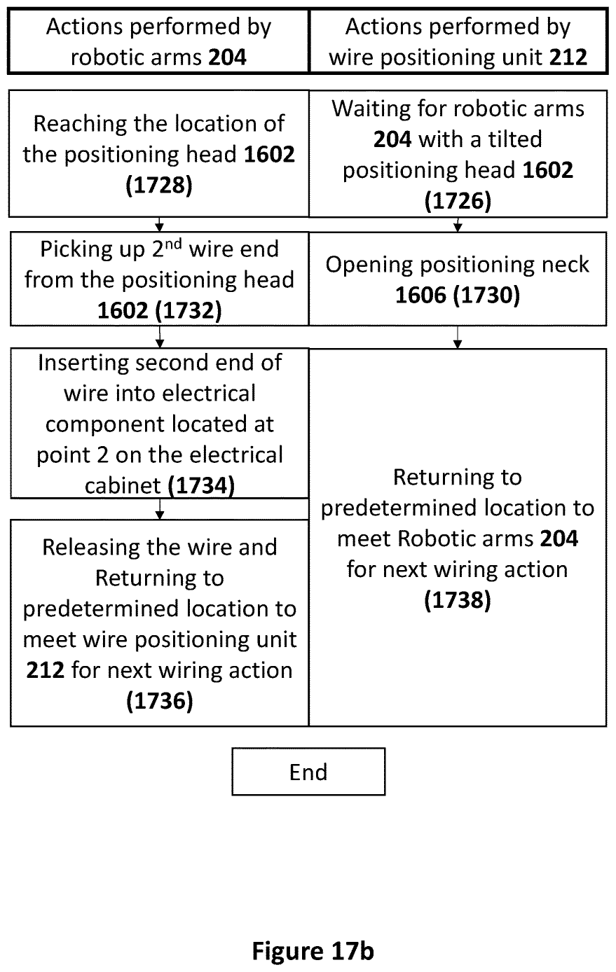

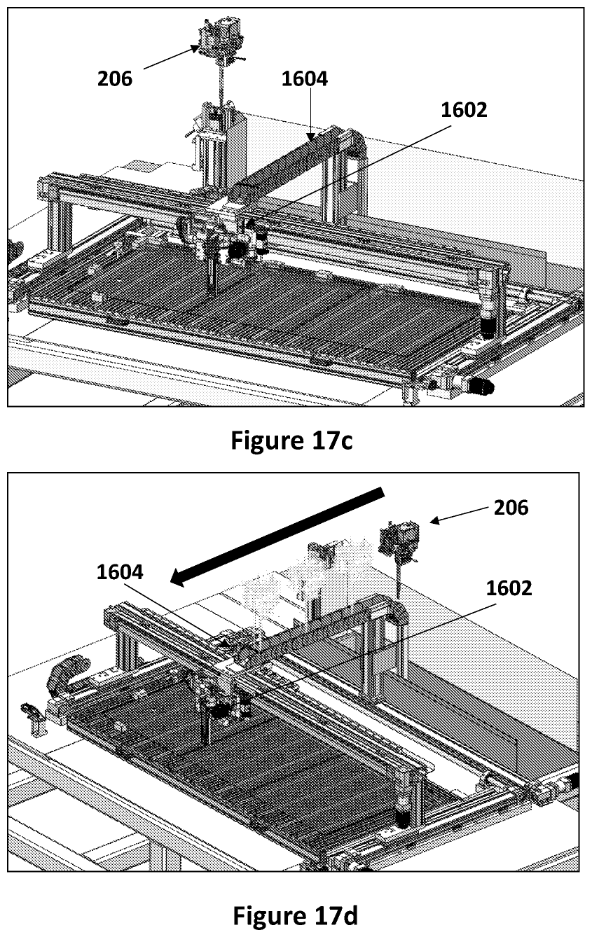

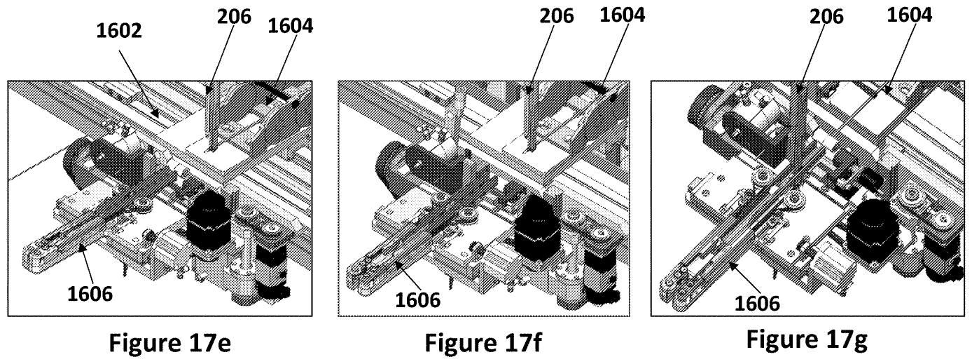

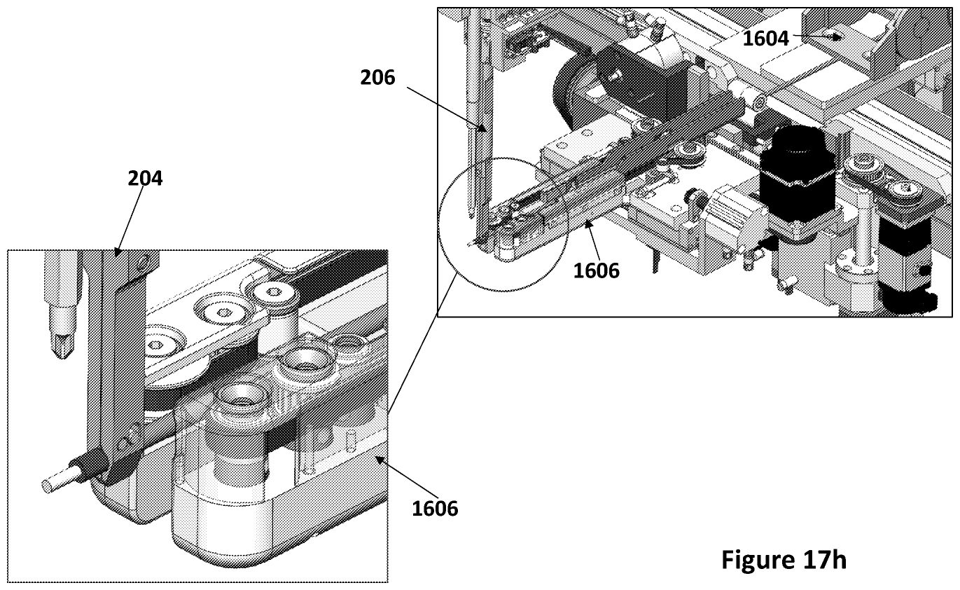

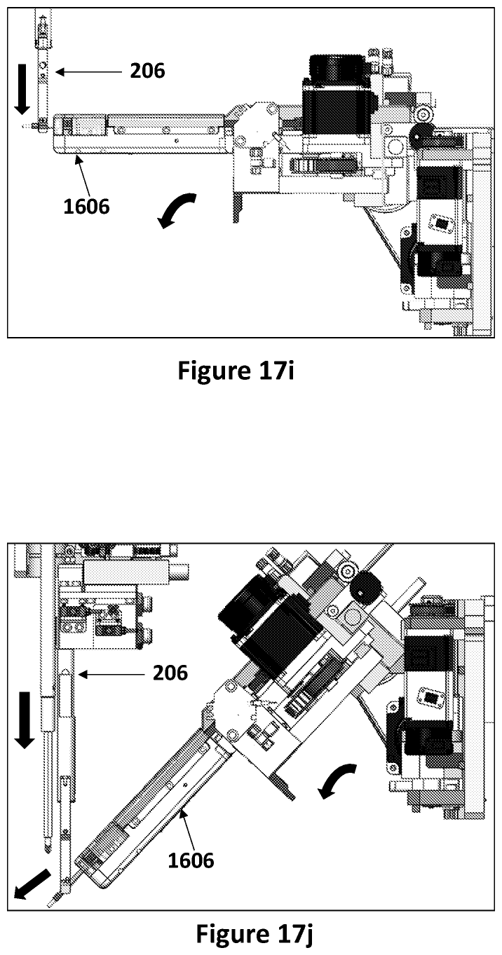

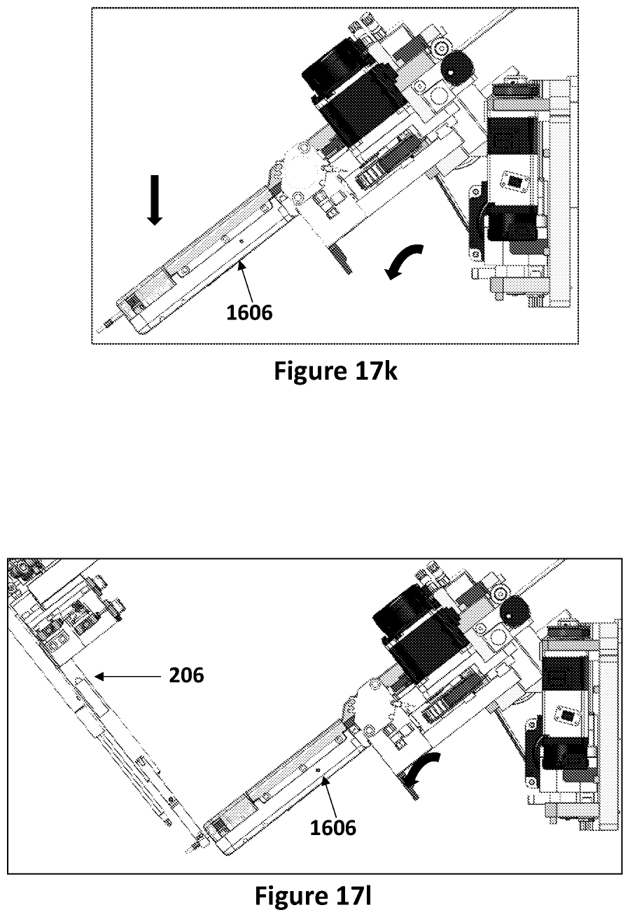

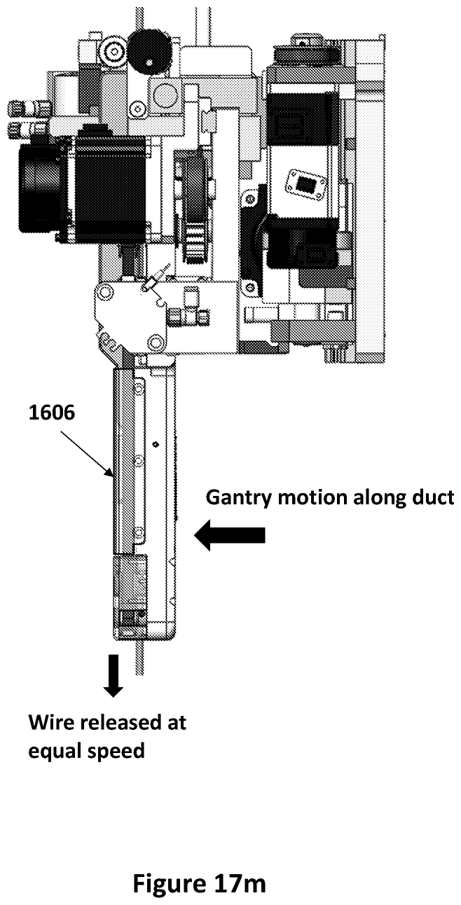

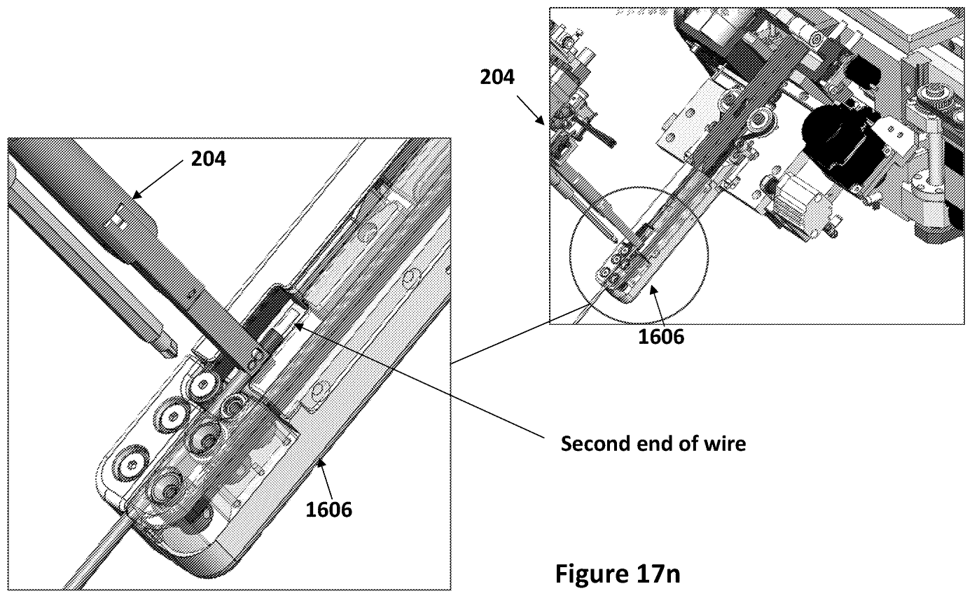

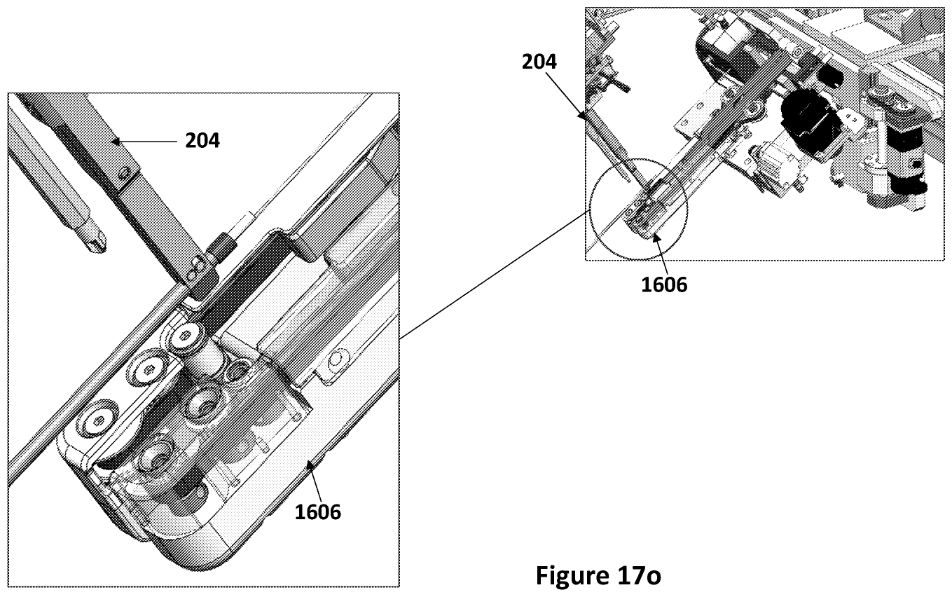

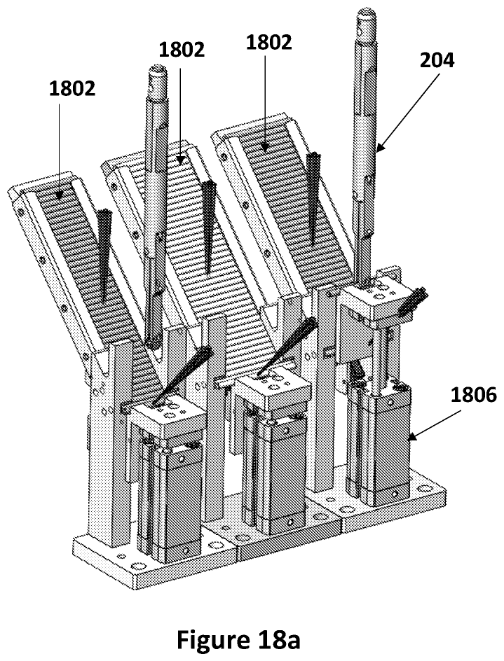

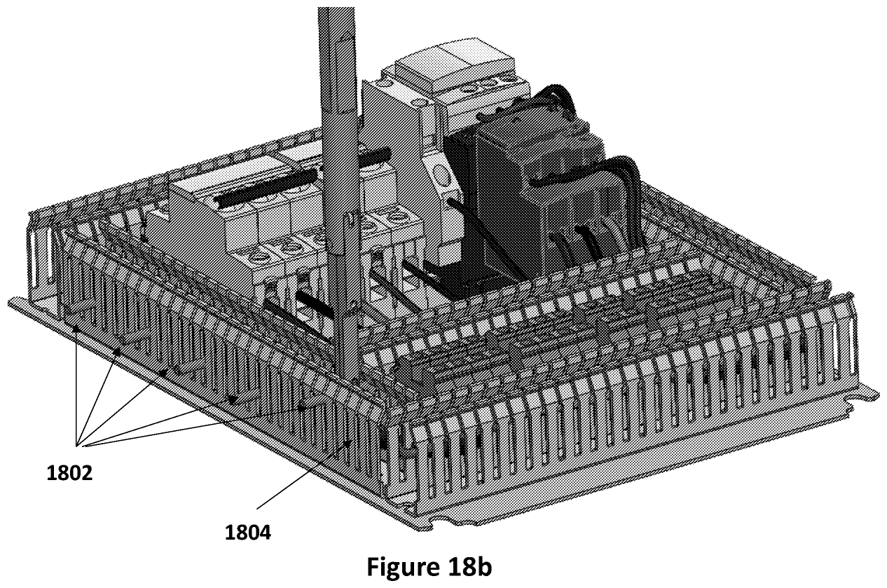

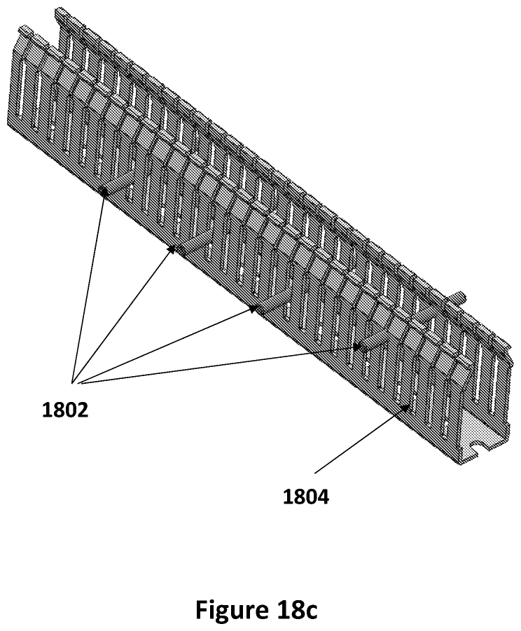

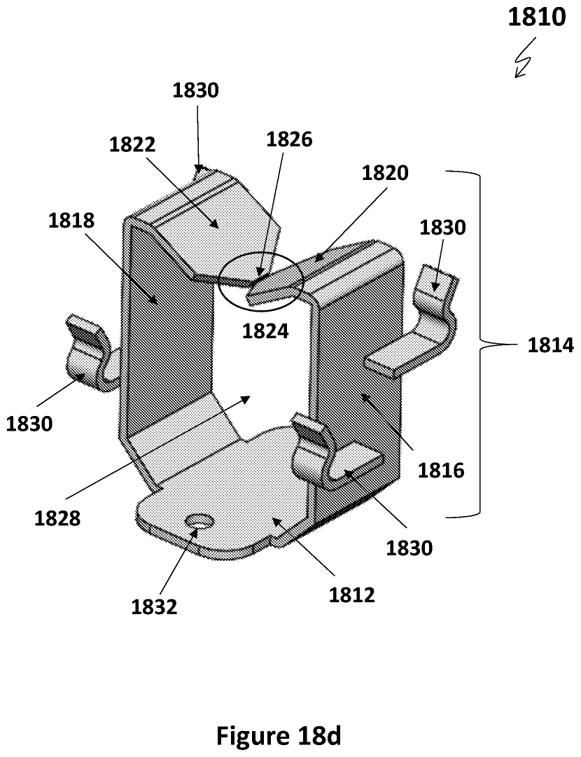

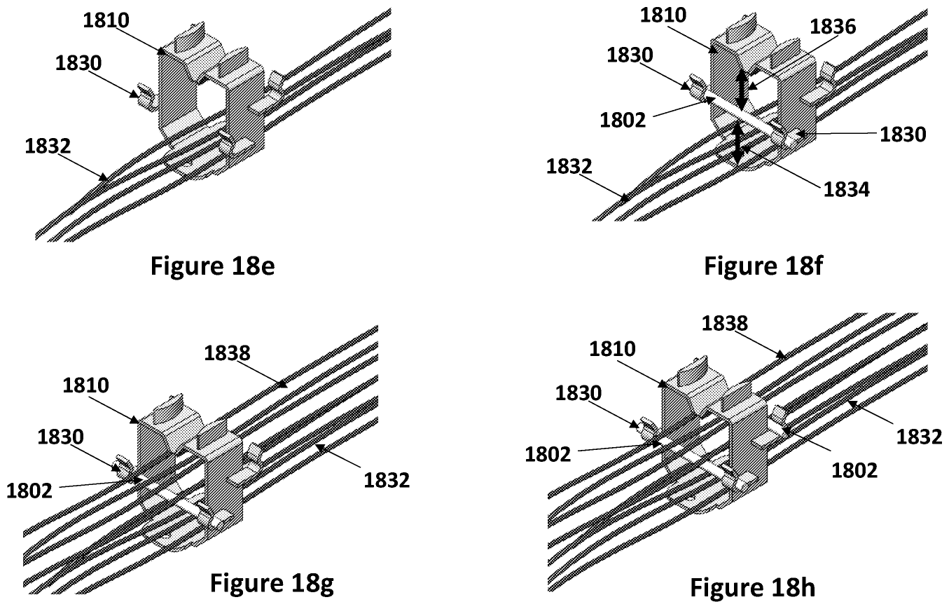

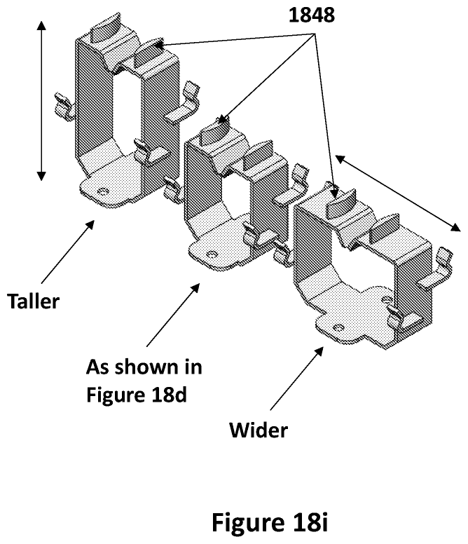

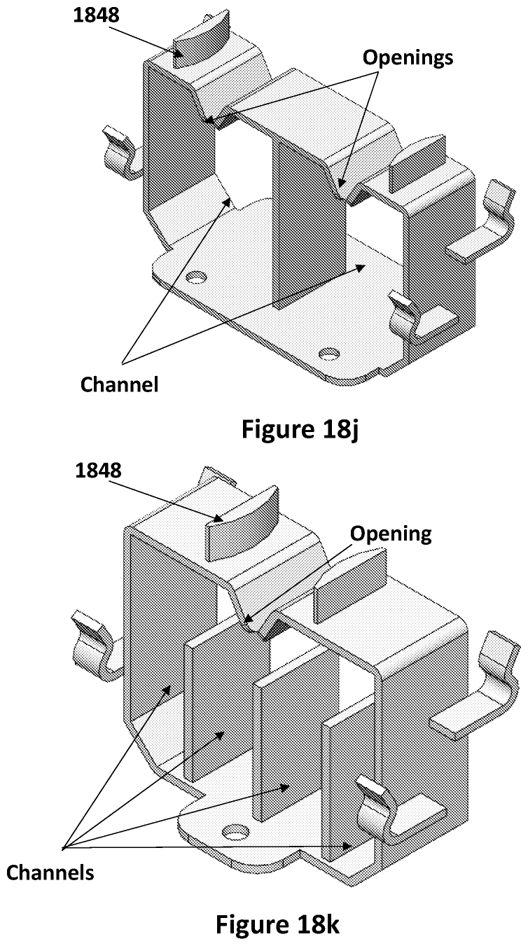

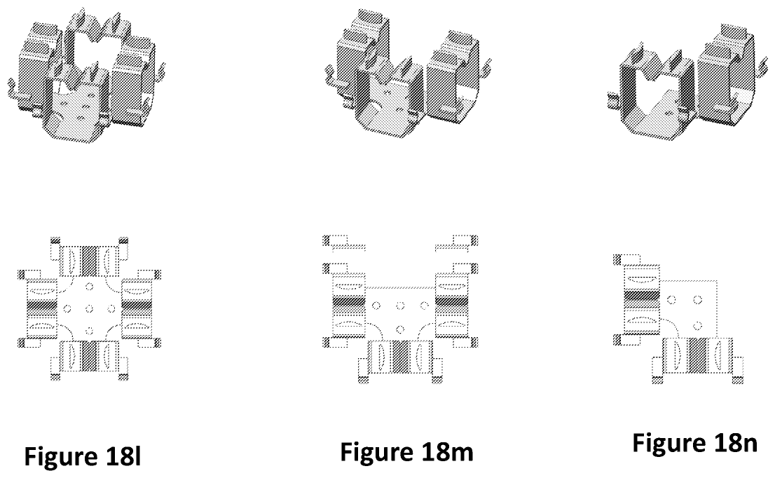

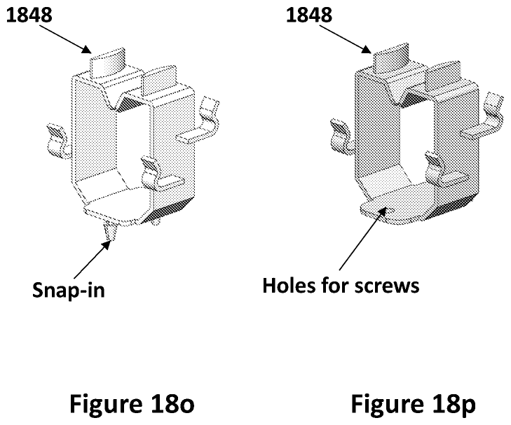

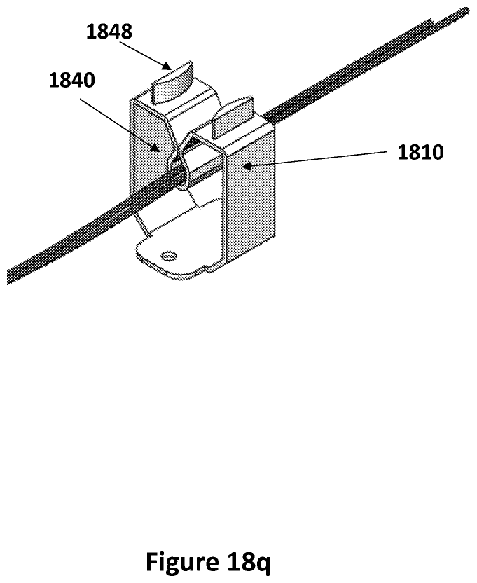

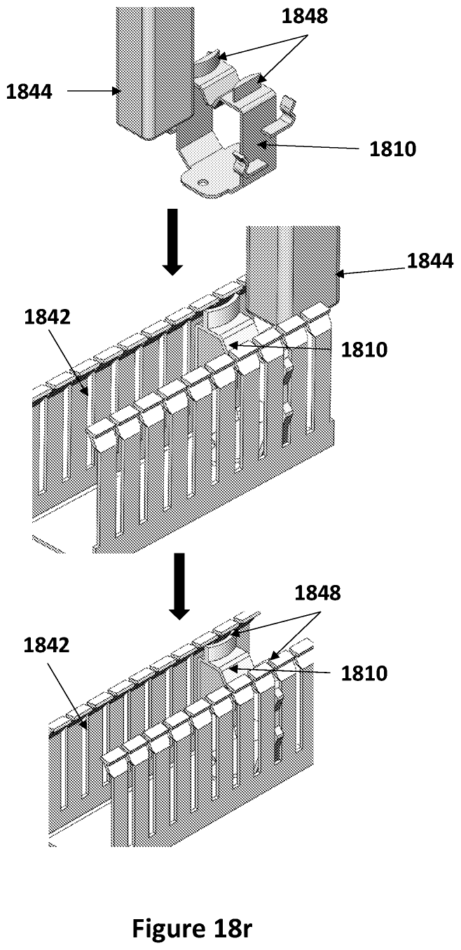

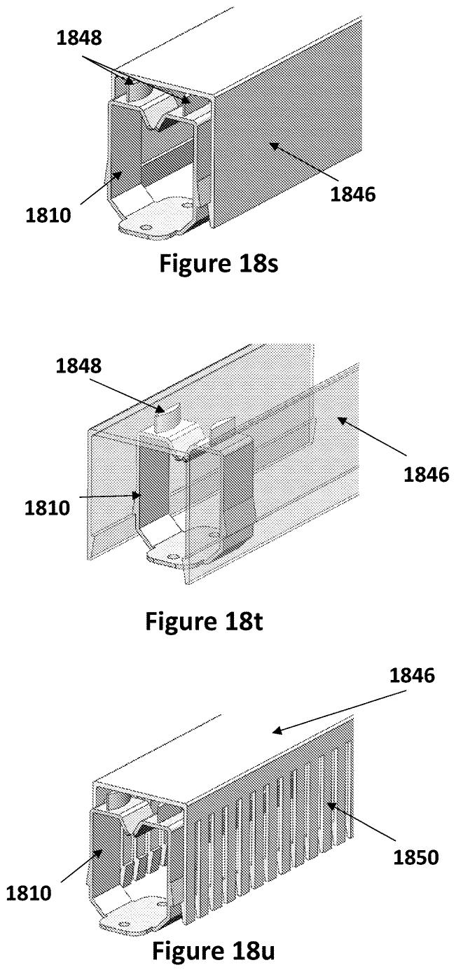

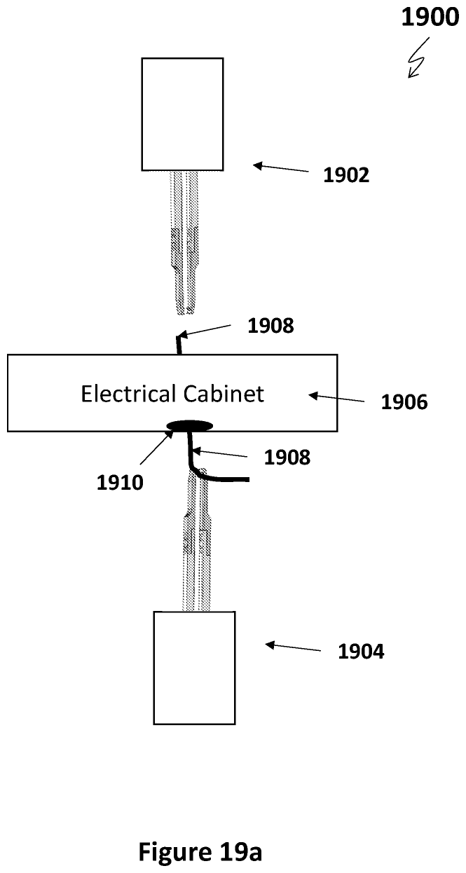

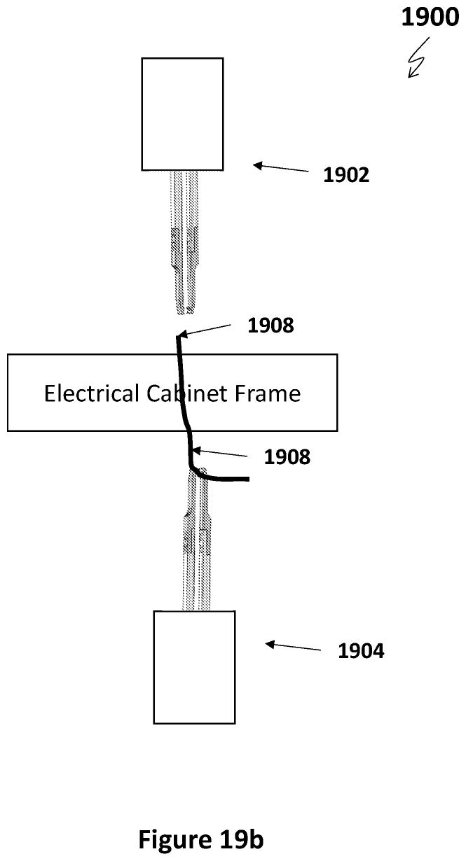

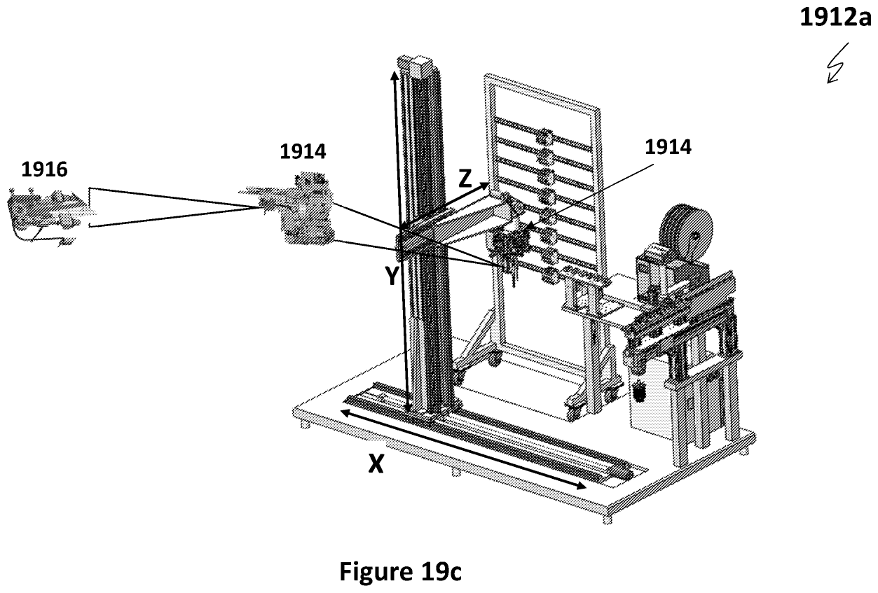

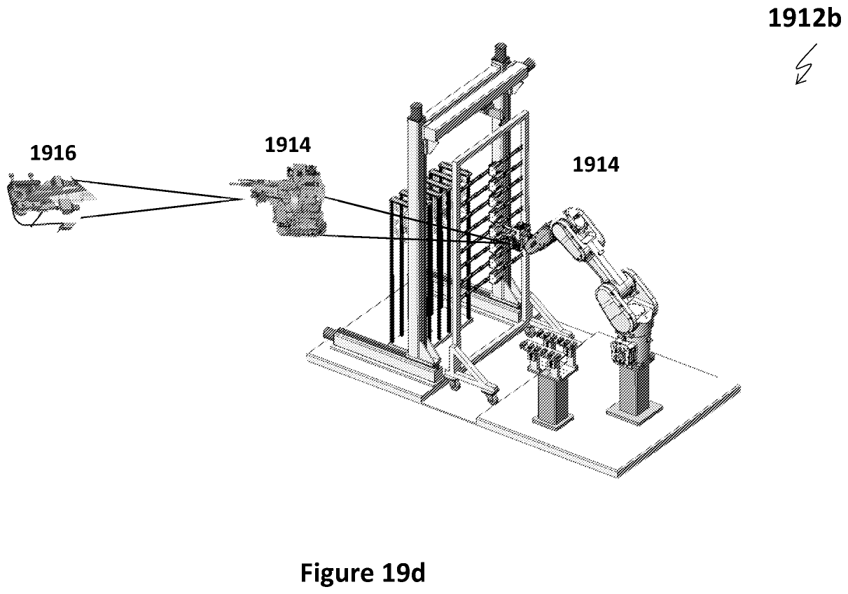

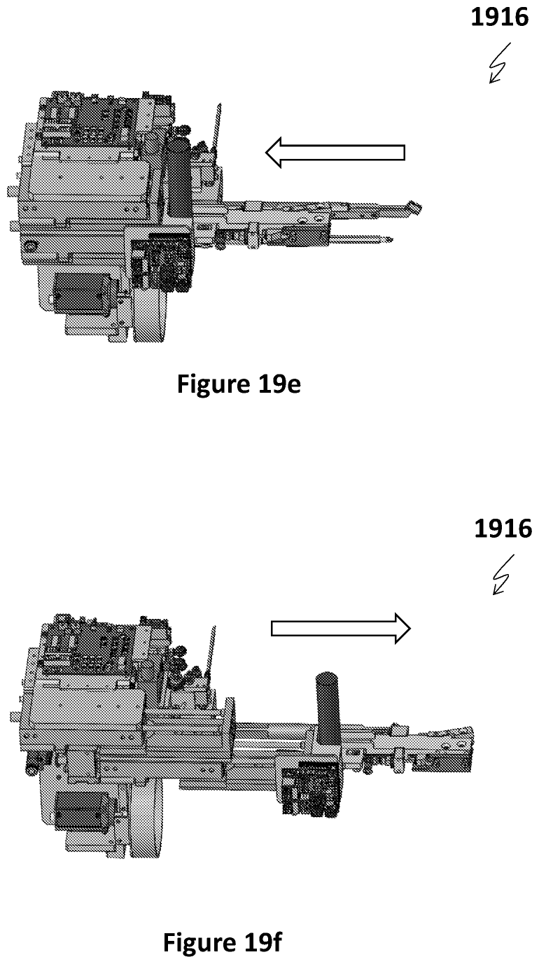

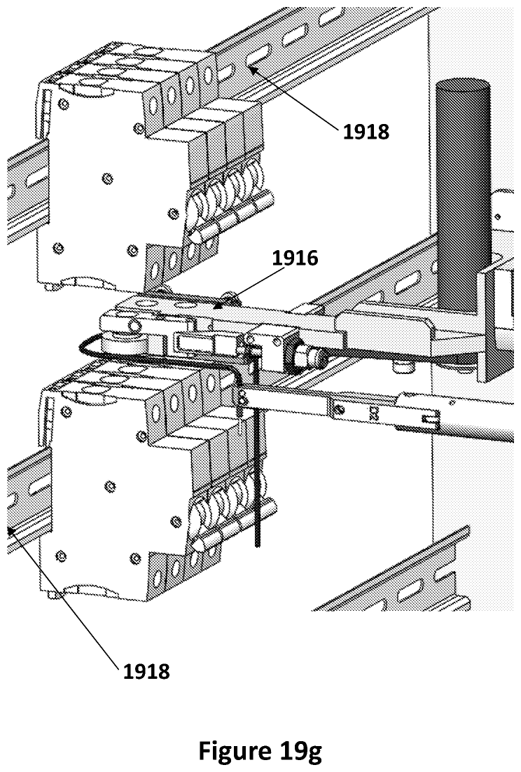

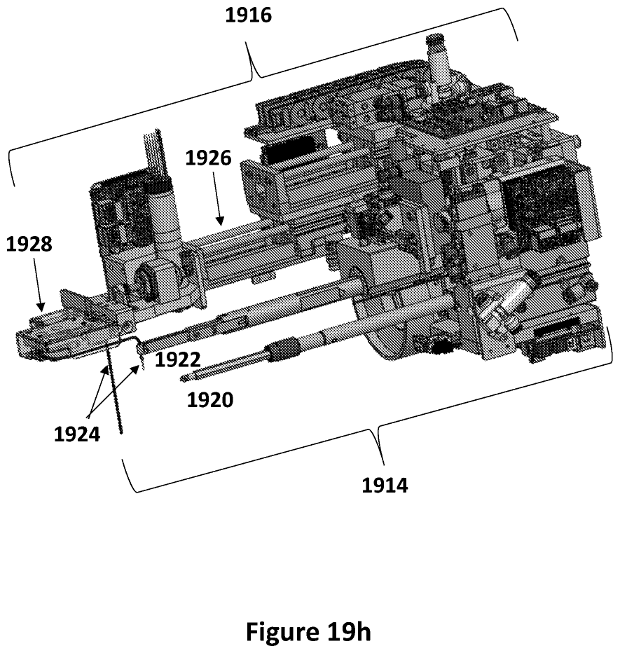

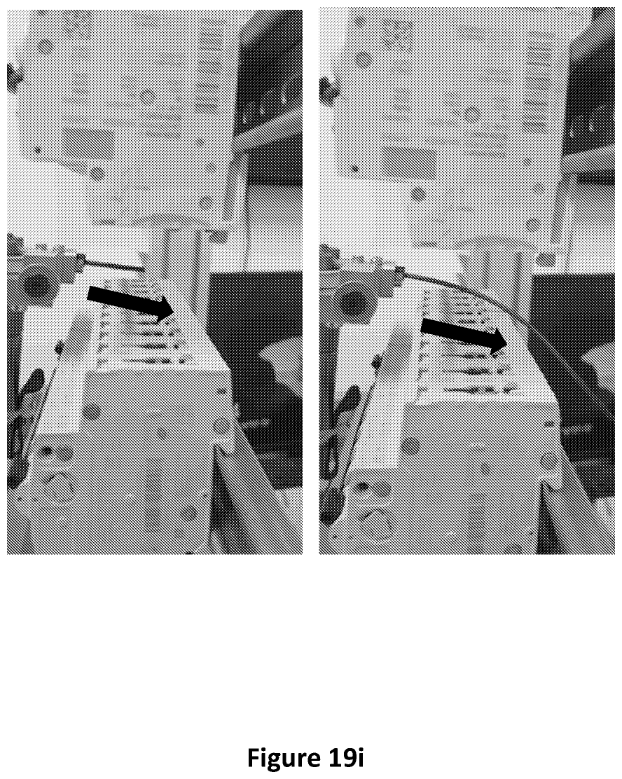

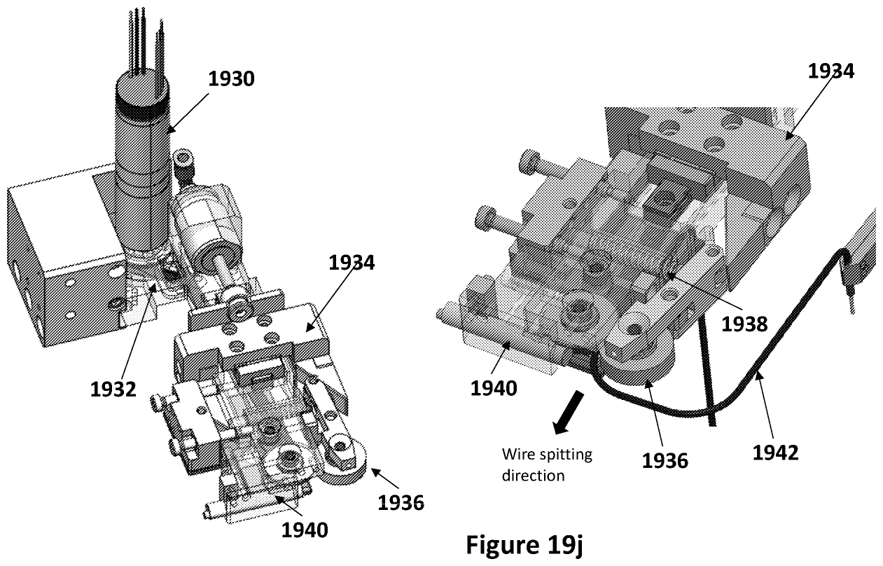

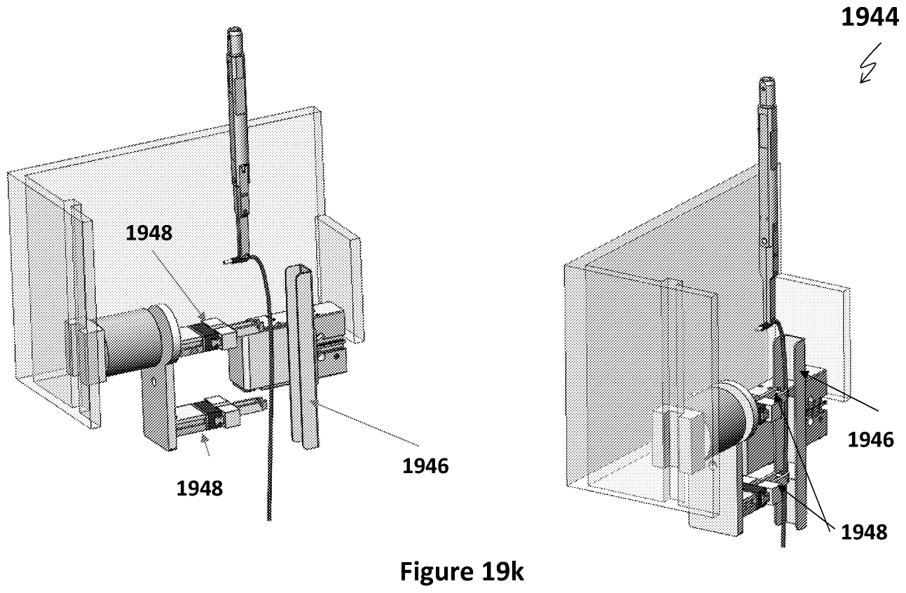

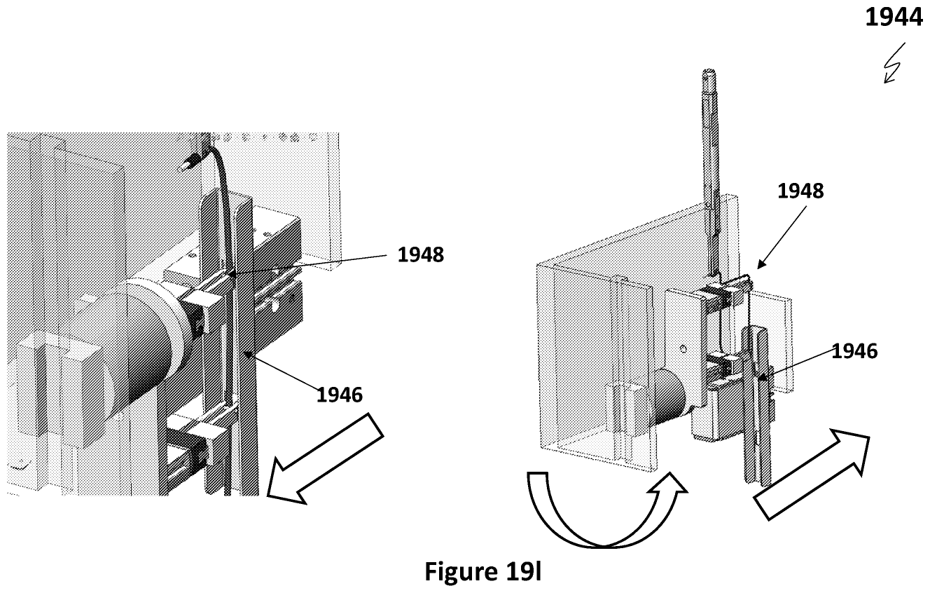

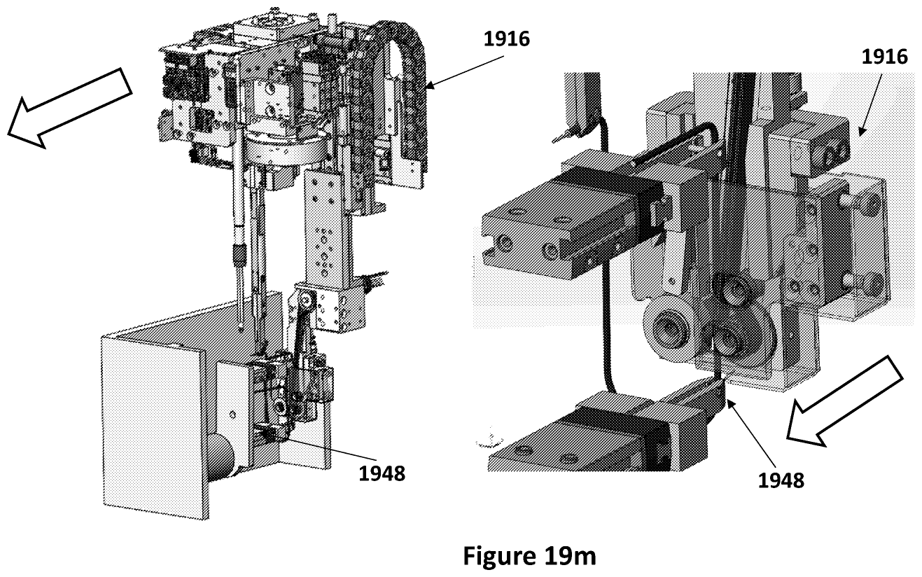

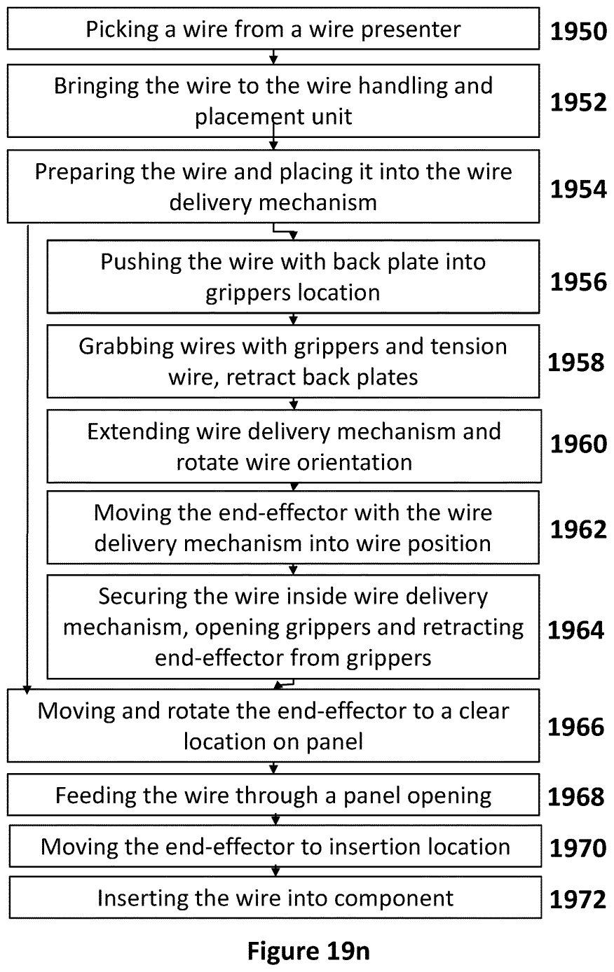

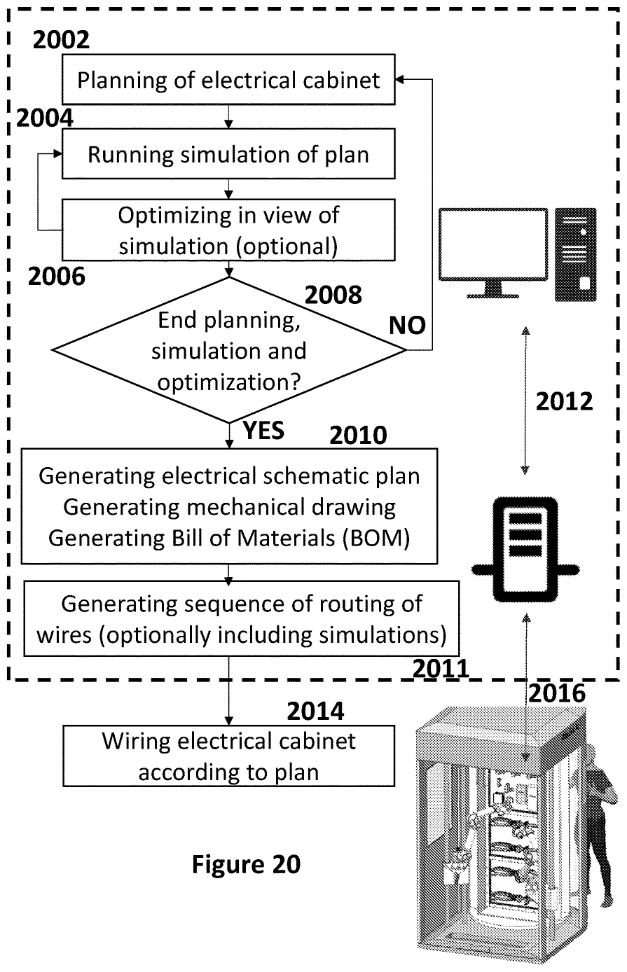

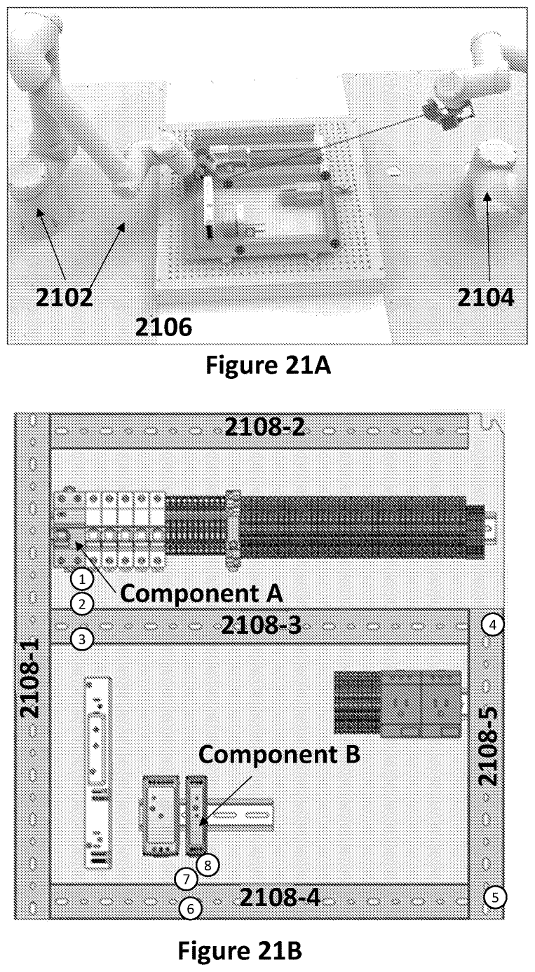

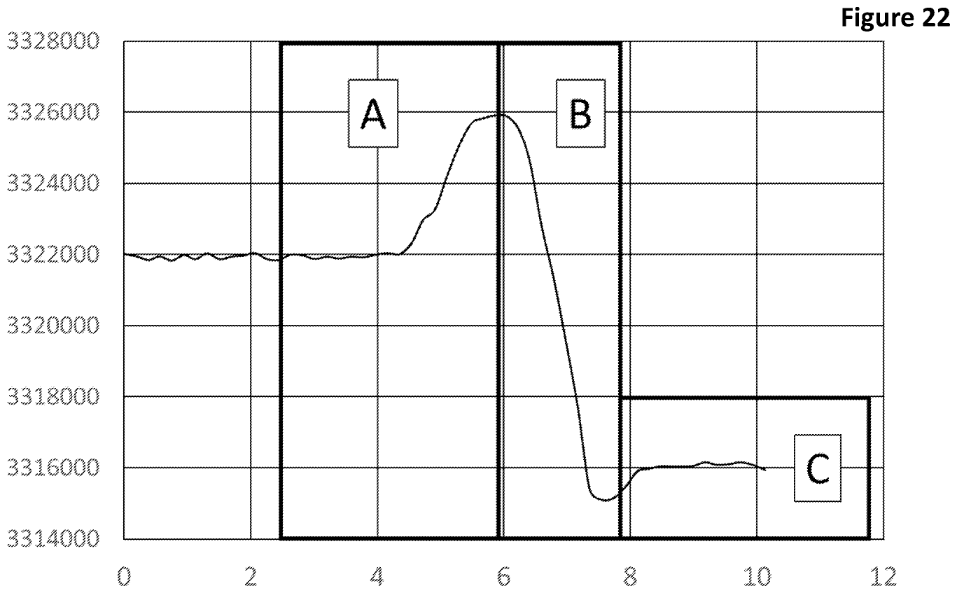

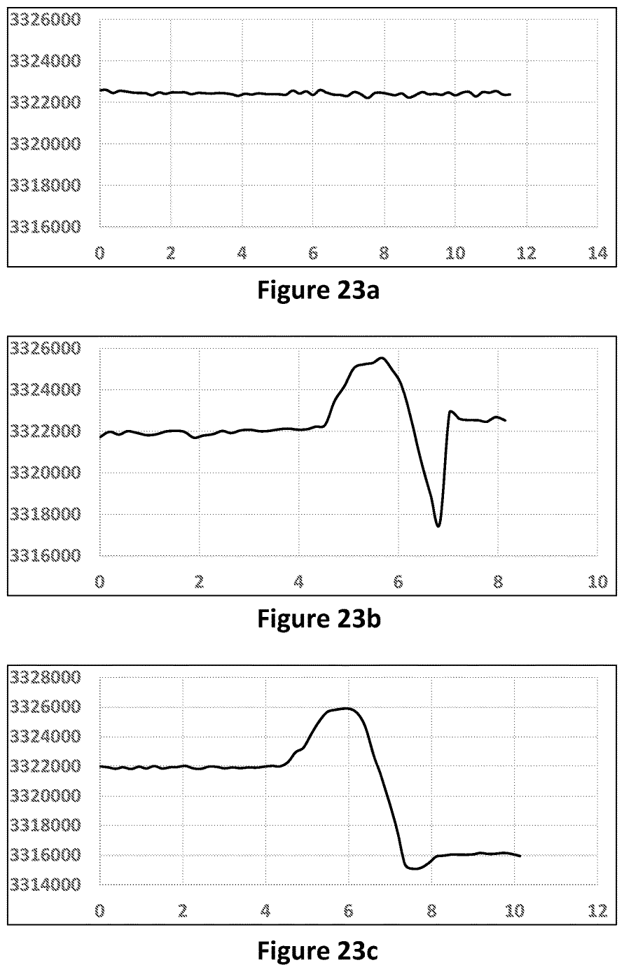

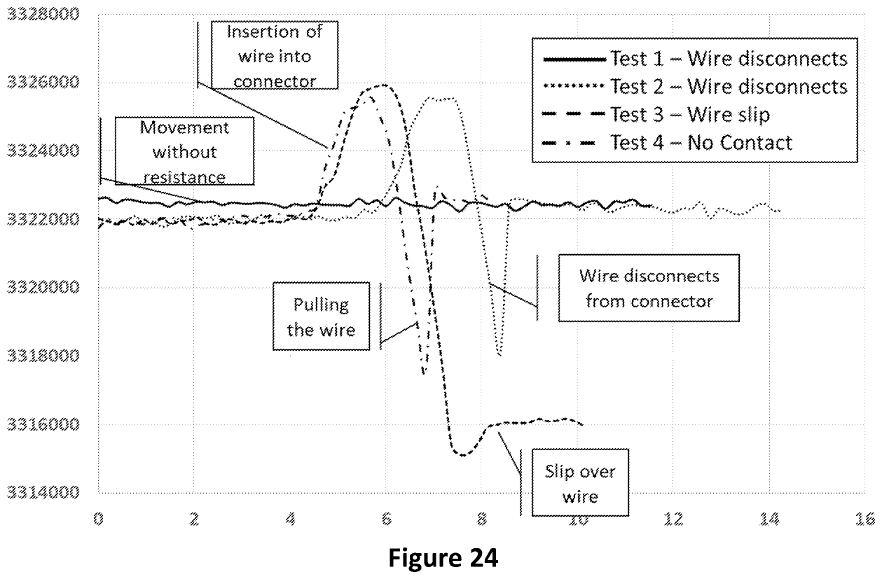

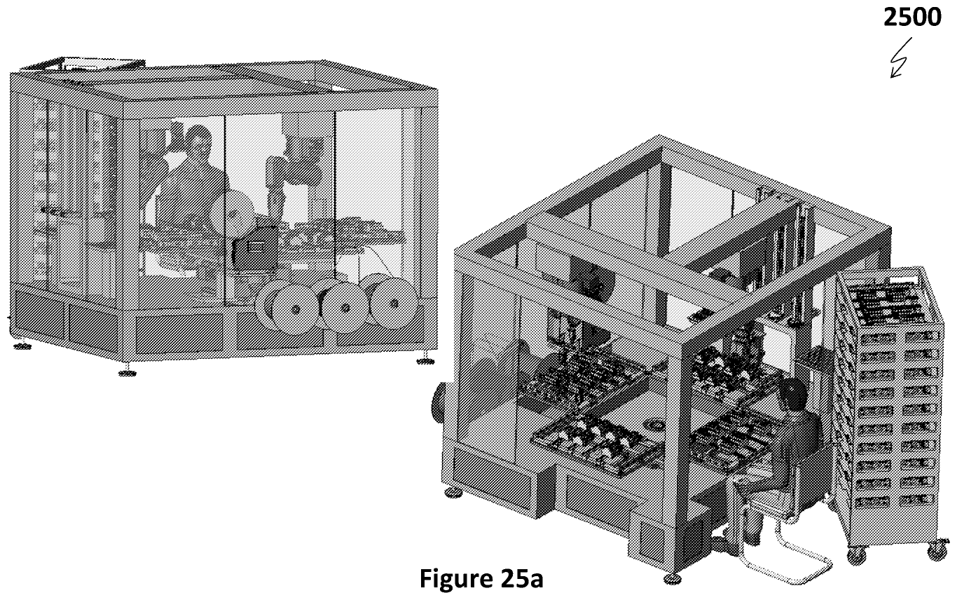

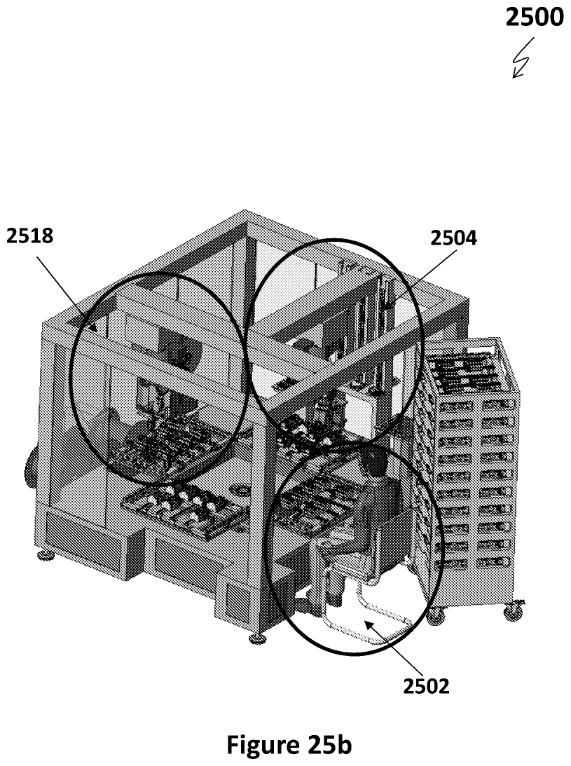

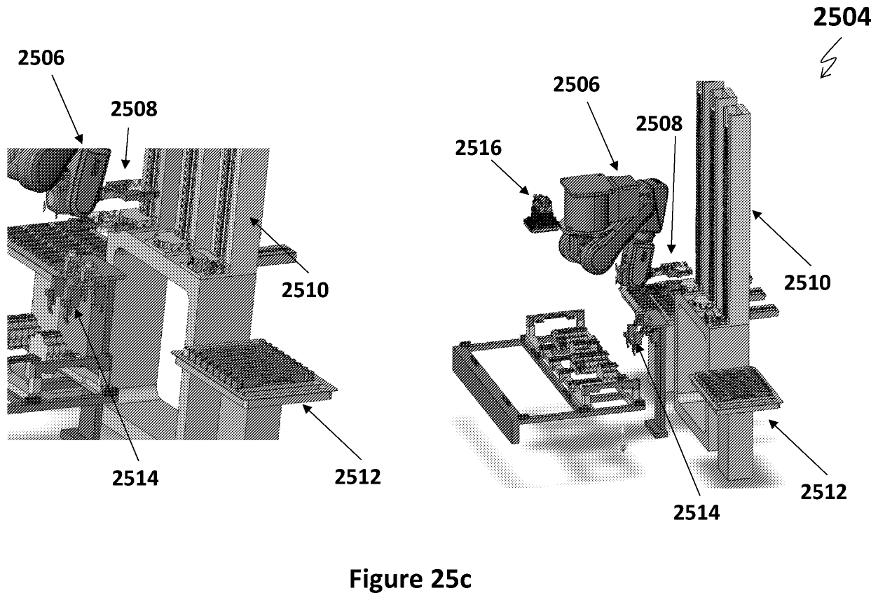

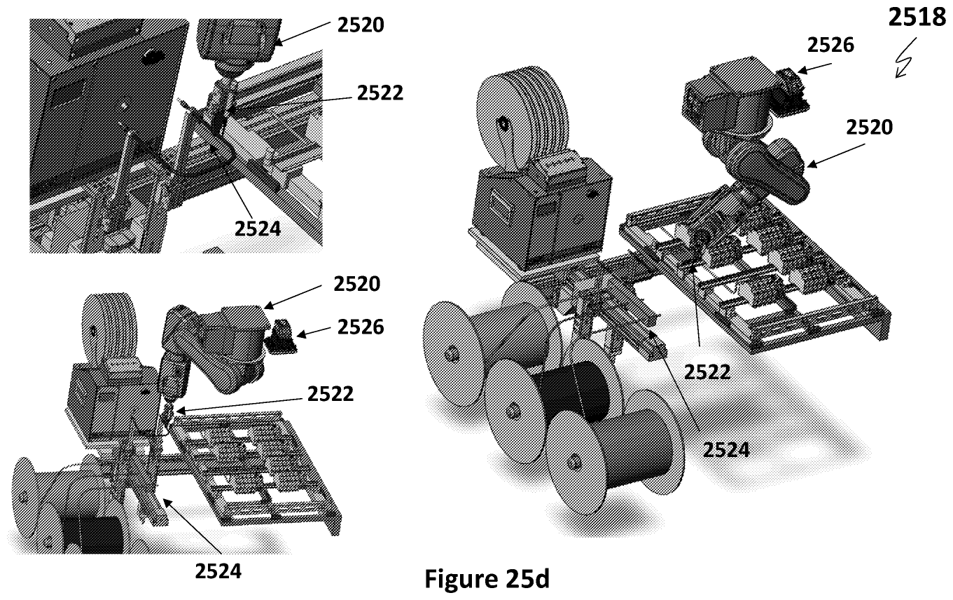

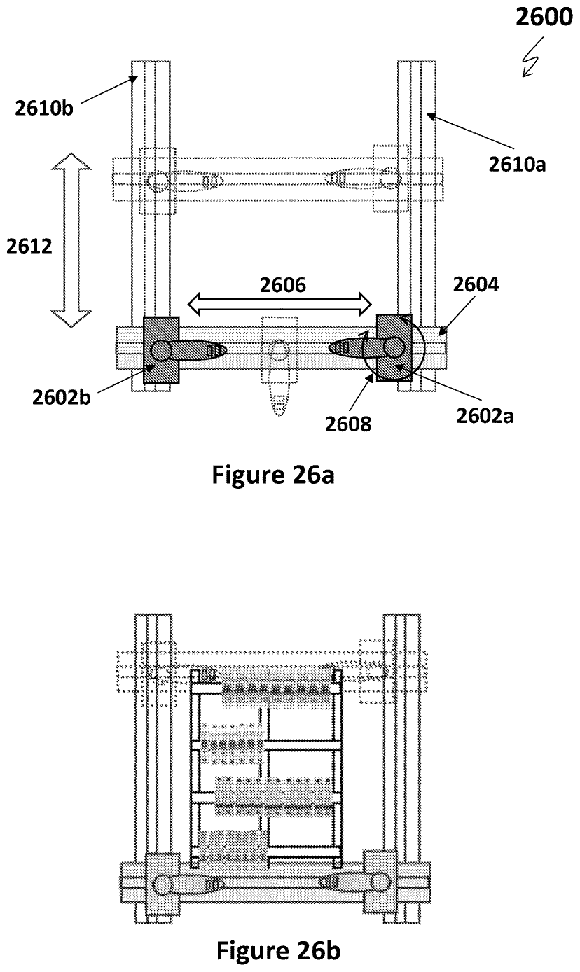

Referring now to FIG. 40, showing a flowchart of an exemplary method of wire preparation, according to some embodiments of the invention. In some embodiments, the method comprises one or more of the following actions:
1. Pulling wire from spools in wire stand 104 and inserting the wire into the wire presentation module 402 (452). In some embodiments, as mentioned above, this can be performed manually by a human user or mechanically by a robotic unit.
2. Marking a first end of the wire, for example, by printing on it by means of wire printer 406 or labeling it by means of a labeling machine (454).
3. Grabbing the first end of the wire by means of the wire manipulator 410 and bring the first end of the wire in to the wire-end connector mounting module 408 (456).
4. Pulling wire to achieve a predetermined needed length of the wire (458).
5. Cutting the wire thereby generating a second end the wire (460).
6. Marking the second end of the wire, for example, by printing on it by means of wire printer 406 or labeling it by means of a labeling machine (462).
7. Grabbing the second end of the wire by means of the wire manipulator 410 and bring the second end of the wire in to the wire-end connector mounting module 408 (464).
8. Leaving the wire at a waiting station of prepared wires (466). In some embodiments, alternatively, the wire is directly transferred to an additional robotic unit to be wired into the electrical panel.

In some embodiments, the wire preparation unit 210 comprises one or more monitoring elements and/or actions configured to monitor the final quality of the wires being prepared, for example, to ensure that the correct wires are being used (for example by using the camera 412), checking the correct mounting of the connectors on the wire ends, assessing whether waiting station of prepared wires is empty and more wire are needed to be prepared, assessing status of consumables, like the connectors, the ink in the printer, etc.

In some embodiments, the wire stand 106 has precut pre-prepared wires sets for a specific panel. In some embodiments, the wire manipulation unit 410 takes a wire from the wire stand and presents it to the system. In some embodiments, a potential advantage of this arrangement is the ability to provide an interface between the system as disclosed herein and existing automatic wire preparation solutions and/or manually prepared wires. In some embodiments, the wire stand 106, when used with pre-prepared wires, is in a form of a jig, a fixture where the wire end or ends are fixed in a known position in such a way as to allow the wire manipulation unit 410 to access and grab the wire. In some embodiments, the wire stand 106 with pre-prepared wires may include a manipulator or a robot that hands over the wires to the system via the wire manipulation unit 410 or directly. In some embodiments, prepared wires are presented to the robotic electrical cabinet wiring system 100, either by the wire preparation unit 210 or directly by any other automated system or manually by a user.

In some embodiments, an exemplary time that takes to prepare one wire is from about 20 seconds to about 30 seconds, optionally from about 15 seconds to about 40 seconds, optionally from about 15 seconds to about 90 seconds.

Referring now to FIGS. 5a-c, showing schematic representations of an exemplary robotic arm 204, according to some embodiments of the invention. FIG. 5a schematically shows the relative location of an exemplary robotic arm 204 in the robotic electrical cabinet wiring system 100, while FIGS. 5b and 5c, shows the chassis 202 comprising a dedicated rail 502 on which the robotic arm 204 is mounted. In some embodiments, the rail 502 provides a horizontal movement, as schematical shown by arrow 504.

### Exemplary Robotic Arm 204

In some embodiments, the robotic electrical cabinet wiring system 100 comprises one or more robotic arms 204, each comprising an end effector 206 configured for automatic exchange of dedicated wiring tools. In some embodiments, the robotic arm 204 comprises connector configured to allow reversible connection of one or more tools to the robotic arm 204. In some embodiments, the connection of the tool to the robotic arm 204 comprises a mechanical connection and/or an electrical connection. In some embodiments, the robotic arm 204 can be one or more of a manipulator, a Cartesian gantry system and a multi-axis platform. In some embodiments, the connector comprises the actuation mechanism for the tool. In some embodiments, the tool itself comprises the actuation mechanisms required for its actuation. In some embodiments, the tools configured to be suitable for wiring actions. In some embodiments, the tools are configured to hold all types of hardware required to perform a full wiring of a device, for example, tools are configured to hold and/or manipulate one or more of electrical components, electrical wires, connectors, ferrules and cables.

In some embodiments, the robotic electrical cabinet wiring system 100 is configured to easily exchange between tools in order to perform the wiring actions. In some embodiments, a plurality of dedicated tools are positioned close to the wiring area, and more specifically, at a distance suitable for the one or more robotic arms to access them.

In some embodiments, the robotic electrical cabinet wiring system 100 comprises a plurality of tools that allow the automatic system to hold any and all types of wires and ferrules and to hold tube pipes, fiber optic cables, connectors and cables. A potential advantage of the system is that it potentially allows to easily design new tools according to needs. In some embodiments, the tools comprise one or more sensors configured to provide feedback regarding force(s) and/or torque(s) sensed through the tools. In some embodiments, the tools are designed to be slim, which allows access to narrow and/or tight components and ducts in electrical cabinets. In some embodiments, the robotic electrical cabinet wiring system 100 is configured to use technical tools, for example for quality assurance tasks, for example, continuity and data transfer. In some embodiments, the different tools comprise one or more markings used by the system to identify the different tools and, in addition, can be used to potentially protect the system from using non-original parts.

In some embodiments, the robotic electrical cabinet wiring system 100 comprises one or more sensors configured to monitor the wiring process and, when and if necessary, automatically interchange tools in the end-effector in order to continue and finish the wiring process. In some embodiments, the system receives in advance a chronological order in which interchangeable tools are going to be used. In some embodiments, if the system detects a problem (using the one or more sensors), the system is configured to assess the problem, choose which tool is appropriate to deal with the problem, perform the interchange of tools, resolve the problem, and continue with the wiring process as previously programmed. In some embodiments, problems are resolved using one or two of the robotic arms. In some embodiments, when two of the robotic arms are used, they cooperate with each other to resolve the problem.

### Exemplary Wiring-End Effector 206

Referring now to FIG. 5d, showing a schematic representation of an exemplary wiring-end effector 206, according to some embodiments of the invention. In some embodiments, the wiring-end effector 206 comprises one or more of the following parts: a wire holding element/wire holder 506 (or wire holder) and a wire locking element 508 (or wire locker). Referring now to FIG. 5e, showing a schematic representation of the parts of the wire holding element/wire holder 506, according to some embodiments of the invention. In some embodiments, the wire holding element/wire holder 506 comprises one or more of a base 510 comprising wire pinching element 512. In some embodiments, the wire pinching element 512 comprises two extensions 514a-b, optionally two elongated finger-like extensions, which are brought together, for example, by an electrical mechanism 516 and/or by a pneumatic mechanism. In some embodiments, the length of the two extensions 514a-b when measured from the base to the end of the two extensions 514a-b is from about 20 mm to about 200 mm, optionally from about 15 mm to about 250 mm, optionally from about 10 mm to about 300 mm. In some embodiments, a potential advantage of having two extensions 514a-b having a length of about 200 mm is that it potentially allows the distal end of the two extensions 514a-b to reach the panel being wired without causing a collision of the end effector with protruding elements in the panel since it potentially provides enough distance between the end effector and the surface of the panel being wired. In some embodiments, the width of the two extensions 514a-b is of about 6 mm, for example from about 3 mm to about 6 mm, optionally form about 2 mm to about 8 mm, optionally from about 1 mm to about 10 mm. In some embodiments, a potential advantage of having a small width of the two extensions 514a-b is that it potentially allows the insertion of the two extensions 514a-b in small and/or crowded places. In some embodiments, the wire pinching element 512 comprises a gimbal block 518 (FIG. 5g) to which the two extensions 514a-b are connected (see below further explanations regarding gimbal block 518). In some embodiments, the base 510 comprises a motor 520 that allows a horizontal movement of the wire holding element/wire holder 506, in the direction as schematically shown by arrow 522. In some embodiments, alternatively or additionally, the wiring arm module provides the motion along schematic arrow 522. In some embodiments, the horizontal movement shown by arrow 522 is the direction along the axis of the wire towards the electrical terminal connector. In some embodiments, the base 510 comprises one or more motors configured to move the holding element/wire holder 506 in one or more directions. In some embodiments the motion is in line with the wire terminal port that may be, for example, at an angle of 30, 45, 90 degrees (or any angle in between) from the plane of the panel.

Referring now to FIG. 5f, showing a schematic representation of the sensors located on the elongated extensions 514a-b, according to some embodiments of the invention. In some embodiments, one or more of the elongated extensions 514a-b comprise one or more sensors 524 configured to monitor the force applied by the elongated extensions 514a-b on the wire 526. In some embodiments sensors are embedded in the finger or the body of the end-effector. In some embodiments, those sensors allow for the measurements of the axial and radial forces, similarly to the actions performed by a human, which provide a system with high levels of dexterity and sensibility capable to perform wiring actions, as explained above. In some embodiments, sensors are based for example, on strain gauges, load-cells and/or others. In some embodiments, additionally or alternatively, mechanism that can sense forces or moments (i.e.: sensors) are located on the part where the extensions are connected to the device, for example the gimbal block (see 518 in FIG. 5g), as shown and explained below for FIGS. 5g-5h.

In some embodiments, the wire holding element/wire holder 506 is responsible for holding the wire once it is received from either the wire manipulators of the wire preparation unit 210 or when picked up directly from a wire stand.

In some embodiments, the elongated extensions 514a-b can be replaced, automatically and/or manually, to accommodate a different wire gauge (see below).

In some embodiments, electrical mechanism 516 includes an anti-collision mechanism that protects the fingers.

In some embodiments, electrical mechanism 516 includes sensors that can measure moments that are applied by the elongated extensions 514a-b during insertion, for example moments at a value of from about 0.01 NM to about 0.1 NM.

Referring now to FIGS. 5g-5h, showing schematic representations of exemplary gimbal blocks to which the extensions are connected, according to some embodiments of the invention. In some embodiments, the gimbal block 518 comprises a plurality of parts that allow the monitoring of forces applied on the extensions 514a-b. In some embodiments, the plurality of parts are one or more gimbals mounted on top of each other but having different axis of movement. In order to facilitate the explanations, two axis of movement will be described. It should be understood that more gimbals can be use, thereby providing more than two axis of movement that can be monitored. These are also part of the scope of the invention. Returning to FIG. 5g, the gimbal block 518 comprises a top block 528, which connects the gimbal block 518 to the rest of the device. In some embodiments, below the top block 528 there is a top connector 530, which is connected to the top block 528 by means, for example, of screws 552. In some embodiments, one or more damping springs 532 in communication with one or more Button Axis Load Cells 534 are housed between the top block 528 and the top connector 530. In some embodiments, calibration of the Load Cells is performed by actuating the Damping Force Calibrating set screw 536. In some embodiments, below the top connector 530 there is a center block 538. In some embodiments, inserted in the top side of center block 538 there is a first gimbal axis 540, which confers the axis of movement perpendicular to the pin of the first gimbal axis 540 in the horizontal direction (see below explanations about the movement of the gimbal block). In some embodiments, inserted on the bottom side of the center block 538 there is a second gimbal axis 542 (shown in an inserted position). In some embodiments, the second gimbal axis 542 is perpendicular to the first gimbal axis 540. In some embodiments, the second gimbal axis 542 confers the axis of movement perpendicular to the pin of the second gimbal axis 542 in the horizontal direction (see below explanations about the movement of the gimbal block). In some embodiments, below the center block 538, there is a bottom connector 544, which is connected on the top to the center block 538 and on the bottom to a bottom block 546. In some embodiments, not shown in FIG. 7D, another set of one or more damping springs in relation/interface with another set of one or more Button Axis Load Cells are housed between the bottom connector 544 and the bottom block 546. In some embodiments, the extensions 514a-b are connected to the bottom block 546.

In some embodiments, the device comprises one gimbal block 518 to which both extensions 514a-b are connected. In some embodiments, the device comprises two gimbal blocks 518, one gimbal block 518 for each extension, as shown for example in FIG. 7E.

Referring now to FIG. 5h, showing schematic representation of the exemplary movements of the gimbal block 518 and an exemplary embodiment of a device comprising two gimbal blocks, according to some embodiments of the invention. In some embodiments, as mentioned above, the gimbal block 518 comprises a first gimbal axis 548, which provides the gimbal block 518 movement in a first axis, and a second gimbal axis 550, which provides the gimbal block 518 movement in a second axis. In FIG. 5h, a side view of the gimbal block 518 is shown, showing the movement (arrow 548) enabled by the first gimbal axis 550. Additionally, in FIG. 5h, a front view of the gimbal block 518 is shown, showing the movement (arrow 550) enabled by the second gimbal axis. In some embodiments, the first gimbal axis 548 and the second gimbal axis 542 provide the gimbal block 518 with dual rotational axes at different locations. In some embodiments, these rotational axes are used with the single axis load cell to measure moments and force applied on the extensions. In some embodiments, as shown in FIG. 5h, the two extensions are each separately connected to a gimbal block 518, therefore allowing measurement of different forces on each extension. In some embodiments, when the gimbal mechanisms reach their limit of rotation (movement), which optionally implies an access of force applied on an extension (for example during a possible collision of the device with the electrical panel), the system may halt the insertion operation of the wire and/or take corrective actions (moving the device).

Referring now to FIG. 5i, showing a schematic representation of an exemplary wire locking element/wire locker 508, according to some embodiments of the invention. In some embodiments, the wire locking element/wire locker is configured to interact with the wire locking mechanism of a component after the wire is inserted in the respective electrical terminal block of that component in the wire cabinet. In some embodiments, components used in the cabinet can comprise different types of locking mechanisms in their connectors, for example: screw terminal, push button and/or push-in. In some embodiments, when using a component comprising an electrical terminal connector comprising a push-in locking mechanism, a wire locking element/wire locker 508 is not needed and therefore not used. In some embodiments, screw terminal or screw type terminal blocks (components) secure the wire against the conductor in the terminal block (component) by tightening a screw which closes a clamp. In some embodiments, push button terminal blocks secure the wire against the conductor by a spring clamp that is opened by pressing a button. In some embodiments, releasing the button clamps the spring onto the wire. In some embodiments, similar to the push button with a spring clamp, a push-in terminal block allows the wire to be pressed directly into the housing without the use of a push button to open the spring. In some embodiments, according to the type of locking mechanism in the terminal block (component), the wire locking element/wire locker 508 will comprise a dedicated actuator 554. For example, in FIG. 5i, the wire locking element/wire locker 508 comprises a flat head screwdriver 554 which is used to secure screw type terminal blocks. In some embodiments, the head of the actuator and/or the drill bit 554 can be replaced manually or optionally automatically (for example, by moving the device towards a replacement rack where the vertical movement 556 is used to replace the head of the actuator 554). Referring now to FIG. 5j, showing schematically representations of a plurality of possible interactions of wiring-end effector modules 208 with different types of terminal blocks (components) having different locking mechanisms of the wire in the connector of the component.

Returning to FIG. 5i, in some embodiments, the wire locking element/wire locker 508 comprises a motor 558 configured to actuate the dedicated actuator 554. In some embodiments, the motor 558 and the dedicated actuator 554 are held by a base 560, which is further connected to a second motor 562 that performs a vertical movement, as schematically shown by arrow 556, necessary for the insertion of the dedicated actuator 554 into the terminal block. In some embodiments, not shown in FIG. 5i, a plurality of motors are used to provide a plurality of movement directions to the wire locking element/wire locker 508. In some embodiments, the wire locking element/wire locker 508 is configured to move up and down, to the sides and forwards-backwards. In some embodiments, a potential advantage of providing such freedom of movement to the locking element 508 is that it allows the device to interact with a plurality of electrical terminal connectors, each having a different location for the access to the wire locking mechanism.

In some embodiments, the wire locking element/wire locker 508 comprises a torque sensor configured to monitor the torque forces applied by the actuator on the locking mechanism of the electrical terminal connector in the component. In some embodiments, the system comprises a database where specific torque forces related to specific locking mechanisms of electrical terminal connectors are saved. In some embodiments, the system comprises instructions to actuate the actuator according to specific parameters which specifically match the torque requirements of specific locking mechanism of specific electrical terminal connectors and specific wire gauge.

### Exemplary Use of Wires Having End Terminal (Wire Head) Ferrules

Referring now to FIGS. 6a-6b, showing schematic representation of ferrules, according to some embodiments of the invention. In some embodiments, the wires used in the automatic wiring system are wires that comprise a built-in ferrule at the distal end (ferrule wire head). Ferrules are a ring or cap 602, optionally having a metal distal end 604, used to enclose the distal end of the exposed wire in order to facilitate the handling and connection of the distal end of the wire into the electrical terminal connector of the component. In some embodiments, the ferrule is stiff. In some embodiments, the ferrule is stiffer than the wire itself. In some embodiments, the ferrule is between about 2 and about 10 times stiffer than the wire. In some embodiments, ferrules can have different dimensions, as shown for example in FIG. 6a. In some embodiments, the ferrules can have a different form of the metal part 602 at the distal end, as shown for example in FIG. 6b. In some embodiments, since the ferrule comprises the cap 602, which is stiffer than the wire itself, the wiring-end effector 206 pinches the cap 602 instead of directly pinching the wire. In some embodiments, a potential advantage of pinching the cap 602 is that it eases the manipulation of the wire during the insertion into the electrical terminal connector of the component. Since the wire is pliant, it can happen that the wire bends during the insertion causing a deviation in the directionality of the head of the wire that needs to be inserted in the electrical terminal connector. Pinching the cap 602 potentially helps avoiding this. In some embodiments, ferrules are configured to be completely inserted into the electrical terminal connectors of the components, meaning that the cap 602 needs to be completely inserted inside the electrical terminal connector of the component in order to be correctly connected. In some embodiments, during the use of wires with ferrules, the method of insertion of the wire into the electrical terminal connector of the component comprises additional steps, as will be further disclosed below. In some embodiments, the additional actions needed to be performed during the insertion of a wire including a ferrule include one or more of: the partial insertion of the ferrule into the electrical terminal connector of the component, release or partial release of the ferrule, moving backwards of the device, re-pinching the wire at a distal location in the wire in relation to the ferrule, finishing the insertion of the wire and ferrule in the electrical terminal connector of the component. In some embodiments, before the release of the ferrule, the system optionally partially closes the locking mechanism of the electrical terminal connector in the component to partially hold the ferrule in place and potentially avoid the ferrule from exiting the electrical terminal connector. In some embodiments, in this case, after re-pinching the wire and before further inserting the wire in the electrical terminal connector, the system releases the locking mechanism of electrical terminal connector to allow further insertion of the wire into the electrical terminal connector. In some embodiments, the wiring-end effector module 208 comprises an additional element configured to hold the wire in place while the extensions are moved to a more distal position on the wire. In some embodiments, the additional element can be a third extension configured to be extended when needed and to hold in place the wire.

In some embodiment the extensions/end effector can insert ferrules of complex shape such as fork type ferrule or ring type ferrule into the connector.

### Exemplary Interchangeable End Effector

In some embodiments, as explained above, the wiring-end effector 206 comprises one or more of the following parts: a wire holding element/wire holder 506 and a wire locking element/wire locker 508. In some embodiments, the automatic wiring system is configured to replace one or more parts of each of the wire holding element/wire holder 506 and the wire locking element/wire locker in order to perform a different action in the automated wiring process. In some embodiments, the parts that are replaced are tools.

Referring now to FIG. 7a, showing a schematic representation of a wiring-end effector module 700 configured for interchangeable tools, according to some embodiments of the invention. In some embodiments, as disclosed above, the wiring-end effector module 700 comprises the wire holding element/wire holder 702 and the wire locking element/wire locker 704.

In some embodiments, the wire holding element/wire holder 702 comprises one or more of a force gauge 706, configured for sensing forces from 3 different axis; a gripping actuator 708 configured for actuating an interchangeable tool 710 (for example: a wire holder comprising two extensions as disclosed above for grasping at least one wire 712, a cable holder, a continuity probe, a USB data transfer tool, etc.), which is held by a tool holder 714, for example a snap-in tool holder.

In some embodiments, the wire locking element/wire locker 704 comprises one or more of a mechanical screwdriver motor 716 configured to rotate at least one interchangeable screwdriver bit 718. In some embodiments, the wire locking element/wire locker 704 comprises one or more actuators configured to provide movement to the wire locking element/wire locker 704 in one or more directions. For example, in FIG. 7a, the wire locking element/wire locker 704 is shown with two motors: a first motor 720 configured to provide a vertical controlled movement (see arrow 722) the wire locking element/wire locker 704 and a second motor 724 configured to provide, for example, a horizontal controlled movement (see arrow 726) to the wire locking element/wire locker 704. In some embodiments, motors are configured to move the different parts to one or more different directions, according to wiring requirements.

### Exemplary Interchangeable Tools Locking Mechanism

Referring now to FIGS. 7b-7c showing schematic representations of an exemplary locking mechanism for interchangeable tools, according to some embodiments of the invention. In some embodiments, the wire holding element/wire holder 702 comprises one or more locking mechanism 728 configured to lock in place the interchangeable tools once inserted in the dedicated tool holder 714. For example, the locking mechanism 728 comprises a mechanical actuator 730 configured to move backwards and forwards a locking pin 732. FIG. 7b shows, for example, when the locking pin 730 of the locking mechanism 728 locks the interchangeable tool in place, while FIG. 7c shows, for example, when locking pin 730 of the locking mechanism 728 is retracted to allow release of the interchangeable tool. In some embodiments, the locking mechanism 728 can be further used to provide an electrical connection for the continuity connection tool (see below).

### Exemplary Characteristics of the Interchangeable Tools

Referring now to FIGS. 7d-7j, showing schematic representations of exemplary end effector interchangeable tools and their characteristics, according to some embodiments of the invention. In some embodiments, the interchangeable tool configured for grasping a wire/components is manufactured in order to potentially overcome difficulties related to automated wiring systems.

For example, in some embodiments, as schematically shown in FIG. 7d, the interchangeable tool grasping a wire comprises a width that is small enough to pass through spaces in an exemplary duct where the wire is being extended. In FIG. 7d it can be seen an interchangeable tool 734 grasping a wire 736 and positioning it along a duct 738. In some embodiments, at some point, the wire needs to exit the duct 738 to reach, for example, a terminal block 740. In some embodiments, exemplary ducts 738 comprise periodical openings, comprising a width W2, which allow wires 736 to enter/exit the duct 738. In some embodiments, the interchangeable tool 734 grasping a wire 736 comprises a total width W1 that is smaller than the width W2 of the opening of the duct 738 (W1<W2). In some embodiments, the total width W1 of the interchangeable tool 734 comprises a width of about 6 mm, for example from about 3 mm to about 6 mm, optionally form about 2 mm to about 8 mm, optionally from about 1 mm to about 10 mm.

Another example, in some embodiments, as schematically shown in FIG. 7e, the interchangeable tool comprises a length that is big enough to reach an exemplary component without risking collision between the end effector and the components of the panel. In some embodiments, as disclosed in several embodiments herein elsewhere, an exemplary end effector comprises a plurality of parts, which together, provide an end effector of a certain size. In some embodiments, the size of the end effector might limit movement and/or distances to which the end effector can approach the panel. In some embodiments, the tools are characterized by having a length that allows reaching the panel while keeping a safe distance from the panel and/or from components in the panel. FIG. 7e shows a panel 742 comprising a plurality of components 744a-f, each having different heights (heights being a distance that a certain component protrudes from the surface of the panel). In addition, several interchangeable tools 734 are shown to show how the length of them allows reaching the components while keeping the volumetric part 746 of the end effector away and/or at a safe distance from the components/panel. In some embodiments, the length of the extensions of the interchangeable tool 734 is from about 20 mm to about 200 mm, optionally from about 15 mm to about 250 mm, optionally from about 10 mm to about 300 mm.

Following the potential limitation in movement of the end effector due to its size, in some embodiments, the distal end of the interchangeable tool 734 configured for grasping wires, might comprise specialized grasping ends that allow grasping the wire at a certain angle. For example, as schematically shown in FIG. 7f, the interchangeable tool 734 comprises a distal end that grasps a wire at an angle of about 45° in relation to the axis of the extensions of the interchangeable tool 734. In some embodiments, the angle is from about 0° to about 180°, for example, 0° (which is exactly as the axis-meaning the distal end wire is facing completely down along the axis of the extensions of the interchangeable tool 734), 30°, 45°, 70°, 90° (which is perpendicular to the axis of the extensions of the interchangeable tool 734). In some embodiments, a potential advantage of grasping a wire at a certain angle is that it allows positioning a wire at a best angle in relation to the location that is needed to be inserted without the need to maneuver the whole end effector in relation to the panel/component.

### Exemplary Wire Gripping Mechanism

Referring now to FIGS. 7g-7j showing an exemplary wiring gripping mechanism, according to some embodiments of the invention. In some embodiments, as explained above, the automated wiring system comprises two extensions (for example 514a-514b in FIG. 5e) configured to interact with a wire during the wiring process. In some embodiments, the two extensions work as “fingers” that grab the wire. In some embodiments, in order to allow the use of interchangeable tools in the wire holding element/wire holder 702, the mechanism 708 that actuates the movement (opening/closing) of the two extensions is located outside and/or separated of the extensions themselves, thereby allowing exchanging the tools while utilizing a single actuating mechanism. In some embodiments, the actuation mechanism 708 comprises two pressing parts 748/750 configured to apply controlled forces (see arrows in FIG. 7g) on the extensions 752/754 of the tool 756 in order to provide a controlled grip of the wire 758 to the wire holding element/wire holder 702. In some embodiments, each extension 752/754 is connected at a proximal end to a head 762 of the tool 756. In some embodiments, the movement of the two extensions 752/754 towards each other when actuated is a circular one (as shown by the arrow), for example, similar to the movement of tweezers when actuated, as the proximal ends of the two extensions 752/754 are connected to the head 762 and only the distal ends are free to move.

Referring now to FIGS. 7i-7j showing three exemplary actuation states of an exemplary wire gripping tool, according to some embodiments of the invention.

In some embodiments, when the actuation mechanism 708 is not activated, the two extensions 752/754 of the tool 756 are separated from each other, for example, a distance D1, as shown for example in FIG. 7h. In some embodiments, an exemplary distance between the two extensions 752/754 when not actuated is from about 3 mm to about 4 mm, optionally from about 2.5 mm to about 4.5 mm, optionally from about 2 mm to about 5 mm, for example 3 mm, 4 mm, 4.7 mm and any number there between. In some embodiments, optionally, the opening distance between the two extensions 752/754 is determined by the wire gauge and an additional added gap allows a simple release of the object being held.

In some embodiments, upon activation of the actuation mechanism 708 (not shown) the distance between the two extensions 752/754 of the tool 756 is decreased, for example, to a distance D2, as shown for example in FIG. 7i. In some embodiments, an exemplary distance between the two extensions 752/754 when actuated (meaning in a closed configuration) is from about 1 mm to about 2 mm, optionally from about 1.5 mm to about 2.5 mm, optionally from about 2 mm to about 3 mm, for example 2 mm, 2.7 mm, 3 mm and any number there between. In some embodiments, when the two extensions 752/754 are in a close configuration, they are configured to secure the object being held with minimal friction between them. In some embodiments, the distance between the two extensions 752/754 of the tool 756 is decreased by applying a certain amount of force F1 on one or more of the extensions 752/754. In some embodiments, an exemplary amount of force applied is from about 4N to about 10N, optionally from about 2N to about 15N, optionally from about 1N to about 20N. In some embodiments, when the two extensions 752/754 of the tool 756 are actuated to have a distance D1 between the two extensions 752/754 of the tool 756, the automated wiring system optionally utilizes the wire holding element/wire holder 702 for routing the wire along the electrical cabinet, as the distance D1 is configured to allow holding a wire at the distal grooves 760 of the two extensions 752/754 while not actually grabbing the wire, therefore allowing the wire to “run free” between the grooves 760 without losing the wire in the process.

In some embodiments, upon further activation of the actuation mechanism 708 (not shown) the distance between the two extensions 752/754 of the tool 756 is further decreased, for example, to a distance D3, as shown for example in FIG. 7j. In some embodiments, an exemplary distance between the two extensions 752/754 when not actuated is from about 3 mm to about 4 mm, optionally from about 2.5 mm to about 4.5 mm, optionally from about 2 mm to about 5 mm, for example 3 mm, 4 mm, 4.7 mm and any number there between. In some embodiments, optionally, the opening distance between the two extensions 752/754 is determined by the wire gauge and an additional added gap allows a simple release of the object being held. In some embodiments, the distance between the two extensions 752/754 of the tool 756 is further decreased by applying a certain amount of force F2 on one or more of the extensions 752/754. In some embodiments, an exemplary amount of force applied is from about 4N to about 10N, optionally from about 2N to about 15N, optionally from about 1N to about 20N. In some embodiments, when the two extensions 752/754 of the tool 756 are actuated to have a distance D2 between the two extensions 752/754 of the tool 756, the automated wiring system utilizes the wire holding element/wire holder 702 for grabbing the wire (gripping mode), as the distance D2 is configured to allow firmly grabbing a wire at the distal grooves 760 of the two extensions 752/754. In some embodiments, for example, the insertion of a distal end of a wire to an electrical connector is performed in this mode.

In some embodiments, D1>D2>D3.

### Exemplary Manipulation System of Wires and Methods Thereof.

In some embodiments, as disclosed extensively herein, the automatic wiring system is used to wire an electrical panel, for example by performing a plurality of actions that includes positioning a wire inside ducts and/or clips and/or other objects, as well as connecting the end of wires to electrical components. In some embodiments, the manipulation of wires is performed by one or more end-effectors. In some embodiments, as mentioned, one or more sensors are used to identify an object in the electrical cabinet, like a duct or a clip or any other object. In some embodiments, for example, the one or more sensors are one or more of optical sensors, force sensors, torque sensors and moment measuring sensors. In some embodiments, the one or more sensors are used to receive feedback of a state of a wire and the surroundings of the wire. For example, the sensor feedback indicates a contact between the wire and an object (for example a duct).

In some embodiments, further movements of the end effectors are executed, for example perpendicular to the vertical axis of the sensed object, while slightly touching the object (meaning while sensing a small vertical force). In some embodiments, the movements are in a diagonal direction, for example in a vertical and lateral direction, where, for example, the lateral movement is for example in increments of few millimeters, for example increments of 8 mm, 5 mm, 3 mm, 2 mm, 1 mm, while the vertical movement is for example in a same or in a different size increments of few millimeters, for example 4 mm or 6 mm. In some embodiments, by sensing the vertical and lateral forces, the position and movement of the end effector are adjusted to allow manipulation of a wire, for example to allow insertion of a wire into a slot (as shown for example in FIG. 7d or FIGS. 18-e-18h) or into a connector (as shown for example in FIG. 18q).

In some embodiments, a rod is being inserted through an object instead of a wire, as shown for example in FIGS. 18a-c, below.

In some embodiments, an object (for example, a clip, a duct or a component) is being manipulated while the wire is stationary. In this case, the relative forces and movements create similar behavior regardless of the moving object.

In some embodiments, during the wiring process, positioning of a single wire may comprise a plurality of actions, which involve moving the wire through various objects, for example, ducts, a panel opening (see FIGS. 19a-b), an opening in a sheet of metal opening, a bracket and more.

In some embodiments, dedicated design is applied to the accessories in order to facilitate the automation of the process (for example, a clip), and dedicated feedback parameters such as sensing (for example sensing forces) and acquiring images are used in assisting in the insertion process. In some embodiments, standard accessories are used, meaning no special or dedicated accessories are required. In some embodiments, for these accessories, the insertion movement may be a complex 3D trajectory that can for example “open” the clip along with exerting prescribed force(s) on the clip.

In some embodiments, as mentioned herein elsewhere, the system uses a learning algorithm to improve the process of insertion, for example for a new duct design, and one of the following may be used: deep learning, reinforcement learning etc. In some embodiments, data is collected from multiple trials (from example in the lab and/or in the field) and is used to improve the process. In some embodiments, when a new object is presented to the system, the object is “investigated” by the system by using multiple sensors to identify the holes and slots and the general dimensions. In some embodiments, a trial and error for insertion may be used as first attempts for insertion with learning improvements.

Referring now to FIG. 7k, showing a schematic representation of the system 770, according to some embodiments of the invention. In some embodiments, an exemplary system 700, comprises an automatic wiring system 100, as described extensively herein, configured for processing a panel comprising ducts and tools 772. In some embodiments, the system is linked to remote and/or local technical office 774 optionally through a cloud line 776.

Referring now to FIG. 7l, showing an exemplary method of wiring, according to some embodiments of the invention. In some embodiments, the method comprises one or more of the following actions:

Identifying a go-through object (778).

Assessing whether the object is a wire duct (780).

If the object is not a wire duct, either the system assesses whether the object is known (for example by examining an internal library) or a new wiring routine is generated for the object (782).

If the object is a wire duct, the already learned process is implemented:

Finding a duct location (784), for example using touch/force sensors or by using vision.

Once object location (height and possibly position) is found a search begins to find a slot to pass the wire through (786). In some embodiments, the search possibly includes a force sensing feedback, visual feedback, and possibly other sensors.

Once the slot entry point is found the system will insert the wire into the slot (788) for example by moving the wire in a way that indicated the slots boundaries.

Once the wire is passed through the slot, the system can proceeds with the next step on the other side of the duct (790).

Referring now to FIGS. 7m-o, showing exemplary force graphs during a process of finding a location of a duct, according to some embodiments of the invention. In some embodiments, finding a location of a duct, for example the height of a duct, comprises moving down slowly the end effector, for example in the Z direction, until a force is detected in that direction (Z direction)—as shown for example in FIG. 7m. For example a change of force of more than 1N, or for example of more than 2N or of more than 3N. In some embodiments, once the end effector finds the duct, a lateral movement is executed with a small displacement in the Z vertical axis, as shown for example in FIGS. 7n and 7o. For example, the Z movement may be of 0.5 mm or 1 mm to 2 mm, while the lateral movement (in Y direction) can be for example of 4 mm, 6 mm or 8 mm. In some embodiments, the movement is diagonal and the system assesses for Y direction forces. In some embodiments, the system performs a change in the Y direction (move diag. to opposite side). In some embodiments, the system reduces the amplitude and moves down.

In some embodiments, the end effector touches the 2 sides in order to adjust amplitude. In some embodiments, when a lateral opposing force is detected, the end effector will begin to move downwards while changing the Y lateral motion for example using the following logic:

Y move step i=Delta Yi

Y move step i+1=−(Delta Yi)*X % where X is less than 1 and indicates conversion factor; the “-” sign indicates side to side movement of the head.

Alternatively, the end effector moves until a lateral sensed force reaches a value greater than a set value, for example greater than 1N, 2N. In some embodiments, once a certain force is reached (and possibly does not change), the position is recorded and the movement direction is reversed in order to find the opposite side using the 2-sides forces and recording the locations. In some embodiments, the center of the slot is calculated and used for the wire insertion. In some embodiments, as can be understood for the above explanations, this algorithm can be used with necessary adjustments to find holes or other openings.

### Exemplary Interchangeable Tools 208

In some embodiments, the automatic wiring system comprises a dedicated stand 208 comprising a plurality of different interchangeable tools 802 and/or a plurality of different interchangeable screwdriver bits 804, as shown for example in FIG. 8a.

Referring now to FIGS. 8b-8c, showing an exemplary stand for different interchangeable tools 802, according to some embodiments of the invention. In some embodiments, the automatic wiring system is configured to interchange tools according to the required task. In some embodiments, exemplary interchangeable tools can be divided in three main types: wire gripping tools, cable gripping tools and technical tools. In some embodiments, exemplary interchangeable tools 802 comprise one or more of the following: a wire gripper for small size wires 806 (for example having a diameter between 0.5 mm and 1.0 mm); a wire gripper for medium size wires 808 (for example having a diameter between 2.5 mm and 4.0 mm); a wire gripper for large size wires 810 (for example having a diameter from 6.0 mm and higher); a USB gripper 812/814, a RJ45 gripper 816, a HDMI gripper 818, a continuity test probe 820 and a USB data transfer tool 822. In some embodiments, the plurality of exemplary interchangeable tools 802 are held in the stand while in close proximity of the wiring-end effector 206, which is configured to move during the wiring process.

### Exemplary Wiring Gripping Tools

Referring now to FIG. 8d, showing exemplary interchangeable wire gripping tools, according to some embodiments of the invention. In some embodiments, as explained above, wire gripping tools comprise three main components: a head and two extensions. In some embodiments, the head is configured to be inserted in the holding element of the wire holding element/wire holder element. In some embodiments, optionally, the head comprises a marking 824 that allows the user and/or the system to identify the type of tool. For example, in FIG. 8d, it can be seen a zoom-in of an exemplary marking 824 showing “T38”. In some embodiments, a marking 824 can be a number that is identified by the system using a camera. In some embodiments, a marking 824 can be, for example, a barcode and/or an RF tag that is identified by the system using a dedicated scanner. In some embodiments, the markings are used to verify the authenticity of the wire gripping tool 756.

In some embodiments, each of the two extensions 752/754 comprise a distal end configured to interact with a wire. In some embodiments, as mentioned above, the distal end comprise one or more grooves 760 configured to interact with a wire. In some embodiments, a wire gripping tool 752 is configured to grab a wire so the distal end of the wire is held horizontally 826 or vertically 828, as shown for example in FIG. 8d. In some embodiments, a same distal end can hold a wire either vertically or horizontally. In some embodiments, a wire is “presented” to the wire gripping tool 756 already in the desired direction (horizontal/vertical). In some embodiments, the wire gripping tool 756 is configured to grab a wire, sense its direction, and amend it if necessary by moving the wire gripping tool 756 accordingly.

In some embodiments, the distal end can be straight 830 or “L”-shaped 832. In some embodiments, the distal ends are configured for holding different diameter of wires, for example, wires having a diameter of from about 0.5 mm to about 6.0 mm. In some embodiments, different wire gripping tools 756 are configured to grab different types of wires, for example, a wire gripper tool 806 for small size wires (for example having a diameter between 0.5 mm and 1.0 mm); a wire gripper tool 808 for medium size wires (for example having a diameter between 2.5 mm and 4.0 mm); a wire gripper tool 810 for large size wires (for example having a diameter from 6.0 mm and higher).

### Exemplary Cable Gripping Tools

Referring now to FIG. 8e showing exemplary interchangeable tools configured to grab technical cables, according to some embodiments of the invention. FIG. 8e shows how exemplary USB gripper 812, RJ45 gripper 816 and HDMI gripper 818 grab the relevant technical cables. In some embodiments, the tools are configured to manipulate (for example, grasping and positioning) tubes, pipes, fiber optic elements and any other required object.

### Exemplary Technical Tools

Referring now to FIG. 8f showing exemplary technical tools, according to some embodiments of the invention. In some embodiments, the wiring system comprises a dedicated continuity test probe 820 configured for assessing the correct connection of the wires in the electrical cabinet. In some embodiments, after a certain electrical line has been assembled by the system, the system assesses the wires have been correctly connected by utilizing the continuity test probe 820. In some embodiments, the wiring system comprises a dedicated USB data transfer tool 822 which is used, for example, to assess correct functioning of USB ports, to install and/or update software of electronic components in the electrical cabinet, etc. In some embodiments, interchangeable technical tools comprise dedicated power/data transfer connectors 834 located at the connector of the tool.

In some embodiments, dedicated tools are designed with special geometry/(ies) that will allow access to hard to reach/tight areas. For example, an offset tool where the wire tip/ferrule location is off-set from the center of the end-effector. Another example is a slim tool may be required for some specific tasks, for example as schematically shown for FIGS. 7d-7f, to navigate between wires, navigate between components and reach components at certain angles. In some embodiments, optionally, a long tool may be needed to access a connection point adjacent to protruding objects. In some embodiments, optionally, a curved or hooked tool may be used to access behind an obstacle.

### Exemplary Dedicated Calibration of End Effector and Interchangeable Tools

In some embodiments, due to the difference (for example) in shape and/or role of specific interchangeable tools, dedicated calibration actions are performed beforehand and/or before use and/or during use of the automated wiring system. In some embodiments, as mentioned above, the end effector comprises one or more sensors configured to monitor, for example, forces applied on the end effector, forces required for the correct positioning of components/wires in the panel and forces applied on the end effector to sense collision (in order to avoid collision of the end effector with components/panel). In some embodiments, the one or more sensors are located on the end effector itself (for example at the base of the end effector above and/or near the adaptor for the interchangeable tools) and are not removed and/or replaced and/or interchanged when an interchangeable tool is changed. Therefore, in some embodiments, since the one or more sensors are fixed on the end effector, dedicated calibrations may be required for and/or in view the exchangeable parts and/or tools. In some embodiments, different interchangeable tools require dedicated monitoring of forces, for example, the forces required to insert a wire into a terminal block are possibly different from the forces required to insert a USB into a USB port. Additionally or alternatively, the length of the different interchangeable tools also influences the monitored forces, even between same roles interchangeable tools (for example, long wire holder and short wire holder). In some embodiments, a potential advantage of performing calibration is that it potentially allows monitoring of moments and torques applied on the tools (for example of the two extensions) during wiring processes. In some embodiments, the moments and torques depend on the geometry and kinematics of the tool, which, in some embodiments, require specific and personalized calibration per tool. In some embodiments, additionally or alternatively, the grasping (pinching/holding) force of the tool also depends on the geometry and kinematics of the tool, which, in some embodiments, require specific and personalized calibration per tool.

Therefore, in some embodiments, personalized calibrations are performed to each interchangeable tool, in view of its role and its physical characteristics. In some embodiments, the calibrations are performed at the factory. In some embodiments, calibrations are performed before performing a specific wiring process. In some embodiments, calibrations are performed during the wiring process.

In some embodiments, calibration information is collected by one or more of tests, analysis (for example, with finite element or straight calculations) and by performing simulations.

### Exemplary Alternative Wire Gripper Tool

Referring now to FIGS. 9a-9b showing schematic representations of an exemplary alternative wire gripper tool, according to some embodiments of the invention. In some embodiments, an exemplary alternative wire gripper tool 900 comprises a head 902, similar to the head disclosed above, for example, in FIGS. 7g-7j. In some embodiments, the exemplary alternative wire gripper tool 900 comprises a fixed extension 904, having a proximal end that is connected to the head 902, and a distal end having a wire housing 906. In some embodiments, the exemplary alternative wire gripper tool 900 comprises a mobile extension 908 configured to move vertically (see arrow 910) in parallel to the fixed extension 904. In some embodiments, the mobile extension 908 comprises a distal end 912 configured to meet the wire housing 906 at the distal end of the fixed extension 904 so as to enclose the wire 914 within the wire housing 906. In some embodiments, similar to what was explained in relation to FIGS. 7h-7j, the amount of distance that the mobile extension 908 moves corresponds to either an open configuration (as seen for example in FIG. 9a), or a closed configuration (as seen for example in FIG. 9b), where in the closed configuration the distance can be just to keep the wire 914 within the wire housing 906 while allowing to “freely-run” therein, or the distance can be to firmly grab the wire 914 within the wire housing 906.

In some embodiments, the mechanism that moves the mobile extension 908 is a mechanical mechanism, for example using a pulley mechanism 916, as schematically shown in FIGS. 9a-9b. In some embodiments, the mechanism that moves the mobile extension 908 is an electrical mechanism, for example using one or more electrical motors and gears.

In some embodiments, a potential advantage of the exemplary alternative wire gripper tool 900 having a vertical closing mechanism is that the mechanism can potentially assist in the insertion of the distal end of the wire in the electrical connector due to the assistive forces applied in this type of holding. Additionally, this mechanisms can potentially assist in checking that the distal end of the wire has been properly attached to the electrical connector by performing a delicate “pull-push” action to the wire and sensing whether there is resistance, as explained herein elsewhere. Additionally, this configuration potentially assists in placing the wire in the duct because, on one side, can firmly grab the distal end while directing it within the duct, while on the other side, when two arms are used, can allow for the wire to “freely run” within the wire housing 906, while still providing “directionality” to the wire being pulled.

Referring now to FIG. 10a, showing another exemplary wiring end-effector having interchangeable tools capabilities, according to some embodiments of the invention. In some embodiments, as disclosed above, an exemplary wiring end-effector comprises a wire holding element/wire holder 1002 and a wire locking element/wire locker 1004.

In some embodiments, also as explained above, the wire locking element/wire locker 1004 comprises a screwdriver unit 1006 with torque control (not shown) and at least one screwdriver head 1008, configured to actuate screws where necessary during the wiring process.

Referring now in addition to FIG. 10a, also to FIGS. 10b-10g, showing a wire holding element/wire holder 1002, according to some embodiments of the invention. FIG. 10b shows an exemplary wire holding element/wire holder 1002 alone. FIGS. 10c and 10d, show exemplary parts of the wire holding element/wire holder 1002. FIGS. 10e, 10f and 10g, show exemplary parts of an exemplary tool 1014. In some embodiments, the wire holding element/wire holder 1002 comprises a multi-axis sensor 1010, configured for monitoring the tridimensional movements of the wiring tools. In some embodiments, the wire holding element/wire holder 1002 comprises a tool changer 1012, configured for allowing the exchange of tools 1014 that are required to perform a wiring process. In some embodiments, the wire holding element/wire holder 1002 comprises one or more sensors 1018 configured for monitoring the performance of one or more parts of the wire holding element/wire holder 1002. In some embodiments, the wire holding element/wire holder 1002 comprises one or more tool actuators 1016 configured for actuating the tools during the wiring process. In some embodiments, the wire holding element/wire holder 1002 comprises a caging actuator 1022 configured for blocking the tool at a certain position, for example, actuator 1016 causes the tool to close and grasp a wire, then caging actuator 1022 keeps the tool in the closed position, thereby potentially avoiding accidental release of the wire. In another example, when the wiring process requires the tool to remain slightly open, but not completely open, for example, when the wiring arm is required to run along a wire without actually grasping it, the actuator 1016 causes the tool to partially close and loosely hold a wire, then the caging actuator 1022 keeps the tool in the partially closed position, thereby potentially avoiding accidental release of the wire while still allowing the wire to stay loose.

In some embodiments, the wire holding element/wire holder 1002 comprises a tool lock actuator 1024 configured to lock a tool shaft 1020 of a tool 1014 in the wire holding element/wire holder 1002.

Referring now to FIGS. 10e, 10f and 10g, showing schematic representation of exemplary mechanism of actuation of exemplary tools 1014, according to some embodiments of the invention. In some embodiments, an exemplary tool is configured to grab a wire using a “scissor-like mechanism”. FIG. 10e shows one example of how the “scissor-like mechanism” is enabled. In some embodiments, the “scissor-like mechanism” comprises a spring 1026 in communication with an actuation shaft 1028, ending in a distal end actuator 1030. In some embodiments, at the distal end of the tool 1014 there are two “fingers” 1032a/1032b interconnected at a pivot 1034. In some embodiments, when the spring 1026 is actuated, it causes the shaft 1028 to move up and/or down, which causes the distal end actuator 1030 to actuate the two “fingers” 1032a/1032b by moving them in relation to the pivot 1034, which is translated into either the opening or the closing of the two “fingers” 1032a/1032b. FIGS. 10f and 10g show another example of how a “scissor-like mechanism” is enabled. In some embodiments, the “scissor-like mechanism” comprises an actuation shaft 1036 (only shown in FIG. 10f). In some embodiments, there are two “fingers” 1038a/1038b interconnected at a pivot 1040; and each comprising a bearing 1046a/1046b. In some embodiments, optionally, there is guiding pin 1042 configured to keep the movement of the two “fingers” 1038a/1038b along a predetermined axis. In some embodiments, optionally, there is a spring 1044 (only shown in FIG. 10f) located between the two “fingers” 1038a/1038b configured to provide opening force between the two “fingers” 1038a/1038b, so when the actuation shaft is not actuated, the “fingers” 1038a/1038b would be separated by means of the spring 1044. In some embodiments, actuating the actuation shaft 1036 causes the actuation shaft 1036 to either descend or ascend. In some embodiments, when the actuation shaft 1036 descends, it pushes the two bearings 1046a/1046b to the sides causing the two “fingers” 1038a/1038b to close (against the force provided by the spring 1044). In some embodiments, when the actuation shaft 1436 ascends, it allows the spring 1044 to push the two “fingers” 1038a/1038b to the sides thereby opening the tool 1014. In some embodiments, the movement performed by the two “fingers” is an angular and/or circular movement, which is different form a parallel movement.

FIG. 10e shows an exemplary tool 1014 comprising an angled gripping tip 1046, while FIGS. 10f and 10g show an exemplary tool 1014 comprising a parallel gripping tip 1048.

### Exemplary Sensor Mechanism

In some embodiments, the two “fingers” and/or the sensors (for example 1018 and/or 1010) are configured to detect non-scheduled contact between the end-effector and the environment, thereby providing the system with anti-collision means that can potentially avoid damage to the wiring system and or the panel. For example, if and when, during the wiring process, the sensors detect an unscheduled contact of the fingers (or other part of the wiring end effector and/or arm), the system comprises instructions to stop the wiring actions. In some embodiments, optionally, the system comprises instructions to activate another wiring arm to continue the wiring process instead of the arm that was originally used. Another example, if and when, during the wiring process, a wire gets, for example, entangled, the sensors are configured to sense the “unexpected” resistance and stop the wiring process in order to potentially avoid damaging the system and/or the object being wired. In some embodiments, optionally, a tool may be designed to be inserted in between wires and/or to use the two fingers to manipulate the wire and/or to open space between wires. Alternatively, a motion of the end-effector and/or arm are configured to perform one or more movements to cause un-entanglement in the wires. In some embodiments, the system comprises dedicated sensors configured to measure the forces and moments during the un-entanglement process.

In some embodiments, a dedicated “compliant tool”, for example rubber finger and/or spring finger, etc., are used to perform a test run (or “dry run”) of a wiring cycle (for example of accessibility to components, ports and various locations in the process before the actual wiring cycle is performed). In some embodiments, a potential advantage of this is that it potentially allows testing a new panel assembly sequence without damaging the systems and tools.

### Exemplary Simulations

In some embodiments, an analysis is performed, for example by using simulations and/or CAD analysis and/or vision analysis, to determine which tool to use for specific wiring process.

### Exemplary Calibration Processes

In some embodiments, a calibration process is performed for one or more tools in order to calculate the forces and moments that will be applied on them. In some embodiments, external force/moment gauges are used for calibration, in which the calibration can then take into account the tool geometry, sensor parameters and location.

### Exemplary Methods

Referring now to FIG. 11, showing a flowchart of an exemplary validation method, according to some embodiments of the invention. In some embodiments, the system receives a new wiring process data 1102. (See an example of a wiring process in FIG. 20). In some embodiments, the system assesses if the received data has been validated 1104. In some embodiments, when the answer is “NO”, then the system begins a validation process 1106. For example, a validation process for the type of tool that is needed to be used, the wire route to be taken, calculation of force applications on the system parts, collision assessment, insertion processes. In some embodiments, the validation process are performed using simulations and/or analysis and/or dry-runs, etc. In some embodiments, when the answer is “YES”, then the system begins performing the first task (i) 1108. In some embodiments, the system chooses the right tool for the task 1110. In some embodiments, the system optionally chooses the right drill bit (when necessary) 1112. In some embodiments, the system takes one end of the wire and inserts it into component A—as stated in task (i) 1114. In some embodiments, the system routes the wire along the device 1116. In some embodiments, the system inserts the second end of the wire and inserts it into component B—as stated in task (i) 1118. In some embodiments, this exemplary process is repeated until all the tasks are performed. In some embodiments, when all tasks have been done then the wiring process ends.

Optionally, a QA cycle can be performed after all wires have been processed, optionally a QA tool is used for this process.

Referring now to FIG. 12, showing a flowchart of an exemplary method of wiring by an exemplary wiring-end effector 206 having interchangeable tools, according to some embodiments of the invention. In some embodiments, the system couples 1202 an adequate tool to the wiring-end effector 206. In some embodiments, an adequate tool is chosen either according to information received from the system and/or from sensed information in real-time, for example, from one or more of a camera and/or a digital sensor, configured to identify the wire that is going to be used. In some embodiments, the elongated extensions grab the wire by applying radial force on the wires 1204. In some embodiments, the force applied on the wire is from about 5N to about 15N, optionally from about 7N to about 20N, optionally from about 8N to about 25N, for example about 8N, about 10N, about 12N. In some embodiments, the resolution of any of the above forces are of about 1N. In some embodiments, the effector module brings the wire close to the connector by applying axial force 1206. In some embodiments, the force applied on the wire is from about 5N to about 15N, optionally from about 7N to about 20N, optionally from about 8N to about 25N, for example about 8N, about 10N, about 12N. In some embodiments, the resolution of any of the above forces are of about 1N. In some embodiments, the wire is then inserted in the hole of the connector 1208 of the component. In some embodiments, the system then senses the resistance on the wire by the fact the wire reached the end of the hole in the connector 1210. In some embodiments, the system then secures the wire in the connector (see above ways to secure the wire in the connector) 1212 of the component. In some embodiments, the system then pulls back wire by lightly applying contrary directional axial force, while sensing resistance from gabbing sensors, to evaluate firm connection of wire in the connector 1214. In some embodiments, the system then slightly reduces the radial force on the wire while keeping holding the wire 1216. In some embodiments, when the insertion of the wire was the last wire to be connected to a component in the electrical cabinet, then the method ends. In some embodiments, the system then allows the wire (that is still held by the elongated extensions) to slip in the elongated extensions, without releasing the wire, while moving the mechanical arm away from the connector 1218. In some embodiments, the system then continues with the wiring process, as explained therein elsewhere 1220.

Referring now to FIG. 13a-13b, showing a flowchart of an exemplary method of wiring by an exemplary wiring-end effector module when the wire comprises ferrule, according to some embodiments of the invention. In some embodiments, the system couples 1302 an adequate tool to the wiring-end effector 206. In some embodiments, an adequate tool is chosen either according to information received from the system and/or from sensed information in real-time, for example, from one or more of a camera and/or a digital sensor, configured to identify the wire that is going to be used. In some embodiments, the extensions grab the wire by applying radial force on the ferrule 1304. In some embodiments, the force applied on the ferrule is from about 3N to about 110N, optionally from about 7N to about 20N, optionally from about 8N to about 25N, for example about 8N, about 10N, about 12N. In some embodiments, the resolution of any of the above forces are of about 0.5N. In some embodiments, the effector module brings the ferrule close to the connector by applying axial force 1306. In some embodiments, the force applied on the wire is from about 3N to about 15N, optionally from about 7N to about 20N, optionally from about 8N to about 25N, for example about 8N, about 10N, about 12N. In some embodiments, the resolution of any of the above forces are of about 0.25N. In some embodiments, the ferrule is then partially inserted in the hole of the connector 1308 of the component. In some embodiments, optionally, the system partially closes the locking mechanism in the electrical terminal connector to hold the ferrule in place 1310. In some embodiments, the wire with the ferrule are held in place 1312. In some embodiments, this is performed by one or more additional elements as disclosed above. In some embodiments, the extensions are actuated to release the ferrule 1314. In some embodiments, then the device is moved backwards in line with the wire 1316. In some embodiments, the extensions re-grab the wire on the wire itself 1318. In some embodiments, optionally, the system opens the previously partially closed locking mechanism of the electrical terminal connector 1320. Flowchart continues in FIG. 13b following the letter A. In some embodiments, the system then applies axial force to completely inserting the ferrule into the electrical terminal connector 1322. In some embodiments, the system then senses the resistance on the wire by the fact the wire reached the end of the hole in the connector 1324. In some embodiments, the system then secures the wire in the connector (see above ways to secure the wire in the connector) 1326 of the component. In some embodiments, the system then pulls back wire by lightly applying contrary directional axial force, while sensing resistance from gabbing sensors, to evaluate firm connection of wire in the connector 1328. In some embodiments, the system then slightly reduces the radial force on the wire while keeping holding the wire 1330. In some embodiments, when the insertion of the wire was the last wire to be connected to a component in the electrical panel, then the method ends. In some embodiments, the system then allows the wire (that is still held by the elongated extensions) to slip in the elongated extensions, without releasing the wire, while moving the mechanical arm away from the connector 1332. In some embodiments, the system then continues with the wiring process, as explained therein elsewhere 1334.

In some embodiments, the parameters sensed by the one or more sensors, either in the extensions, on the gimbal block or anywhere else in the system, for example force, thresholds, motion values relating to the wire and the insertion process are saved in a data base.

Exemplary Management of a Wire Held by Two Wiring Arm Modules Optionally Each Having a Wiring End Effector Module with Interchangeable Tools

In some embodiments, when a wire is held by two wiring arm modules, the system comprises instructions to choose a correct tool for the job and to hold the wire in a certain way. For example, a dedicated wire gripping tool for a wire having a certain dimeter to hold a wire in a certain position relative to the electrical cabinet. Another example a wire is held with a certain tension between the two points on the wire using the adequate tools that are being held by the two arms. In some embodiments, a series of instructions are prepared and provided to each of the arm modules during the wiring planning process, including a list of tools to be needed and when to be used. In some embodiments, this is performed to allow the robotic arms to act potentially in an autonomous manner and potentially without causing damages to each other, without causing damages to the electrical cabinet, without causing damage to the wire and/or without causing tangling of the wire during the wiring process. In some embodiments, the tension on the wire is directional. For example, while one mechanical arm holds the wire on one end using an dedicated chosen tool, the other mechanical arm, also having a chosen dedicated tool, holds the other end while keeping tension and in the direction of the location where it will be allocated in the electrical cabinet, optionally above the duct/DIN.

In some embodiments, the role of holding and tensing the wire is interchangeable between the two mechanical arms, as long as each is provided with the right tools. For example, at the beginning of a wiring action, a first mechanical arm holds the wire and does not move, while a second mechanical moves while sliding the wire towards the location where the wire will be allocated. Once the second arm arrives at the destined location on the electrical cabinet it stops, the first arm then releases the wire and goes to where the second mechanical arm is located to continue the wiring process. At this point the second mechanical arm is the one holding the wire while not moving, while the first one will be the one sliding the wire and moving it towards the location in the electrical cabinet where it will be positioned. In some embodiments, when needed, during the exchange of roles, the mechanical arm can exchange the tool at the wiring-end effector 206.

In some embodiments, during the wiring process, one of the two arms slides over the wire when laying it on a duct/DIN. For example, as explained above when describing when the wiring-end effector 206 reduces the radial force on the wire and allows the wire to slip while the mechanical arm moves (see FIG. 11), as also explained regarding the FIGS. 7h-7j.

In some embodiments, the distance between the two wiring arms is maintained. In some embodiments, optionally, the distance is adjusted during the placing of a cable in relation to the route of the cable in the duct(s). In some embodiments, optionally, the distance between the arms provide clearance from the components located on the board. In some embodiments, the motion of the arms is slowed down or stopped if the tension is above certain threshold, for example, 15% more than the desired tension and/or the predetermined threshold. In some embodiments, thresholds are set according to the wiring arm capabilities, the type of wire and any combination thereof. In some embodiments, the system monitors the distance between the arms and keeps a certain distance between the wiring arms. In some embodiments, if the distance between the arms exceeds a certain predetermined distance, the motion of the arms is adjusted or stopped.

In some embodiments, when the system senses that a level of tension in the wire and/or a distance between the arms is out of tolerance and/or above or below a predetermined value, for example, ±20% of the predetermined value/tolerance value, the wiring end effector releases the wire to avoid possible damage to the arms and/or the panel/component.

In some embodiments, before placing the wire in a duct, a vision system is used to validate the process.

In some embodiments, operation of two wiring arms for the wiring of a cabinet requires high levels of synchronization and precision in the operation of the arms, the different tools used in the arms, and in a plurality of levels, for example (not an exhaustive list), the operation of one arm with respect to the other, operation of the arms with respect to the cabinet, operation of the arm with respect to the wire, operation of the arms with respect to the wire and the wiring routing plan of the wire in the panel, and each of the above mentioned in relation to dedicated interchangeable tools used during the wiring process.

In some embodiments, an example of dual arm coordination during wire routing operation comprises that during the routing a first arm will lead the way, meaning the arm that will insert the end of the wire to the relevant terminal connector in the component, while a second arm will follow and support the first arm during the routing process. In some embodiments, a lead wiring arm can become a support arm during the wiring process, and vice versa. In some embodiments, during the wiring process the support arm keeps the wire at certain tension in relation to the lead wire arm by maintaining a certain force on the wire (e.g. 2N, 4N, 8N). In some embodiments, during the wiring process the support arm keeps part of the wire in tension, for example the part of the wire held between the two wiring arms, while other part is left without tension (the wire slacks and/or dangles behind the wiring-end effector). In some embodiments, the length of the slack is from about 10% to about 30% of the total length of the wire being wired. Optionally from about 5% to about 40% of the total length of the wire being wired. Optionally from about 1% to about 50% of the total length of the wire being wired. For example 15%, 20% or 25% of the total length of the wire being wired). In some embodiments, during the wiring process, the slacked wire is held above (when the wiring is performed from above on a panel arranged in a horizontal direction) and/or distanced (when the wiring is performed from the side on a panel arranged in a vertical direction) from the plane where the components of the panel are located. In some embodiments, as the leading arm moves towards the insertion point, leading the wire along the planned path on the panel, the second arm is kept at a certain distance behind the first arm. In some embodiments, as the leading arm moves towards the insertion point, leading the wire along the planned path on the panel, the second arm is kept at a location that is in relation to the next point where the wire needs to be inserted, for example, if a wire needs to be inserted through a hole in a duct, the first arm will insert the end of the wire into the hole, while the second arm will be waiting on the other side of the hole to catch the end of the wire, thereby, additionally, becoming the lead wiring arm. In some embodiments, since sometimes the wire is placed in a duct or go through clips, the location of the second arm is set to be in relation to the duct path and the direction of the wiring. In some embodiments, when the duct is straight, the second arm can be positioned at the distant location of the duct relative to the component being wired. In some embodiments, the second arm is used to facilitate twisting of the wire, for example, in order to facilitate turns of the wire inside the panel. In some embodiments, optionally, when a turn in the duct path is expected, the second arm is positioned above this location to facilitate the twisting of the wire. In some embodiments, while positioning a wire in a location where there is change in the direction of the wire, for example a corner in a duct, excess in wire is purposely left after the point of change of direction of the wire and before positioning the wire. In some embodiments, a potential advantage of doing this before positioning the wire is that it provides enough wire to allow proper positioning of the wire without pulling the wire and/or causing distortions in the wire while being changed direction in the required point in the path.

In some embodiments, the wiring process comprises inserting a first end of a wire into a terminal connector in a component in the cabinet and then taking the cable along a planned path inside the cabinet, towards a second component inside the cabinet where the other end of the wire will be connected to a second terminal connector in the second component. In some embodiments, once the first end of the wire has been inserted into the first component, for example, by the first arm, then the second arm will become the leading arm, taking the wire towards the second component, while the first arm will become the support arm.

In some embodiments, the support arm performs one or more of the following actions: securing the wire in the duct (optionally with other tools, for example a passive finger a stapler, a gluer and/or a latching element; or may be used to place a plastic holding strip (“a bridge”) clearing the way to the leading arm; validating routing process using one or more sensors, for example, a camera, a force sensor, a laser line sensor and/or a proximity sensor). In some embodiments, a safe zone is defined, for example, above component level (when the wiring is performed from above on a panel arranged in an horizontal direction) and/or distanced (when the wiring is performed from the side on a panel arranged in a vertical direction) from the plane where the components of the panel are located, and the support arm with the wire are manipulated in the safe zone. In some embodiments, the panel is divided into multiple local safe zones, optionally having different safety heights. In some embodiments, as mentioned above, optionally, the wiring arms comprise wire adhesive elements (e.g. glue, adhesive tape, staples) actuated by one or more dedicated devices, thereby providing means to secure and/or attach the wire to certain location in the panel and/or duct. In some embodiments, as also mentioned herein elsewhere, while the lead arm takes the distal end of the wire to the next point in the panel, the supporting arm slides along the wire to position the wire in place along the path on the panel.

In some embodiment where multiple wires are placed in same duct, the position of the manipulated wire that is being held, is in relation to the already placed wire, for example, if the center of the duct is occupied by other wires, the support arm will place and/or will nudge the wire being currently placed to one side of the duct. In some embodiments, the software takes into account the load on the ducts and can, optionally, add to the wire length to compensate for added distance required due to wire loads in the ducts, for example adding 1%, 2% or 5% to wire length.

### Exemplary Optimization Features for Automated Wiring Processes

In some embodiments, the system comprises one or more features configured to optimize the automated wiring process performed by an exemplary horizontal/vertical automated wiring system.

### Cartridge for Lose Wire During Wiring Process

In some embodiments, as explained above, while the lead wiring arm is positioning the wire along the planned path in the cabinet, the support wiring arm provides support to the actions performed by the lead wiring arm. In some embodiments, one of those support actions is to hold the rest of the wire that the lead wiring arm is “dragging” while moving the end of the wire through the wiring path. In some embodiments, the wiring arms optionally comprise a dedicated cartridge where lose wire is rolled and/or kept, when a specific wire arm acts as support wiring arm. In some embodiments, since the roles of lead and support might change during the wiring process, both arms optionally comprise the dedicated cartridge. In some embodiments, the wire that is kept in the dedicated cartridge is released when necessary during the wiring process, for example, when a motion of an arm requires more lose wire, while considering ducts and/or obstacles in wiring path. In some embodiments, a potential advantage of having the dedicated cartridge is that long wires are kept contained during the wiring process thereby potentially avoiding the lose wire to cause damage or get entangled during the wiring process.

### Exemplary Clearing of Obstacles by the Support Wiring Arm

In some embodiments, if and when during a wiring process, there is a possibility that the wire, being positioned in the cabinet by the lead wiring arm, might get entangled and/or could not be correctly positioned in the destined place along the path, the system is configured to activate the support wiring arm to perform actions to solve these problems. For example, the support wiring arm will move the obstacle (for example other wires already positioned in the cabinet) away from the wire being positioned, optionally using a dedicated tool that allows interaction with other wires without damaging them (for example a tweezer, an elongated rod). In some embodiments, optionally, during the clearing of obstructions, the support wiring arm does not hold the wire being positioned. In some embodiments, optionally, the wire is routed with the two arms around an obstacle. In some embodiments, alternatively, a new path is calculated to provide a detour around the obstacle.

Use of One Wiring Arm when Possible

In some embodiments, the system is not obligated to use two wiring arms for the wiring process. In some embodiments, for example when wiring short wires (e.g. having 1 cm, 2 cm, 5 cm length), the system is configured to allow one wiring arm to do the whole wiring process, leaving the second arm to perform other tasks related to the overall wiring process of the cabinet. In some embodiments, optionally for a short wire, the wiring arm secures one end of the wire in the object/component and then slides along the wire (while possibly “feeling” the sliding motion) to the other end and then insert it in the required position. In some embodiments, optionally, after the 1^{st} insertion, the arm releases the wire and re-grabs it at the other end optionally with aid of sensors for example a vision camera.

### Use of Grip and Slip for Wiring Process

Grip and Slip capabilities: when a human performs wiring actions, he/she uses tactile feedback to secure a cable into a connector/device, a typical cycle of actions includes (see FIGS. 14a-14e):
Gripping tight the wire during insertion by applying radial force on the wire (radial force—FIG. 14a) and applying an insertion force (axial force—FIG. 14b)—before contact force is zero and it grows during insertion);
At a certain peak force (as determined by user experience) he “feels” that the wire is inserted in the connector (peak force—FIG. 14c) of the component. Usually at this point, the axial force is countered by the complete insertion of the wire in the connector in the component;
After the wire is secured in the connector, the user pulls back the wire (to feel if it is tightly secured) at a certain force (user pulls—FIG. 14d);
Then, the user apply less radial force on the cable (the grip force) and allows the cable to slip in the hand in the axial direction (FIG. 14e). Usually, the user feels the slip of the cable without releasing the wire.

In some embodiments, these actions are performed using capabilities that are referred herein as Grip and Slip capabilities.

In some embodiments, the system utilizes its ‘grip and slip’ capabilities for the allocation of the wires on the planned path. For example, wiring arm can hold the wire on top of the surface where it is needed to be positioned, and slowly moving along the wire (the ‘slip’ component of the ‘grip and slip’ capabilities) while positioning the wire in the destined path.

### Exemplary Actuation of Circuit Breakers

In some embodiments, the wire end effectors are configured to actuate, for example, moving upwards/downwards and/or pushing, circuit breakers in the panel using dedicated interchangeable tools. In some embodiments, the actuation is performed using the extensions. In some embodiments, actuation is performed using a dedicated actuation device. In some embodiments upon switching on/off a component, certain tests are performed, for example, continuity test, load test, logical test (of circuit logic).

### Use of Complex Wires

In some embodiments, the system is configured to manipulate not only single wire wires, but also wires comprising one or more splits in the wire, providing a multi-wire wire and/or harnesses. In some embodiments, for example, wires with a T-like harness having three ends, the supporting arm holds the location on the wire where the split in the wire is located while the leading arm inserts one end of the wire to a component and then a second end of the wire to a second component.

### Example Using the System to Wire Harness in a Cabinet

In some embodiments, as disclosed above, the tools of the end-effector are configured to hold a wire head that needs to be inserted into a component. For example, a network cable comprises a dedicated wire head (also known as RJ45 connector). In this example, the extensions of the end-effector are configured to hold the RJ45 connector of a network cable and connect it to a dedicated component in the cabinet. In some embodiments, the system comprises information about the sensory feedback that will be recorded when connecting these types of wire heads, for example, force, torque and visual feedback. In some embodiments, sensory feedbacks are used to validate proper insertion of the wire head in place. In some embodiments, after insertion of the wire head in place, the locking actuator is used to secure the wire head in place, for example by tightening the screws of the connector in the component. In some embodiments, a dual push action is used (i.e. pushing releasing and re-grabbing) to insert the wire head.

### Optional Division of Tasks in a Timeline

In some embodiments, the system is configured to perform a part of a task, stop, perform a different task, and then pick up the previous task and finish it. For example, connecting one end of a wire to one connector and positioning the wire along the planned path, release the wire, perform different tasks and then return to the wire previously left and continue with the positioning and/or connection to a connector. In some embodiments, re-grabbing a wire is done using vision system and/or by going to a known position (a component a clip a corner) and slipping along the wire to its end.

### Exemplary Provision of Multiple Degrees of Freedom to the Wire End Effectors

In some embodiments, the wire end effectors are provided with multiple degrees of freedom (DOF) to allow overcoming of obstacles and/or wire overcrowding. In some embodiments, the wire end effectors or the manipulating arms are provided with 6 degrees of freedom: three rotations and three translations about each perpendicular axis. In some embodiments, the wire end effectors are provided with 7 or more degrees of freedom. In some embodiments, a potential advantage of providing more than 6 degrees of freedom is that, while it may cause redundancy (or over-redundancy) problems in the software, it may also potentially allow the solving of wire manipulation to overcome obstacles and/or when positioning a wire during a wire overcrowding situation.

### Exemplary Method of Wiring by Robotic Arms 204

Referring now to FIG. 15, showing a flowchart of an exemplary method of wiring by the robotic arms 204, according to some embodiments of the invention. In some embodiments, the system receives the information about the wire that is needed to be used, the length of the wire and the type of wire end required 1502. In some embodiments, optionally, a wire preparation module prepares the wire, in other embodiments, ready to be used wires are provided 1504. In some embodiments, a dedicated tool is coupled to the end effector 1506. In some embodiments, the dedicated tools is chosen according to the wire/cable that is needed to be wired. In some embodiments, the first end of the wire is picked up by the wiring arms module 1508. In some embodiments, the first end of the wire is manipulated to the location in the electrical cabinet 1510. In some embodiments, the robotic arm 204 inserts the first end of the wire into the terminal connector of a first component, locks the wire in the terminal block and performs a validation 1512, for example by slightly pulling the wire back and “feeling” slippage of the elongated extensions rather than increased force. In some embodiments, the second end of the wire is picked up by the wiring arms module 1514. In some embodiments, the second end of the wire is manipulated to the location in the electrical cabinet 1516. In some embodiments, manipulation of the second end of the wire includes routing the wire from the location where the first end of the wire was inserted through wire channels/tracks until the second end of the wire reaches its location. In some embodiments, the two wire arm modules work in cooperation in the insertion of the wire through the channels/tracks, similar to the work that a human would do while performing the same work. For example, when inserting the wire in an angled channel/track, one arm holds the wire in a certain location while the other arm places the wire inside/through the channel/track, or for example, when needing to pass the wire through an orifice, one arm holds the wire on one side of the orifice, passes the end of the wire through the orifice and the other arm picks the end of the wire from the other side of the orifice. It should be understood that the examples above are just examples and should not limit the invention in any way.

In some embodiments, the robotic arm 204 inserts the second end of the wire into the connector of a second component, locks the wire in the terminal block and performs a validation 1518. In some embodiments, the system then assesses if there are any other wires needed for that job 1520. In some embodiments, if the answer is “YES”, then the method starts for the beginning. In some embodiments, if the answer is “NO”, then the system generates a report and ends the job 1522.

### Exemplary Wire Laying and Positioning Robotic Unit 212

In some embodiments, as explained above, the wire is positioned inside the duct by the one or more robotic arms 204 or any other robotic unit as mentioned above. In some embodiments, additionally or alternatively, the wire is positioned inside the duct by a wire laying and positioning robotic unit 212.

Referring now to FIGS. 16a-16c, showing schematic representations of an exemplary wire laying and positioning robotic unit 212, according to some embodiments of the invention. FIG. 16a shows an exemplary location of the exemplary wire laying and positioning robotic unit 212 in the robotic electrical cabinet wiring system 100, while FIG. 16b shows a more simplistic view of the exemplary wire laying and positioning robotic unit 212 in the robotic electrical cabinet wiring system 100, without other units.

FIG. 16c shows a schematic detailed view of the wire laying and positioning robotic unit 212. In some embodiments, the wire laying and positioning robotic unit 212, comprises a positioning head 1602, mounted on a dedicated gantry 216. In some embodiments, as mentioned above, instead of a gantry, the positioning head 1602 is located on a robotic arm that provides the necessary movement capabilities. In some embodiments, when a gantry is used, the gantry is configured to provide movement of the positioning head 1602 along two dimensions, forwards and backwards and right and left, as schematically shown by the arrows. In some embodiments, optionally, the gantry also provides movement in the up-down direction. In some embodiments, the positioning head 1602 comprises a dedicated mechanism/motor that provides the up-down movement (Z axis) while the gantry stays still or provides the lateral movement (X-Y axes). In some embodiments, the provided movements are configured to allow the positioning head 1602 to reach any location in the electrical cabinet being wired. In some embodiments, the wire laying and positioning robotic unit 212, comprises a wire channel 1604 where the wire being positioned is located before and during the wire is being positioned (see below).

Referring now to FIG. 16d, showing a schematic representation of an exemplary positioning head 1602, according to some embodiments of the invention. In some embodiments, the positioning head 1602 comprises a positioning neck 1606 from which the wire exits while it is being positioned (laid) in the duct. In some embodiments, the positioning neck 1606 is configured to open and close by means of an actuator 1608. In some embodiments, inside the positioning neck 1606 there is a wire feeding device for example a feeder belt or one or more rollers (not shown in FIG. 16d) configured to move the wire forwards and backwards (according to the needs) operated by a dedicated feeder belt/roller actuator 1610. In some embodiments, the positioning head 1602 is configured to move vertically (up and down), as schematically shown by arrow 1612, by means of an elevation actuator 1614. In some embodiments, the positioning head 1602 comprises a wire securing mechanism operated by a wire securing actuator 1616. In some embodiments, the wire securing mechanism is configured to allow insertion of the wire into the mechanisms of the positioning head 1602, and once the wire is engaged, it ensures the correct position of the wire within the positioning head 1602. In some embodiments, additionally, the wire securing actuator 1616 provides tension on the wire while it's being laid down in order to control the feeding rate (speed) of the wire. In some embodiments, optionally, the wire securing actuator 1616 optionally comprises an encoder (not shown) configured to measure the quantity of wire that has been laid down. In some embodiments, the positioning head 1602 is configured to tilt, from a vertical position (0 degrees tilt) to a horizontal position (90 degrees tilt) by means of a tilting actuator (see also FIGS. 16e, 16f and 16g). In some embodiments, a potential advantage of the tilting is that it potentially provides improved access to the second robot unit (for example the robotic arms 204) when the wire and/or wire tip is transferred from one unit to the other.

In some embodiments, optionally, the positioning head 1602 comprises a dedicated mechanism that provides the positioning head 1602 with additional rotation movement around the z vertical axes to prevent wire twisting around duct corners.

In some embodiments, a potential advantage of providing a better angle of the robotic units during the transfer of the wire is that it potentially allows the transfer of shorter wires, it potentially avoids collision of the robotic units with components in the electrical panel, and it potentially facilitates the transfer of the end connectors of the wires between the robotic units.

In some embodiments, as mentioned above, the robotic electrical cabinet wiring system 100 is configured for the manipulation of very short wires that, optionally, do not require the use of a wire laying and positioning robotic unit 212. In some embodiments, in these cases, the manipulation of the short wires is performed, for example, by one or more robotic arms 204.

Referring now to FIGS. 16e, 16f and 16g, showing schematic representations of an exemplary tilting action of the positioning head 1602, according to some embodiments of the invention. FIG. 16e shows the positioning head 1602 in a vertical position having 0 degrees of tilting. FIG. 16f shows the positioning head 1602 in a half way tilting position having about 45 degrees of tilting. FIG. 16g shows the positioning head 1602 in a horizontal position having 90 degrees of tilting. In some embodiments, the vertical position is used for the positioning of the wire in the duct during the wiring process. In some embodiments, the half way tilting position and the horizontal tilting position are used for the passage of wires from the robotic arms 204 to the positioning head 1602 (also referred as “wire handshake”). In some embodiments, the half way tilting position can be at any angle that is bigger than 0 degrees, for example any angle higher or equal to 1 degree, and smaller than 90 degrees, for example any angle lower or equal to 89 degrees. In some embodiments, the wire handshake in the half way tilting position is performed at an angle from about 45 degrees to about 60 degrees.

### Exemplary Wiring Method Using Robotic Arms 204 and Wire Laying and Positioning Robotic Unit 212

In the following paragraphs, a flowchart of an exemplary method of wiring will be explained, together with accompanied figures provided to allow a person having skills in the art to understand better the invention. It should be understood that the following actions are exemplary actions, which may include additional actions of less actions.

Referring now to FIGS. 17a-b showing a flow chart of an exemplary method of wiring using both robotic arms 204 (optionally with an end-effector 206) and wire laying and positioning robotic unit 212, according to some embodiments of the invention. Additionally, referring to FIGS. 17c-o, showing representative images of the actions disclosed by the flowchart of FIGS. 17a-b. In FIGS. 17a-b, actions on the left side are actions performed by the robotic arms 204 (optionally with an end-effector 206), actions on the right side are actions performed by the wire laying and positioning robotic unit 212 (for commodity just called wire positioning unit 212), while actions that involve both the robotic arms 204 (optionally with an end-effector 206) and the wire laying and positioning robotic unit 212 are positioned at the center.

In some embodiments, the robotic arm 204 changes the tool at the end effector 206 according to the relevant actions that are needed to be performed in the following wiring process 1702. In some embodiments, the robotic arm 204 optionally using an end-effector 206 picks up a wire from the waiting station of the prepared wires 1704, see also FIG. 17c showing a schematic representation of the end-effector 206 of the robotic arm 204 picking up a wire from the waiting station of the prepared wires. In some embodiments, the wire that is waiting in the waiting station is recognized by means of a camera or other sensor, in order to ensure the correct picking of the wire (for example, regarding the type and length according to the predetermined wiring process). In some embodiments, the robotic arm 204 reaches a predetermined location to meet the wire laying and positioning robotic unit 212 (1706).

In some embodiments, during actions 1702, 1704 and 1706 of the robotic arm 204, the wire laying and positioning robotic unit 212 reaches a predetermined location to meet the robotic arm 204 (1708) and opens the positioning neck 1606 (1710). In some embodiments, at this point the positioning head 1602 is at the horizontal tilting position, ready to receive the wire (see also FIGS. 17e-17h and related explanations below).

In some embodiments, the robotic arm 204 (optionally using the end-effector 206 or using any other mechanical unit) inserts the wire into the wire channel 1604 of the wire laying and positioning robotic unit 212, and advances until reaching the positioning head 1602 having the open positioning neck 1606 (1712). See also FIG. 17d, showing a schematic representation of the end-effector 206 of the robotic arm 204 inserting the wire into the wire channel while advancing towards the positioning head 1602. Additionally, see FIGS. 17e, 17f and 17g. FIG. 17e schematically shows the end-effector 206 of the robotic arm 204 at the end of the wire channel approaching the positioning head 1602. FIG. 17f schematically shows the positioning head 1602 opening the positioning neck 1606. FIG. 17g schematically shows the end-effector 206 of the robotic arm 204 inserting the wire within the opened positioning neck 1606. Lastly, FIG. 17h schematically shows the end-effector 206 of the robotic arm 204 finally reaching the end of the opened positioning neck 1606.

In some embodiments, the end-effector 206 of the robotic arm 204 keeps holding the first end of the wire (1714), while the wire laying and positioning robotic unit 212 closes the positioning neck 1606 (1716). In some embodiments, the positioning head 1602 then tilts to a half way tilt position. In some embodiments, the robotic arm 204 (and therefore also the end-effector 206) follows the movement of the positioning head 1602 while it tilts, as shown for example in FIGS. 17i and 17j. In some embodiments, the end-effector 206 of the robotic arm 204 releases the wire, waits until the movement of the positioning head 1602 is over to then, re-engage the wire, as schematically shown for example in FIGS. 17k and 17l.

In some embodiments the robotic arm 204 using the end-effector 206 inserts the first end of the wire into the electrical component located at point 1 on the electrical cabinet (1718), while the wire laying and positioning robotic unit 212 follows the robotic arm 204 wherever it goes (1720).

In some embodiments, the robotic arm 204 releases the first end of the wire from the end-effector 206 and moves away to wait for the next action when it is required 1722, while the wire laying and positioning robotic unit 212 lays down and positions the wire following a predetermined path from point 1 to point 2, within ducts, in the electrical cabinet (1724). See also FIG. 17m, schematically showing the wire laying and positioning robotic unit 212 releasing a wire, optionally at an equal speed, while the gantry moves along the duct. In some embodiments, a potential advantage of releasing the wire at the same speed of the movement of the wire laying and positioning robotic unit 212 is that is potentially avoids applying unnecessary forces on the wire and/or the units while positioning the wire. In some embodiments, optionally, the speed in which the wire is released is faster than the speed of the movement of the wire laying and positioning robotic unit 212, for example faster by 1%, optionally by 2%, optionally by 5%. In some embodiments, a potential advantage of releasing the wire at a faster speed than the movement of the wire laying and positioning robotic unit 212 is that it provides a level of “slack” in the positioned wire, which potentially can compensate for a duct having a plurality of wires that can disturb the positioning of the wire.

### Flowchart Continues in FIG. 17b.

In some embodiments, after the wire laying and positioning robotic unit 212 finished positioning the wire, it waits for the robotic arm 204 to reach the same location, while the robotic arm 204 reaches the location of the wire laying and positioning robotic unit 212 (1728). In some embodiments, the location of the meeting between the robotic arm 204 and the wire laying and positioning robotic unit 212 is near the location of point 2 in the electrical cabinet. In some embodiments, the wire laying and positioning robotic unit 212 comprises a sensor at the distal end of the positioning neck 1606 configured to sense when the second end of the wire reaches the distal end of the positioning neck 1606.

In some embodiments, the wire laying and positioning robotic unit 212 opens the positioning neck 1606 (1730), while the robotic arm 204 picks up the second wire end of the wire 1732 using the end-effector 206. See also FIGS. 17n and 17o showing the robotic arm 204 picking up the wire from the opened positioning neck 1606.

In some embodiments, the positioning neck 1606 comprises an adjustable opening that provides clearance that allows the end-effector 206 to properly and securely take the second end of the wire.

In some embodiments, the robotic arm 204 inserts the second end of the wire into a second electrical component located at point 2 on the electrical cabinet (1734), and then releases the wire and returns to a predetermined location to meet the wire laying and positioning robotic unit 212 for performing the next wiring action 1736, while the wire laying and positioning robotic unit 212 returns to the same predetermined location to meet the robotic arms 204 for performing the next wiring action 1738, which concludes the exemplary wiring cycle.

### Exemplary Separator

Referring now to FIGS. 18a-c, showing schematic representations of exemplary separators and uses thereof, according to some embodiments of the invention. In some embodiments, the robotic electrical cabinet wiring system 100, comprises one or more types of separators 1802, configured to be inserted between the openings of the duct 1804 in order to separate between wires being positioned within the duct 1804. In some embodiments, the separator 1802 also holds down the wire that has been positioned. In some embodiments, the robotic arm 204 picks up a separator 1802 from a stand 1806, as schematically shown in FIG. 18a, and positions it on a duct 1804, as schematically shown in FIG. 18b. In some embodiments, separators 1802 can be held at different heights on the duct 1804, as schematically shown in FIG. 18c.

### Exemplary Wire Holder Adaptor

Referring now to FIGS. 18d-u showing schematic representation of exemplary wire holder adaptors, according to some embodiments of the invention. It is known in the art that wires are positioned within ducts in electrical panels. This is done in order to allow organization of the plurality of wires within the electrical panel and potentially avoid entanglements of the wires. In some embodiments, as part of the wiring process performed by the robotic electrical cabinet wiring system 100, the system utilizes wire holder adaptors configured to be used within the electrical panel, and optionally within existing ducts. In some embodiments, the wire holder adaptors are configured to hold the wires being laid down and/or positioned within the electrical panel, and optionally within the ducts.

Referring now to FIG. 18d showing a schematic representation of an exemplary wire holder adaptor 1810, according to some embodiments of the invention. In some embodiments, an exemplary wire holder adaptor 1810 comprises a base 1812 configured to engage the surface of the electrical panel, and optionally the surface of the duct (see below FIGS. 180-p for engaging mechanisms) comprising an engaging mechanism 1832; and a wire holding enclosure mechanism 1814. In FIG. 18d, the wire holding enclosure mechanism 1814 comprises two bodies 1816/1818 extending vertically from the base 1812, each having a bended distal end 1820/1822 meeting at a center (marked with circle 1824) and leaving an opening 1826 for the insertion of the wire into the internal area 1828 of the wire holding enclosure mechanism 1814. In some embodiments, the bended distal ends 1820/1822 block the wire from exiting the internal area 1828 of the wire holding enclosure mechanism 1814. In some embodiments, the exemplary wire holder adaptor 1810 optionally comprises one or more additional features configured to facilitate the organization of the wires within the electrical panel, and optionally within the duct, as will be further explained below.

Still referring to FIG. 18d, an exemplary wire holder adaptor 1810 comprises one or more separator holders 1830 (two are shown in FIG. 18d) configured to receive a separator 1802 (see FIGS. 18a-c). In some embodiments, the separator holders 1830 are arranged in couples so each receives an end of a same separator 1802. Referring now to FIGS. 18e-h showing schematic representations of exemplary wire holder adaptors 1810 using exemplary separators 1802 being held by exemplary separator holders 1830, according to some embodiments of the invention. FIG. 18e shows an exemplary wire holder adaptor 1810 after a plurality of wires 1832 were positioned within the internal area of the wire holding enclosure mechanism. FIG. 18f shows the positioning of an exemplary separator 1802 in the separator holders 1830, thereby practically causing a separation of the internal area of the wire holding enclosure mechanism into two separate areas 1834/1836. FIG. 18g schematically shows additional wires 1838 added within the internal area of the wire holding enclosure mechanism, which are held in sub-area 1836 by the separator 1802. Finally, FIG. 18h schematically shows the addition of an additional separator 1802 that further holds the wires 1838 within the sub-area 1836, and optionally allows for further wires to be inserted within the internal area of the wire holding enclosure mechanism (not shown).

In some embodiments, the exemplary wire holder adaptor 1810 can have different sizes, as schematically shown in FIG. 18i. For example, the wire holder adaptor 1810 in the middle is the same as shown in FIG. 18d, while the wire holder adaptor 1810 shown on the left side is taller and the wire holder adaptor 1810 shown on the right side is wider.

In some embodiments, the exemplary wire holder adaptor 1810 can have more than one channel and/or one or more openings, as schematically shown in FIGS. 18j-k. FIG. 18j shows an exemplary wire holder adaptor 1810 with two channels, each independently accessible from each other, while FIG. 18k shows an exemplary wire holder adaptor 1810 with three separators generating four channels, which are accessed by only one opening.

In some embodiments, the exemplary wire holder adaptor 1810 are used in intersections, either within a duct or outside of it, for example, as schematically shown in FIGS. 18l-n. FIG. 18l schematically shows an exemplary wire holder adaptor 1810 that can be placed to generate a four ways intersection, while FIG. 18m shows an exemplary wire holder adaptor 1810 having a “T” intersection configuration, and lastly, FIG. 18n shows an exemplary wire holder adaptor 1810 having a “L” intersection configuration.

In some embodiments, as mentioned above, an exemplary wire holder adaptor 1810 comprises at the base 1812 an engagement mechanism 1832. For example, FIG. 180 shows a “snap-in” mechanism, while FIG. 18p shows wholes for insertion of screws as engaging mechanism.

In some embodiments, an exemplary wire holder adaptor 1810 optionally comprises attached to the end of the opening a small enclosure 1840 configured to hold one or more wires at the level of the small enclosure 1840, as schematically shown in FIG. 18q. In some embodiments, optionally, pulling further down the wires causes the wires to exit the small enclosure 1840 and entering the internal area of the wire holding enclosure mechanism.

In some embodiments, as mentioned above, an exemplary wire holder adaptor 1810 is optionally inserted into an existing duct 1842, as schematically shown in FIG. 18r. On the top of FIG. 18r it can be seen that a mechanical instrument 1844 (for example using the end-effector 206 of the robotic arm 204 or any other robotic unit) is holding an exemplary wire holder adaptor 1810. In the middle of FIG. 18r, the mechanical instrument 1844 inserts the exemplary wire holder adaptor 1810 into an existing duct 1842, while in the bottom part of FIG. 18r, it can be seen the assembled exemplary wire holder adaptor 1810 in the duct 1842.

In some embodiments, an exemplary wire holder adaptor 1810 is optionally accompanied by a dedicated cover 1846, as schematically shown in FIGS. 18s-t. FIG. 18s shown an exemplary wire holder adaptor 1810 with a dedicated cover 1846, while FIG. 18t shows a transparent view of the cover to facilitate viewing the interaction of the wire holder adaptor 1810 with the cover 1846. In some embodiments, the wire holder adaptor 1810 comprises one or more protrusions 1848 at the top configured to interact with the cover 1846 to allow distance between the cover 1846 and the wires running through the wire holder adaptor 1810. In some embodiments, the cover 1846 comprises one or more openings on the sides 1850 to allow wires to exit towards other locations (other ducts, components, etc.) within the electrical panel, as schematically shown in FIG. 18u.

In some embodiments, the cover 1846 is configured to cover the whole length of the duct, or partial parts of it.

In some embodiments, a robotic unit or a part thereof (for example the positioning neck 1606 of the positioning head 1602 or a dedicated tool—for example tweezers—of the end-effector 206 of the robotic arm 204) engages the one or more protrusions 1848 to temporarily open the opening 1826 and allow the insertion of the wire in the internal area 1828 of the wire holding enclosure mechanism 1814. In some embodiments, this is allowed by providing the wire holder adaptor 1810 with deformable properties that allow reversible deformation of the wire holder adaptor 1810 when engaged. In some embodiments, engagement of the wire holder adaptor 1810 to the panel (and optionally to the duct) is characterized so as to avoid obstruction of the actuation of the robotic units working on the wiring process and/or to avoid obstruction of access to electrical components. In some embodiments, the wire holder adaptor 1810 comprises one or more vertical pins (not shown), similar to the extensions shown in FIG. 18k that generate channels in that they extend vertically, that allow a wire to be directed, for example, in 90 degrees around the vertical pin to perform a “bend” in the wire. In some embodiments, the one or more vertical pins are also used to provide separate channels to group of wires. In some embodiments, the wire holder adaptor 1810 are used to hold un-connected wires that are left for later use by humans operators (for example when wires need to be routed to devices on a cabinet door—for example, indicator LEDs, buttons etc.). In some embodiments, wire holder adaptors 1810 are positioned within an electrical panel, optionally within a duct, either by a robotic unit or by a human operator, either in real time during the wiring process or prior to commencing the wiring process. In some embodiments, wire holder adaptors 1810 are used as add-ons on existing electrical ducts. In some embodiments, wire holder adaptors 1810 are used instead of electrical ducts and are engaged directly on the electrical panel.

Exemplary System and Methods for Passing a Wire from One Robotic Unit to Another Robotic Unit to Pass a Wire from One Side of the Electrical Cabinet to the Other

In some embodiments, wires are required to pass through the walls of the electrical cabinet in order to allow the passage of wires from the inside of the electrical cabinet to the outside of the electrical cabinet. For example, wires exiting the electrical cabinet to the main structure where the electrical cabinet is being positioned, and/or for example wires that need to exit through the door of the electrical panel. In some embodiments, wires are required to be positioned behind electrical components, for example, behind DIN rails, behind ducts, etc., during the wiring process. In some embodiments, wires are required to be positioned first before the electrical components, then be passed behind electrical components, then back forwards, and so on.

In some embodiments, as mentioned above, an exemplary electrical panel comprises one or more openings 124 (in FIG. 1d) in the wall of the cabinet that allow the passage of one or more wires from the inside of the electrical cabinet to the outside of it. In some embodiments, as will be explained below, the electrical cabinet comprises a frame, where panels are added after the wiring process has been finished. In some embodiments, dedicated robotic units are configured to manipulate one or more wires in order to make them pass through one or more of the openings 124 and/or, when wiring an electrical panel without panels, configured to move and/or pass a wire from one side of the electrical components to the other, and back.

Referring now to FIGS. 19a-b, showing schematic representations of exemplary robotic electrical cabinet wiring systems configured to pass wires, where FIG. 19a schematically shows how wires are passed through openings, while FIG. 19b shows an example where the electrical cabinet comprises a frame and removable/mountable panels and the wiring is performed while the panels are removed; and the wired is moved forwards and backwards in relation to electrical components, during the wiring process.

Referring now to FIG. 19a, showing a schematic representation of an exemplary robotic electrical cabinet wiring system 1900 configured to pass wires 1908 through openings 1910, according to some embodiments of the invention. In some embodiments, an exemplary robotic electrical cabinet wiring system 1900 configured to pass wires 1908 through openings 1910 is configured to house an electrical cabinet standing and/or laying down and perform the passage of wires in either position. To facilitate the explanations, in the following paragraphs the explanation will use an exemplary embodiment where the electrical cabinet is lying down, having the electrical cabinet facing up, thereby having the electrical panels/components facing up, and the back of the electrical cabinet facing down. It should be understood that the following explanations are meant to include the embodiment where the electrical cabinet is standing and the passage of wires is performed from one side to the other of the electrical cabinet. In some embodiments, an exemplary robotic electrical cabinet wiring system 1900 configured to pass wires 1908 through openings 1910 comprises at least two distinct robotic units 1902/1904, each configured to manipulate wires 1908, where one robotic unit positioned on one side the electrical cabinet 1906 (for example above the electrical cabinet) and another robotic unit positioned on the other side of the electrical cabinet 1906 (for example below the electrical cabinet). In some embodiments, at least one of the at least two distinct robotic units 1902/1904 are for example as robotic arms 204 shown in FIG. 2a and FIGS. 5a-c. In some embodiments, at least one of the at least two distinct robotic units 1902/1904 are for example as the wire laying and positioning robotic unit 212 shown in FIG. 16d. In some embodiments, at least one of the at least two distinct robotic units 1902/1904 are one or more of a manipulator, a Cartesian gantry system and a multi-axis platform. In some embodiments, more than two robotic units are used, for example 3, 4 5 or more robotic units are used in the wiring process.

In some embodiments, the electrical cabinet 1906 is positioned in a robotic electrical cabinet wiring system (for example as shown in FIGS. 1a-c), with the difference that the robotic electrical cabinet wiring system 1900 comprises the additional robotic unit positioned below the electrical cabinet 1906. In some embodiments, the at least two distinct robotic units 1902/1904 are configured to pass a wire 1908, or at least a part of a wire, from one side of the electrical cabinet to the other using one of the openings 1910. In some embodiments, for example, a distal end of a wire is passed, using one of the openings 1910, from the back of the electrical cabinet in a direction towards the front of the electrical cabinet, which means that the distal end of the wire is inserted from the outside of the electrical cabinet to the inside of the electrical cabinet—this is the example shown in FIG. 19a. In some embodiments, a distal end of a wire is passed, using one of the openings 1910, from the front of the electrical cabinet in a direction towards the back of the electrical cabinet, which means that the distal end of the wire is inserted from the inside of the electrical cabinet to the outside of the electrical cabinet.

In some embodiments, according to the predetermined planning, one of the distal ends of one or more wires are left outside the electrical cabinet. In some embodiments, a potential advantage of leaving a distal end of a wire outside the electrical cabinet is that it allows the preparation of the wires for the installation of the electrical cabinet at the destined location, therefore saving time and work of the technician installing the electrical cabinet.

Referring now to FIG. 19b, showing a schematic representation of an exemplary robotic electrical cabinet wiring system configured to access an electrical cabinet and/or a frame thereof from both sides and to pass wires from one robotic unit to the other, according to some embodiments of the invention. In some embodiments, as mentioned above, an exemplary electrical cabinet comprises a frame on to which panels or covers and/or doors are added after the wiring process. In some embodiments, during the wiring process the at least two distinct robotic units 1902/1904 are configured/allowed to access within the frame, where one robotic unit is positioned on one side of the frame while the other robotic unit is positioned on the other side of the frame. In some embodiments, the robotic units 1902/1904 pass at least a part of a wire to each other through the frame while avoiding other components (for example DIN rails, ducts, electrical components, etc.) located within the frame of the electrical cabinet. In some embodiments, wiring can be done on the front side of the electrical components positioned within the electrical cabinet and/or on the back side of the electrical panel, behind the electrical components positioned within the electrical cabinet. In this case, for example, the robotic unit located on the back side of the electrical cabinet frame can be a wire laying and positioning robotic unit 212 as shown in FIG. 16d, because most of the positioned of the wiring will be performed on the back side of the electrical cabinet.

### Exemplary Means and Methods for Delivering a Wire Through an Opening

In some embodiments, the automatic wiring system is configured to pass a wire, or a distal end of a wire, from one side of an electrical panel to another side of the electrical panel, optionally through an opening in the electrical panel. In some embodiments, as mentioned before, one or more end-effectors or optionally some elements/mechanisms of the one or more end-effectors are used to manipulate the wire being passed from one side to another, and optionally back.

Referring now to FIGS. 19c-d, showing schematic representations of exemplary systems 1912a-b, respectively, configured to pass a wire from one side to another, according to some embodiments of the invention. In some embodiments, the system is an automated robot, for example a Cartesian robot 1912a (as shown by the XYZ arrows), as shown for example in FIG. 19c, or an articulated robot 1912b, as shown for example in FIG. 19d. In some embodiments, in either configuration, the automated robot is fitted with a dedicated end-effector 1914. In some embodiments, the end-effector 1914 comprises a wire delivering mechanism 1916 that controllably discharges or ejects a distal end of the wire from one side to the other. In some embodiments, the wire delivering mechanism 1916 is directly mounted on an independent robot or a manipulator, and in some embodiments, the wire delivering mechanism 1916 is positioned adjacent to an already existing end-effector. In some embodiments, either system may comprise any of the herein mentioned modules/parts, for example: a wire preparation system, a system base and/or frame, a local computer, a remote computer, a connection to a server, etc.

Referring now to FIGS. 19e-f, showing a schematic representation of an exemplary wire delivering mechanism 1916 in two actuation configurations, according to some embodiments of the invention. In some embodiments, the wire delivering mechanism 1916 comprises two actuation configurations, a retracted configuration, as shown for example in FIG. 19e, and an extended configuration, as shown for example in FIG. 19f. In FIGS. 19e-f, the wire delivering mechanism 1916 is shown as an integral part of a wire-manipulating end-effector.

FIG. 19g shows an exemplary wire delivering mechanism 1916 ready to deliver a wire from one side to another, according to some embodiments of the invention. FIG. 19g shows the wire delivery mechanism 1916 positioned between two rows of electrical components 1918, and the wire delivering mechanism 1918 is ready to send the wire while one of the ends of the wire is being held by a gripping end-effector.

Referring now to FIG. 19h, showing a schematic representation of an exemplary wire delivering mechanism 1916 mounted on an end-effector 1914, according to some embodiments of the invention. In some embodiments, as mentioned elsewhere herein, the end-effector 1914 comprises a screw bit tool 1920 and a gripper tool 1922. In some embodiments, also as mentioned, the gripper tool 1922 is configured to hold a wire 1924. FIG. 19h shows the wire delivering mechanism 1916 in an extended configuration. In some embodiments, the wire delivering mechanism 1916 comprises a linear actuator 1926 configured to move the wire delivering mechanism 1916 from a retracted configuration to an extended configuration and vice-versa. In some embodiments, the wire delivering mechanism 1916 comprises a wire driving mechanism 1928 configured to drive forwards and backwards the wire. In some embodiments, as the wire driving mechanism 1928 pushes the wire out (optionally, while the gripper 1922 holds the wire 1924), the slack of the wire gets short and the wire is delivered to the other side of the frame.

FIG. 19i shows two images showing a wire delivering mechanism 1916 delivering a wire between two rows.

Referring now to FIG. 19j, showing a schematic representation of a wire delivery mechanism 1916 and parts thereof, according to some embodiments of the invention. In some embodiments, an exemplary wire delivery mechanism 1916 comprises one or more of:

A drive motor 1930 configured to drive a timing belt 1932. In some embodiments, the timing belt 1932 pushes the wire forward, moving it through the gap. In some embodiments, the drive motor 1930 is configured to modify the speed of the timing belt 1932 and therefore the delivering velocity of the wire. In some embodiments, the speed may depend on the wire type, gage, friction parameter etc. In some embodiments, the speed may be combined with the end-effector angle relative to the panel to create best delivering performance. In some embodiments, a feeder release actuator 1934 creates contact between the timing belt 1932 and a support wheel 1936. In some embodiments, a spring 1938 ensures contact of the timing belt 1932, the wire and the support wheel 1936. In some embodiments, a wire detector sensor 1940 is used for detecting the wire presence and optionally wire motion parameters (e.g. speed).

In some embodiments, upon completing of the throwing process (for example by measuring the length), the feeder release actuator 1934 opens up and allows the wire 1942 to be released from the wire delivery mechanism 1916.

Referring now to FIGS. 19k-m, showing an exemplary wire handling and placement unit, according to some embodiments of the invention. In some embodiments, a wire handling and placement unit 1944 is configured to place the wire into a wire delivery mechanism 1916. In some embodiments, an end-effector delivers a wire to the wire handling and placement unit 1944, a back guide plate 1946 moves the wire into position where two grippers 1948 grab the wire. In some embodiments, the two gripper rotate upward and sideways (using for example an eccentric mechanism) to present the wire to the wire delivery mechanism 1916 in the right configuration/orientation. In some embodiments, the robot and end-effector can then move to the spitting position in front of the panel.

Referring now to FIG. 19n, showing a flowchart of an exemplary method for delivering a wire from one side to the other, according to some embodiments of the invention. In some embodiments, an exemplary process of manipulating a wire for a panel (or a frame or a cabinet) comprises one or more of the following actions:
Picking a wire from a wire presenter 1950;
Bringing the wire to the wire handling and placement unit, in some cases the wire slack is left to hang lose 1952;
Preparing the wire and placing it into the wire delivery mechanism, which may include one or more of the following steps 1954:
   Pushing the wire with back plate into grippers location 1956
   Grabbing wires with grippers and tension wire, retract back plates 1958
   Extending wire delivery mechanism and rotate wire orientation 1960
   Moving the end-effector with the wire delivery mechanism (unit in open state) into wire position 1962
   Securing the wire inside wire delivery mechanism, opening grippers and retracting end-effector from grippers 1964
Moving and rotate the end-effector to a clear location on panel 1966
Feeding the wire through a panel opening 1968; In some embodiments, feeding through an opening may be by advancing the wire in to the gap by quickly creating a “throwing effect”. Alternatively, a two-part guide tube may be used to guide the wire in the opening gap.
Moving the end-effector to insertion location 1970
Inserting the wire into component 1972

In some embodiments, the method further comprises moving to pick-wire position. In some embodiments, the opening gap where the wire will be delivered may be near the component that needs wire insertion, for example 5 cm or 8 cm. In some embodiments, the gap may be located relatively far from the component, for example 40 cm or 60 cm.

In some embodiments, the system software will compare the wire length to the gap distance to component location. In some embodiments, if the distance is relatively close to wire size e.g. 90% to 110% or 80% to 120% the system will not deliver the wire through the gap. In some embodiments, the system may leave the wire hanging on same side or will omit this operation all together.

In some embodiments, a vision system is used to identify the gap through which the wire will be delivered to the other side. In some embodiments, alternatively it can be pre-calculated by using for example a CAD (or ECAD) system, for example EPLAN or ZUKEN (ECAD systems). In some embodiments, a vision system will be used to validate the transfer of the wire to the other side of the panel/frame.

### General Information Regarding the at Least Two Robotic Units

In the following paragraphs, general information regarding the at least two robotic units configured to pass to each other a wire (or a part thereof) through an opening and/or back and forth within the electrical cabinet, when panel are not present.

In some embodiments, as mentioned above, there are at least two robotic units that are involved the process of passing a wire from one side of the electrical cabinet to the other (either within the electrical cabinet or when needing to pass a wire to the outside of the electrical cabinet). In some embodiments, there are more than two robotic units. In some embodiments, robotic units involved in the passing of a wire can be robotic arms 204 as shown in FIG. 2a and FIGS. 5a-c, or can be wire laying and positioning robotic unit 212 as shown in FIG. 16d, or can be one or more of a manipulator, a Cartesian gantry system and a multi-axis platform. In some embodiments, the type of robotic unit used is chosen according to the required actions needed to be performed. For example, if a wire is needed to be positioned within the electrical panel but along the backside of the electrical panel, a wire laying and positioning robotic unit 212 will be positioned on the side of the back of the electrical panel, while, for example, a robotic arm is positioned on the front side of the electrical cabinet. A potential advantage of doing this, is that the best type of robotic unit is used in the location that it is required thereby enhancing the wiring performance of the system.

In some embodiments, the at least two distinct robotic units 1902/1904 are configured to perform a “handshake” protocol when passing the wire from one robotic unit to the other, in order to guarantee that the wire is properly passed. In some embodiments, the passage of the wire is monitored using one or more sensors, for example, a video camera, a touch sensor, a laser sensor, etc. In some embodiments, the passage of the wire is monitored by utilizing two reference markers, one on each robotic unit, used to synchronize the movement of the two robotic units when performing the passage of the wire. In some embodiments, data is transferred between one robotic unit and the other as part of the handshake protocol, for example, the type of wire, the “name” of the wire, the size of the wire, the color of the wire, the length of the wire, etc. In some embodiments, the handshake protocol comprises intercommunicating the position of each of the robotic units, for example in relation to a known location.

In some embodiments, the function and/or actions (for example providing/receiving a wire) performed by the robotic units 1902/1904 can change between the two robotic units, for example at one time a first robotic unit passes the wire to the second robotic unit, while later the second robotic unit passes the wire to the first robotic unit.

In some embodiments, optionally, the cabinet/frame is positioned on a turntable (or another device/system that allows handling and/or changing the positioning of the electrical cabinet/frame) configured for allowing to change the positioning of the electrical cabinet/frame to allow presenting/positioning the electrical cabinet/frame to a designated robotic unit according to the required task.

### Exemplary Additional General Information Regarding the Robotic Automatic Wiring System and Processes Thereof

### Exemplary Data Flow and Operation

Referring now to FIG. 20, showing a schematic representation of an exemplary data flow and operation of an automated wiring system, according to some embodiments of the invention. In some embodiments, the user begins by virtually planning an electrical cabinet 2002. In some embodiments, the user runs a simulation in a dedicated software 2004. In some embodiments, the planning is optionally optimized in view of the results of the simulation 2006. In some embodiments, further simulations are run until the best plan is achieved. In some embodiments, before continuing the system performs a final assessment to see if the planning stage is over 2008. In some embodiments, if the answer is “NO”, then the system returns to the planning stage. In some embodiments, if the answer is “YES”, then the system generates an electrical schematic plan adapted also to be shared in other platforms, the system generates a mechanical drawing of the electrical panel adapted also to be shared in other platforms and the system generates a bill of materials (BOM) for the assembly of the electrical cabinet 2010.

In some embodiments, at this point, the system generates a sequence of routing of wires based on the electrical schematic and the mechanical drawing 2011. In some embodiments, as explained herein elsewhere, the generation of a sequence of routing of wires comprises the virtual generation of a series of possible sequences of inserting the wires in the electrical cabinet, the changes in the tools used during the wiring process and evaluating possible problems that could occur during the actual wiring of the electrical cabinet. In some embodiments, optionally, the system performs simulations to optimize the sequence of routing the wires, optionally according to determined parameters.

In some embodiments, the abovementioned actions comprises a continuous exchange of data between the computer of the user planning the electrical and the server 2012. In some embodiments, once all is ready for assembly, the electrical cabinet is assembled in the automated electrical wiring unit/system 106 according to the final version of the plan 2014. In some embodiments, during the assembly, the automated electrical wiring unit/system 106 is in communication with the server for continuing monitoring of performance 2016.

### Exemplary One Arm System

In some embodiments, the system comprises one mechanical arm configured to perform all automated action of the wiring process. For example, pre-made wires ready to be wired are held on one side by the mechanical arm, while the other side is revolved into a winch and the wire is released as needed. In some embodiments, the winch with the wire is provided to the mechanical arm directly from the wire preparation module.

Various embodiments and aspects of the present invention as delineated hereinabove and as claimed in the claims section below find experimental support in the following Exemplary Embodiments.

### EXEMPLARY EMBODIMENTS

Reference is now made to the following Exemplary Embodiments, which together with the above descriptions illustrate some embodiments of the invention in a non-limiting fashion.

Referring now to FIGS. 21a-b, showing schematic illustrations of a wiring process by two automated mechanical arms, according to some embodiments of the invention.

FIG. 21a shows a schematic representation of two automated mechanical arms 2102/2104. For the following explanations one automated mechanical arm will be called arm one 2102 and another will be called arm two 2104. Also shown in FIG. 21a is a schematic representation of an electrical panel 2106 in need to be wired. FIG. 21b shows a schematic representation of the electrical panel 2006 in more detail. The exemplary electrical panel 2106 comprises 5 ducts 2108-1/5. The exemplary electrical panel further comprises a plurality of components, and for the present example, Component A and Component B require a wire to connect between them.

On FIG. 21b, are also marked reference points, circled 1 through 8 for the explanations that will follow.

As stated above, in the following example a wire needs to be placed between Component A and Component B. For the matters of this example, it was decided that the chosen path from Component A to Component B will be by extending the wire from reference point 1, which is the wire connected to Component A, to reference point 2, into duct 2108-3 following reference point 3. Then the wire will need to be turned to be then extended inside duct 2108-3 towards reference point 4 and into duct 2108-5. Then the wire will need to make a turn into duct 2108-5 towards reference point 5. Then the wire will need to make a turn into duct 2108-4 towards reference point 6. Then the wire will exit duct 2108-4 at reference point 7, and will be inserted into Component B following reference point 8.

The following table summarizes the actions of arm one 2102 and arm two 2104 during the placement of the wire from reference point 1 to reference point 8.

| From | To | | |
|---|---|---|---|
| reference | reference | | |
| point | point | Status of Arm 1 2102 | Status of Arm 2 2104 |
| | | Connect chosen tool to | Connect chosen tool to |
| | | end effector for insertion of | end effector for holding |
| | | wire into Component | wire |
| | | Grab an end of a wire | Grab the wire a certain |
| | | | distance from the grabbed end |
| 1 | | Insertion of wire into | Hovers over panel |
| | | connector of Component A | while keeping the wire tense |
| | | Optionally - | |
| | | interchange tool if required to | |
| | | perform placing actions | |
| 2 | 3 | 1. Arm goes above | Updating location to |
| | | duct 2108-3 close to the zone | keep the wire tense |
| | | where the side opening of the | |
| | | duct is located. | |
| | | 2. Identification of the | |
| | | side opening by visual sensors | |
| | | or tactile sensors. | |
| | | 3. insertion of the wire | |
| | | inside duct 2108-3 | |
| 3 | | 90 degrees rotation of | Movement along duct |
| | | the wire | 2108-3 where the wire will be |
| | | | placed |
| 3 | 4 | Caging hold the wire | Continuous |
| | | and placement of the wire | movement following the |
| | | along duct 2108-3 | placement of the wire while |
| | | | holding it tense |
| 4 | | 90 degrees rotation of | Movement along duct |
| | | the wire | 2108-5 where the wire will be |
| | | | placed |
| 4 | 5 | Caging hold the wire | Continuous |
| | | and placement of the wire | movement following the |
| | | along duct 2108-5 | placement of the wire while |
| | | | holding it tense |
| 5 | | 90 degrees rotation of | Movement along duct |
| | | the wire | 2108-4 where the wire will be |
| | | | placed |
| 5 | 6 | Caging hold the wire | Continuous |
| | | and placement of the wire | movement following the |
| | | along duct 2108-4 | placement of the wire while |
| | | | holding it tense |
| 6 | | 90 degrees rotation of | |
| | | the wire | |
| 6 | 7 | 1. Arm goes above | Updating location to |
| | | duct 2108-4 close to the zone | keep the wire tense |
| | | where the side opening of the | |
| | | duct is located. | |
| | | 2. Identification of the | |
| | | side opening by visual sensors | |
| | | or tactile sensors. | |
| | | 3. insertion of the wire | |
| | | into side opening therefore | |
| | | exiting duct 2108-4 | |
| | | Optionally - | |
| | | interchange tool if required to | |
| | | perform insertion actions | |
| 8 | | Insertion of wire into | |
| | | connector of Component B | |

Referring now to FIG. 22, showing a graph describing the exemplary phases of the insertion of a wire into an electrical terminal connector of a component as identified by the sensors in the gripper, according to some embodiments of the invention. In some embodiments, the system is configured to identify the different phases of the insertion of the wire into the electrical terminal connector of a component, as further disclosed above. The graph in FIG. 22 shows the force sensed by the sensors on the finger-like extensions 910a-b in the gripper 1308 in relation to the held wire. In some embodiments, the phases are:

Phase A: movement forward towards the electrical terminal connector of a component. In some embodiments, at this phase, the wire is held by the gripper 1308 and the gripper 1308 is moving forward towards the electrical terminal connector of the component. In some embodiments, at the beginning the sensed force is the same as the wire has not met any obstruction. In some embodiments, at some point, the wire meets the electrical terminal connector of the component, and the sensors begin to sense an increase in the sensed force. Once reached a certain peak, the system will move to the next phase. In some embodiments, the peak may depend and optionally set based on type of wire and/or the type of electrical terminal connector. In some embodiments, the relation between the type of wire, the type of connector of the component and the “sensed” forces is learned by the system and stored in a dedicated database. In some embodiments, an AI algorithm is used to generate these peak values based on learned data.

Phase B: movement backwards from the electrical terminal connector of the component. In some embodiments, once a certain peak has been reached, the gripper 1308 will begin moving backwards while still holding the wire but without actually pulling the wire with it. In some embodiments, as shown in the graph, the sensed forces decrease drastically, as the gripper loosens the grip.

Phase C: movement backwards from the electrical terminal connector of the component while pulling the wire. In some embodiments, in order to assess correct connection between the wire and the electrical terminal connector of the component, the gripper gently holds the wire while continuing moving backwards from the electrical terminal connector of the component. In some embodiments, at this point, two possible things can happen: 1. the wire is correctly connected and will not move causing the gripper to slip over the connected wire; or 2. the wire is not connected correctly and will be pulled out the electrical terminal connector. In some embodiments, as mentioned above, the values are learned and/or adjusted after each attempt.

In some embodiments, different types of electrical terminal connectors and different types of wires will be characterized with different forces, which will be characterized by different forces sensed by the gripper. In some embodiments, the system comprises a database in which the different combinations of different types of electrical terminal connectors and different types of wires are kept, and according to the input provided by the user, the system will actuate the gripper accordingly.

Referring now to FIGS. 23a-c, showing three different examples of sensed forces by the gripper in three different scenarios, according to some embodiments of the invention. FIG. 23a shows an example of what the sensors sense during the movement backwards of the gripper and the wire did not connect at all with the electrical terminal connector of the component. In this case, there is no increase of the sensed force since the wire does not resist the pulling of the gripper.

FIG. 23b shows an example of what the sensors sense during the movement backwards of the gripper and the wire did not connect correctly with the electrical terminal connector of the component. In this case, at the beginning, the gripper begins to move backwards until the wire resists the pulling, which is translated to an increase in the sensed force. At some point, because the wire is not properly connected, it will detach from the electrical terminal connector of the component, which is evidenced by the sudden decrease in the sensed force, and then return to the same levels as in the beginning.

FIG. 23c shows an example of what the sensors sense during the movement backwards of the gripper and the wire did connect correctly with the electrical terminal connector of the component. In this case, at the beginning, the gripper begins to move backwards until the wire resists the pulling, which is translated to an increase in the sensed force. At some point, because the wire is properly connected, the gripper will begin slipping over the wire, which is evidenced by the reduction of the sensed force on the gripper at the end of the graph.

Referring now to FIG. 24, showing a plurality of test experiments for the characterization of exemplary scenarios, according to some embodiments of the invention. As previously disclosed, at the beginning there is movement of the gripper without resistance from the wire, therefore the input from the force sensor stays stable. Then, once the wire enters the electrical terminal connector of the component, there is spike in the input from the sensors due to the resistance between the wire and the connector. Then, the device begins to pull the wire backwards in order to assess the connection between the wire and the electrical terminal connector of the component. This part is characterized by a sudden decrease in the input received from the sensor, as seen in FIG. 24.

Then, according to the outcome of the connection between the wire and the electrical terminal connector, different inputs are received from the sensor. In Test 1, the wire missed the connector, as can be seen by the unchanged graph. In Test 2, the wire disconnected from the connector during the pulling backwards of the wire. In test 3, the wire connected perfectly to the connector, and the gripper slipped over the wire during the backwards movement. In Test 4 the wire disconnected from the connector during the pulling backwards of the wire. The abovementioned graphs are exemplary experiments provided to allow a person having skills in the art to understand the invention and should not be limiting in any way.

### Exemplary Automatic Assembly and Wiring System for Small Panels

Referring now to FIG. 25a showing a schematic representation of an exemplary automatic assembly and wiring system for small panels 2500, according to some embodiments of the invention. In some embodiments, the system 2500 is configured to allow the wiring of multiple small electrical panels within a same unit. In some embodiments, the system 2500 comprises dedicated modules configured to perform the automatic wiring process.

Referring now to FIG. 25b, showing a schematic representation of the modules of an exemplary automatic assembly and wiring system for small panels, according to some embodiments of the invention.

In some embodiments, the system 2500 comprises a loading/unloading module 2502 where a user can load a frame to be wired and unload a finished panel. In some embodiments, the loading and unloading is done either manually or with the assistance of a robotic device.

In some embodiments, the system 2500 comprises an assembly module 2504, shown in more detail in FIG. 25c. In some embodiments, the assembly module 2504 comprises one or more robotic arms 2506 having a gripper 2508, and configured to pick up components from a component magazine 2510 and/or tray 2512. In some embodiments, the assembly module 2504 comprises a tool changer 2514 having a plurality of tools that the one or more robotic arms 2506 might need during the assembly process and are interchangeable during the process. In some embodiments, the assembly process is monitored using one or more sensors 2516, FIG. 25c shows a camera, but other sensors can be used.

In some embodiments, the system 2500 comprises a wiring module 2518, shown in more detail in FIG. 25d. In some embodiments, the wiring module 2518 comprises one or more robotic arms 2520 having a gripper 2522, and configured to manipulate one or more wires provided from one or more wire manipulators 2524. In some embodiments, the assembly process is monitored using one or more sensors 2526, FIG. 25c shows a camera, but other sensors can be used. In some embodiments, the one or more robotic arms 2520 are positioned on a frontal side of the electrical panel, while the one or more wire manipulators 2524 are positioned on the other side (either below or behind or under) of the panel (see also FIGS. 26a-b below explaining an exemplary system to manipulate a wire under an electrical panel 2600).

### Exemplary Under-Panel System to Manipulate Wires

Referring now to FIG. 26a, showing an exemplary system to manipulate a wire under an electrical panel 2600, according to some embodiments of the invention. In some embodiments, a dedicated system 2600 is positioned behind (meaning on the back side) of the electrical panel being wired, as schematically shown in FIG. 26b. In some embodiments, the dedicated system comprises a two grippers 2602a/b, mounted on an elongated base 2604. In some embodiments, each gripper is configured to move along the elongated base, as shown by arrow 2606. In some embodiments, each gripper is configured to rotate around its axis, as shown by arrow 2608. In some embodiments, the elongated base 2604 is mounted on two rails 2610a/b that allow the elongated base to move side to side, as shown by arrow 2612. In some embodiments, a distal end of a wire is held by each of the grippers 2602a/b of the system 2600. In some embodiments, the distal ends of a wire are presented and passed to a wire manipulation robot located on the front side of the electrical cabinet, while the wire is left on the back side of the panel. Contrary to what was explained herein elsewhere, that the wires are positioned within channels/ducts, in this case the wire is left on the back side of the panel not within any channel or duct. In some embodiments, one gripper, for example 2602a, presents the wire to a wiring robot (for example robot arm 2520 in FIG. 25d) in the vicinity of a first electrical component that needs to be wired (i.e. moves to that location), while the second gripper, for example 2602b moves to a location where a second component needs to be wired. In some embodiments, the position and movement of the grippers 2602a/b depends on parameters such as wire length, wire gauge, end of wire orientation, robot accessibility to component, location, etc.

It should be understood that while the description above and the drawing are presented horizontally for convenience, the panel may be vertical and the wiring robot can be located on the front side while the wire manipulation system on the back side.

In some embodiments, the gripper may have a motion in the perpendicular plane to the panel allowing wire presentation thru the panel.

As used herein with reference to quantity or value, the term “about” means “within +20% of”.

The terms “comprises”, “comprising”, “includes”, “including”, “has”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular forms “a”, “an” and “the” include plural references unless the context clearly dictates otherwise. For example, the term “a compound” or “at least one compound” may include a plurality of compounds, including mixtures thereof.

Throughout this application, embodiments of this invention may be presented with reference to a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Unless otherwise indicated, numbers used herein and any number ranges based thereon are approximations within the accuracy of reasonable measurement and rounding errors as understood by persons skilled in the art

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. An automated robotic wiring system configured for performing a wiring process including wiring one or more wires in an electrical panel, the system comprising:
a. one or more of a first robotic unit configured for inserting an end of a wire into an electrical component;
b. one or more of a second robotic unit configured for positioning said wire along a path within said electrical panel;
wherein said first robotic unit and said second robotic unit collaborate with each other during said wiring process.

2. The system according to claim 1, wherein said automated robotic wiring system is configured for passing parts of wires from said one or more wires from said one or more of a first robotic unit to said one or more of a second robotic unit and viceversa during said wiring process.

3. The system according to claim 1, wherein said one or more of a first robotic unit is positioned on a front side of said electrical panel.

4. The system according to claim 1, wherein said one or more of a second robotic unit is positioned on a same side like said one or more of a first robotic unit or on a back side of said electrical panel.

5. (canceled)

6. The system according to claim 1, further comprising at least two second robotic units, and wherein a first second robotic unit from said at least two second robotic units is positioned on a front side of said electrical panel while a second second robotic unit from said at least two second robotic units is positioned on a back side of said electrical panel.

7. The system according to claim 1, wherein said first robotic unit is a robotic arm comprising an end effector configured to engage said wire.

8. (canceled)

9. The system according to claim 1, wherein said second robotic unit is a wire laying and positioning robotic unit.

10. The system according to claim 9, wherein said wire laying and positioning robotic unit, comprises:
a. a robotic manipulator configured to provide movement to a positioning head in one or more directions;
b. a positioning head, comprising one or more wire manipulating mechanisms.

11. The system according to claim 10, wherein one of said one or more wire manipulating mechanisms comprises a positioning neck comprising one or more wire moving mechanisms.

12. The system according to claim 11, wherein said one or more wire moving mechanisms are one or more belts and/or one or more rollers.

13. (canceled)

14. The system according to claim 10, wherein said positioning head comprises an inclination mechanism configured to tilt said positioning head to an angle from 0 degrees to 90 degrees.

15. (canceled)

16. The system according claim 10, wherein said positioning head comprises a rotation mechanism configured to rotate said positioning head.

17. The system according to claim 10, wherein said robotic manipulator is one or more of a robotic arm and a robotic gantry.

18. The system according to claim 10, wherein said one or more directions provided by said robotic manipulator are selected from the group consisting of left-right, forward-backward and up-down.

19. The system according to claim 10, further comprising one or more of:
a. sensors configured to monitor the movement of a wire within said positioning head;
b. a wire securing actuator configured to control a speed which a wire is being released;
c. an encoder configured for measuring how much of a wire has been released;
d. a wire channel configured for containing a wire while said wire is being released.

20-22. (canceled)

23. The system according to claim 11, wherein said positioning neck comprises a closed configuration and an open configuration; and wherein in said open configuration a robotic unit is allowed to access and engage a wire located within said positioning neck.

24. The system according to claim 1, wherein said second robotic unit is a wire manipulation robotic unit positioned behind said electrical panel.

25. The system according to claim 24, wherein said wire manipulation robotic unit comprises two or more grippers, each configured to manipulate a distal end of a wire; and wherein each of said two or more grippers is configured for one or more of:
a. rotate along a longitudinal axis of a gripper;
b. move in a Cartesian fashion;
c. move independently from other grippers;
d. move up and down in relation to said electrical panel;
e. move from a back side of said electrical panel to a front side of said electrical panel;
f. interact with at least one of said one or more of a first robotic unit;
g. interact with at least one of said one or more of a second robotic unit positioned on a front side of said electrical panel.

26-32. (canceled)

33. The system according to claim 1, further comprising one or more of:
a. a wire preparation unit configured for preparing one or more wires to be used in said wiring process;
b. an openable loading table configured to receive said electrical panel;
c. one or more sensors configured to monitor said wiring process.

34-35. (canceled)

36. A method of performing a wiring process of an electrical panel by an automated robotic wiring system, comprising:
a. inserting a first end of a wire into a first electrical component by means of one or more of a first robotic unit;
b. positioning said wire along a path by means of one or more of a second robotic unit;
c. inserting a second end of a wire into a second electrical component by means of said one or more of a first robotic unit.

37. The method according to claim 36, further comprising one or more of:
a. positioning said wire within said one or more of a second robotic unit before said inserting a first end of a wire;
b. picking up, by means of said one or more of a first robotic unit, said first end of said wire from a distal end of said one or more of a second robotic unit after said positioning said wire within said one or more of a second robotic unit;
c. picking up, by means of said one or more of a first robotic unit, said second end of said wire from a distal end of said one or more of a second robotic unit after said positioning said wire along said path
d. inclining a part of said one or more of a second robotic unit to facilitate said picking up;
e. receiving wiring information data comprising a plurality of tasks for said one or more of a first robotic unit and said one or more of a second robotic unit to be performed during said wiring process;
f. performing said plurality of tasks according to said wiring information data; wherein said plurality of tasks are characterized by instructing said one or more of a first robotic unit and said one or more of a second robotic unit to collaborate with each other during said a wiring process;
g. picking up, by said one or more of a first robotic unit, a dedicated tool for a task from said plurality of tasks according to said wiring information data;
h. interchanging tools when a specific task from said plurality of tasks requires a different tool from said picked up tool;
i. passing one or both distal ends of a wire from one side of said electrical panel to another side of said electrical panel.

38-43. (canceled)

44. The method according to claim 36, wherein said positioning said wire along a path comprises leaving a wire on a back side of an electrical panel.

45. (canceled)
